(19) United States
(12) Patent Application Publication
(10) Pub. No.: US 2004/0004967 A1
(43) Pub. Date: Jan. 8, 2004

(54) Mobile communication system, router, mobile node, and mobile communication method

(76) Inventors: Keiichi Nakatsugawa, Kawasaki (JP); Tsuguo Kato, Kawasaki (JP); Kazuyuki Oka, Yokohama (JP)

Correspondence Address: KATTEN MUCHIN ZAVIS ROSENMAN, 575 MADISON AVENUE, NEW YORK, NY, 10022-2585, US

(21) Appl. No.: 10/465,005

(22) Filed: Jun. 19, 2003

(30) Foreign Application Priority Data
Jul. 4, 2002 (JP) 2002-196320

(51) Int. Cl. H04L 12/56

(52) U.S. Cl. 370/400; 370/338; 370/328

(57) ABSTRACT

A technique to support mobile communication in an IP network in which a mobile node MN in communication with an access router detects change of a connection link, the mobile node MN sends another access router a change request regarding a first temporary address used prior to the movement of the mobile node MN based on the detected change, and a distribution router creates a cache memory in which the first temporary address is changed into a second temporary address used after the move and receives and forwards a packet destined for the first temporary address sent from a correspondent node CN to the second temporary address. Therefore, a mobile node on high-speed movement continues mobile communication and it is possible to improve efficiently use of network resources without change of an exiting network configuration and to realize data transmission/reception with less packet losses.

### BACKGROUND OF THE INVENTION

1. Field of the Invention

The present invention relates to IP (Internet Protocol) network technology and particularly to a mobile communication system, a router, a mobile node and a mobile communication method preferably applied to a technique to support mobile communication in an IP network.

2. Description of the Related Art

In recent years, while walking or taking trains, many people are using their mobile telephones to receive communication service, such as access to web sites or e-mail communication. The communication service is provided through well-known IP protocol.

When this IP protocol was developed, all terminals exemplified by workstations and personal computers (PCs) that are connected to an IP network are placed at fixed points assuming that each terminal does not serve a mobile use. But, recent improvement in mobile communication technique can mainly provide terminals connected to an IP network with mobility communication service. In order to provide and manage such mobility communication service, a dedicated IP address has to be dynamically assigned to each mobile terminal (hereinafter also called mobile node MN) in the IP network.

There are two reasons for the dynamically assignment of an IP address: one is because a mobile node MN is not able to maintain continuous communication with the IP network. In other words, since an IP network has a structure of multistage interconnection sub-networks (hereinafter also called a “subnet”) and each mobility node MN belongs to one (hereinafter called “the original subnet”) of the subnets, when the mobility node MN moves from the original subnet to another subnet the mobile node MN cannot establish communication with another node which belongs to the same original subnet and communication of the mobility node MN and the IP network is disconnected.

The other reason for the requirement for the dynamically assignment is that a user of an inmobile PC cannot establish communication, e.g., send data aiming to a mobile node MN such as a mobile telephone. As a solution, there is provided various standardized IP protocols for mobile communication. Mobile Internet Protocol version 4 protocol (for example, contents stated in a web site at “http://www.ietf.org/rfc/rfc2002.txt” which is hereinafter called “reference 1”), one of the above standardized IP protocols for mobile communication, enables a mobility node MN to communicate with IP network even after the mobility node changes a point of attachment in the IP network. Mobile Internet Protocol version 4 protocol is standardized by United States' standardization working group IETF (The Internet Engineering Task force).

Hereinafter, Mobile Internet Protocol version 4 will be abbreviated to “mobile IPv4” if further description is not made.

In recent years, a drastic increase in mobility nodes attached to IP networks raises a serious problem of depletion of IP addresses. To solve the problem, IPv6 protocol (Internet Protocol version 6 protocol ((hereinafter also called IPv6), for example, contents stated in a web site at “http://www.ietf.org/rfc/rfc2460.txt” which is called hereinafter “reference 2”) is discussed to make a larger number of IP addresses available. IPv6 uses hierarchical addresses in order to retain a larger number of IP addresses, so that networks can be effectively managed, reducing burden thereon. Working networks have begun communication through IPv6.

A hierarchical address has a 128-bit length: the former-half 64 bit is assigned to a network prefix; and the latter-half 64 bit is assigned to a host ID (identifier). In other words a hierarchical address is a combination of the above two types addresses. Specifically, 128-bit hierarchical address is indicated by eight sets of hexadecimal four digits with colons interposed, as shown in formula (W1).

1040:0A23:0C10:0800:C02D:00FC:E09A:76BB (W1)

Here, a network prefix indicates an ID (or a network address) to identify a network, and a host ID indicates a host computer, aterminal, arouter, aport oran interface. Further, a network prefix is expressed by “address/netmask length”, so that above formula (W1) can be indicated by below formula (W2), for example.

1040:0A23:0C10:0800:0000:0000:0000:0000/64 (W2)

In formula (W2), “0” at the head of each set of four digits and continuing “0s” can be omitted and continuing “0s” interrupted by a colon (:) is indicated by “::”. Above formula (W2) can be therefore indicated by below formula (W3).

1040:A23:C10:800:0:0:0:0/64 (W3)

Further, omitting of the continuing “0s” with colons interrupting changes formula (W3) into below formula (W4).

1040:A23:C10:800::/64 (W4)

A correspondent host computer requires the complete IP address of a destination host computer and a relay router in the network refers only to the prefix of a packet to forward the packet to the destination. In this manner, IPv6 (means IPv6 protocol without further description) guarantees 3.4×10²⁸ IP addresses (on the other hand, the number of 32-bit IP address is 4.3×10⁹). With IPv6, it is therefore possible to provide mobile telephones, car navigation systems, and Internet appliances with IP addresses.

For this reason, in addition to a mobile IP protocol that is used in networks support normal IPv4, the IETF is developing in standardization of mobile IPv6 protocol (for example, the contents stated in a web site at “http://www.ietf.org/internet.drafts/draft-itself-mob ileIP-IPv6-15.txt” which is called hereinafter “reference 3”). The mobile IPv6 is able to support communication of a terminal on the move in an IPv6 network, and is being discussed in the IEFT to be standardized in the IETF RFC (Request for Comments).

The difference of mobile IPv6 from mobile IPv4 is that: mobile IPv6 has a 128-bit IP address; the header is simplified; and an extension header and options are added to the IP address. Further, mobile IPv6 is used in coexistence with mobile IPv4 and communication through mobile IPv6 can be executed in a mobile IPv4 environment. Since mobile IPv4 is substantially identical to mobile IPv6 except the above difference, the description hereinafter is made on mobile IPv6.

If a network supports both IPv4 and IPv6, communication through both mobile IPv4 and mobile IPv6 can be performed in the network. Technique of conversion between mobile IPv4 and mobile IPv6 are being developed.

Mobile IPv6 has a function for continuing communication even when a mobile node MN moves to another attachment to Internet, in addition to the functions of IPv6. In an IPv6 network, when a mobile node MN moves to change the point of attachment to the Internet, the IP address allocated to the mobile node MN is changed to a new one so that data sent from a correspondent reaches an address prior of the change. Namely, mobile IPv6 has a function for managing a move of a mobile node MN.

Through mobile IPv6, a mobile node MN sets (or changes) a care-of address (hereinafter also called CoA) to be used at a visited attachment point as a consequence of a move of the mobile node MN to register the CoA in a homeagent HA that manages a move of the mobile node MN in the home network in which the mobile node usually establishes attachment to Internet. After that, if the mobile node MN moves from the visited attachment point to another attachment point, the mobile node MN informs the homeagent HA of a new CoA, so that homeagent HA registers the new CoA to update the care-of address of the mobile node MN.

If there is a long distance between the homeagent HA and the mobile node on the move, those skilled in the art have pointed out that the problem that registration or update of a care-of address takes a long time. To solve the problem, the IETF proposes a hierarchical (multistage) mobile IPv6 protocol (for example, the contents stated in a web site at “http://www.ietf.org/internet-drafts/draft-ietf-mobil eip-hmIPv6-04.txt” which is hereinafter called “reference 4”) that is functionally extended version of mobile IPv6.

A hierarchical (multistage) mobile IPv4 protocol that is functional extended version of mobile IPv4 is described in a web site at “http://www.ietf.org/internet-drafts/draft-ietf-mobileip-3gwireless-ext-06.txt” (which is hereinafter called “reference 5”).

The hierarchical (multistage) mobile IPv6 protocol and hierarchical (multistage) mobile IPv4 protocol are called hierarchical mobile IPv6 and hierarchical mobile IPv4 in the description hereinafter unless additional explanation is made.

Hierarchical mobile IPv6 introduces a mobility anchor point (hereinafter called a “MAP”) in a visited network so that a local movement of a mobile node MN is hidden from the home agent HA. That can realize a high-speed route switching and can continue communication without informing the homeagent HA of a position registration message (a location registration message, a registration message).

A number of references have been proposed in order to improve the above technique.

Japanese Patent Application Laid-Open (KOKAI) Publication No. 2002-64544 (hereinafter called “reference 6) discloses a method for setting distributed routes, which method provides an IP mobility control technique efficiently utilizes resources even in a large-scale network. Reference 6 also aims to realize a high-speed handover (a high-speed handoff) that has been difficult for a conventional IP mobility control technique).

In mobile IPv4, a packet (also called an IP packet or an IP datagram) is usually forwarded through a mobile node MN (a mobile terminal), a homeagent HA, a correspondent node CN (a source node) and a path via the homeagent HA. Conversely, in reference 6, the homeagent HA notifies the correspondent node CN and a terminal adapter TA that is closer to the correspondent node CN of the current position of the mobile node MN whereupon load on the homeagent HA is reduced and the forwarding path is optimized (by taking a short cut so as not to pass through the homeagent HA.)

Reference 6 refers to technique to solve the problem in the use of a mobile IP on the assumption of communication through a mobile IP, but communication in reference 6 is not executed through a mobile IP protocol.

Another Japanese Patent publication No. 2894443 (hereinafter called “reference 7”) discloses a moving packet routing system that supports a move of an ATM (asynchronous Transfer Mode) host in a network with routers intervening. Another object of reference 7 is to realize a moving-packet routing system able to control assurance of QoS (quality of service (provided by a network)) peculiar to the ATM, using an application. In addition to assurance of QoS peculiar to the ATM, reference 7 aims to eliminate a redundant path by using a short cut that does not pass through routers and the homeagent HA whereupon the system in reference number 7 minimizes a delay in each process. The reference 7 makes the homeagent HA cooperate with an ATM resolution server so that mobile IPv4 works in a ATM-LAN (Local Area Network).

Subsequently, mobile IPv6 will be described in more detail with reference to accompanying drawings FIGS. 31 to 35. FIG. 31 is a diagram showing procedural steps to register the position of a mobile node MN in hierarchical mobile IPv6. Mobile communication system 500 of FIG. 31 supports hierarchical mobile IPv6 and comprises Internet 50 and networks 101, 102 and 103. Internet 50 is a normal Internet and able to deal with communication through IPv6. Network 101 is the home link of a mobile node MN, to which the mobile node MN usually attaches. Networks 102 and 103 are respectively attached to Internet 50. Networks 101, 102 and 103 may be provided by the same telecommunication carrier or by respective different telecommunication carrier A to C. Each of networks 101-103 includes one or more routers, a mobile node and a homeagent.

In FIG. 31, router 1 forwards a packet through IPv6 to the destination. A mobile node MN is a terminal possessed by a subscriber to telecommunication carrier A. The mobile node MN supports hierarchical mobile IPv6 (hereinafter the mobile node is also called a mobile node MN of hierarchical mobile IPv6) and has a home address (for example, “100::10”) used during communication with network 101 to which the node MN is usually attached. Communication between the mobile node MN and another terminal is carried out using the home address. The mobile node MN decides that network 101 is the home network to which the mobile node MN itself belongs. In other words, network 101 is the home link of the mobile node MN.

The homeagent HA manages home network 101 and also supports mobile IPv6. The homeagent HA is attached to home network 101, and, when the mobile node MN moves to another area of another network, receives a registration message issued from the mobile node MN to create a biding cache (a memory retaining the home address of the mobile node MN and CoA (an address, a network prefix and the like)). The homeagent HA receives, in place of the mobile node MN, a packet that is destined to the mobile node MN and that has been issued from another terminal, and forwards the received packet to the CoA indicating the current position of the mobile node MN after the move. In the environment introducing hierarchical mobile IPv6, the homeagent HA does not have special extended functions, thereby being identical in function to a homeagent HA for ordinary mobile IPv6.

Network 102 includes an ordinary IPv6 router and a correspondent node CN, which is a normal terminal (for example, possessed by a subscriber to communication carrier B) attached to network 102 and establishes communication to issue a packet to the mobile node MN.

Network 103 supports hierarchical mobile IPv6 and includes routers 3 to 9. Router 4 also functions as an ordinary router in addition to hierarchical addressing using hierarchical mobile IPv6, and supports terminals attached to access routers (routers) 6 or 7. Router 5 (MAP2) functions as an ordinary router in addition to hierarchical addressing using hierarchical mobile IPv6, and supports terminals attached to access router 8 or 9. Access routers 6 through 9 are ordinary IPv6 routers. A radio antenna section (not shown) used for wireless communication of the mobile node MN may be integrated with each of access routers 6 to 9 or may be installed separately from each access router.

When the mobile node MN moves from network 101 to network 103, the mobile node MN wirelessly attaches to router 6 installed for packet forwarding, and then network 103 automatically assigns a new IP address (a care-of address) to the mobile node MN. The mobile node MN notifies the homeagent HA at network 101 of the assigned care-of address. A succession of the procedural steps will be described in detail with reference to processes (1) to (10) in FIG. 31. A network and a router in the visited network should by no means be limited to the example of FIG. 31.

Process (1): the mobile node MN moves from network 101 to visited network 103 to enter a wireless communication area of access router 6.

Process (2): the mobile node MN receives a router advertisement message (a router advertisement) that access router 6 periodically sends or sends responsive to a request from the mobile node MN. The router advertisement message includes a network prefix (for example, “311::/64”) of a connection link of the mobile node MN and the address (for example, “310::1”) of router 4. The address of router 4 is provided as a MAP option newly defined by hierarchical mobile IPv6. A connection link represents a physical state in which two entities are wirelessly attached in a wireless area.

Process (3): on the basis of the network prefix of the connection link in the received router advertisement message, the mobile node MN creates a “LCoA1” (for example, “311::10”), which means an “On-link”care-of address defined by hierarchical mobile IPv6.

Process (4): on the basis of the 64 bits at the head of the address of router 4 in the received router advertisement message, the mobile node MN creates a “RCoA1” (for example, “310::10”), which means a “regional” care-of address defined by hierarchical mobile IPv6.

Process (5): the mobile node MN sends router 4 a position registration message (binding update: BU) to register the RCoA1 and LCoA1 created by the mobile node MN into router 4.

Process (6): the mobile node MN sends the homeagent HA the position registration message BU to register the home address and RCoA1 created by the mobile node MN into the homeagent HA.

Process (7): upon receipt of the position registration message BU issued in process (5), router 4 creates a binding cache based on the contents of the position registration message BU, which binding cache is a memory a retaining correspondence between the RCoA1 and LCoA1.

Process (8): upon receipt of the position registration message BU, the homeagent HA creates a binding cache based on the contents of the position registration message, which binding cache is a memory retaining a correspondence between the home address and RCoA1of the mobile node MN.

Process (9): router 4 sends the mobile node MN a registration response message (binding acknowledgement: BA) to notify the completion of the registration.

Process (10): the homeagent HA sends the mobile node MN a registration response message (binding acknowledgement: BA) to notify the completion of the registration.

Data that another terminal has issued to the mobile node MN reaches network 101. At that time, since a terminal that is a destination of the issued data is not present in network 101, the homeagent HA retrieves the destination terminal in network 101 and, if the destination terminal is not present in network 101, forwards the issued data to a terminal having the care-of address corresponding to the destination terminal. In this manner, a correspondent terminal can communicate with the mobile node MN automatically (without an extra operation) irrespective of the presence or the absence of the mobile node MN in the network 101.

Procedural steps of packet forwarding after the position registration (the location registration, the registration) of FIG. 31 will now be described with reference to FIG. 32, which is a diagram showing a procedural steps of forwarding a packet through hierarchical mobile IPv6. In FIG. 32, reference numbers identical to those already described refer to elements and parts identical or substantially identical those have been described.

Process (11): the correspondent node CN (having, for example, an address “200::20”) located in network 102 issues a packet destined for the mobile node MN to the home address of the mobile node MN.

Process (12): the homeagent HA of network 101, in place of the mobile node MN, intercepts the issued packet destined for the mobile node MN. On the basis of information retained in the binding cache, the homeagent HA adds anew header to the intercepted packet (the addition of the new address is called “encapsulation”) so that the destination address of the intercepted packet is changed to RCoA1.

Process (13): the homeagent HA forwards the packet encapsulated in the previous process (12) to RCoA1.

Process (14): router 4 intercepts the packet forwarded by the homeagent HA in the previous process (13). On the basis of information retained in the binding cache, router 4 encapsulates the intercepted packet by adding a header which changes the destination address is LCoA1.

Process (15): router 4 forwards to the packet encapsulated in the previous process (14) to LCoA1 whereupon the mobile node MN receives the encapsulated packet. The mobile node MN removes the headers respectively added by router 4 and the homeagent HA from the received packet to obtain the original packet issued by the correspondent node CN.

Subsequently, a handover caused after the position registration of FIG. 31 will now be described with reference to FIG. 33.

FIG. 33 is a diagram showing procedural steps in relation to a handover through hierarchical mobile IPv6 when a MAP is not changed in accordance with a handover of a point of attachment of a mobile node MN. In FIG. 33, reference numbers identical to those already described refer to elements and parts identical or substantially identical those have been described.

Process (21): the mobile node MN moves from the wireless communication area of access router 6 to that of access router 7 in the visited network 103. Here, when the mobile node MN detects that a level of a radio signal received from access router 7 becomes higher than that from access router 6, the mobile node MN switches an attachment router from access router 6 to access router 7.

Process (22): the mobile node MN receives a router advertisement message issues periodically or responsive to a request from the mobile node MN. A router advertisement message includes a network prefix (for example, “312::/64”) of a connection link of the mobile node MN and the address (for example “310::1”) of router 4. The address of router 4 is provided as a MAP option newly defined by hierarchical mobile IPv6, and is identical to that used in process (2) described with reference to FIG. 31.

Process (23): on the basis of the network prefix of the connection link in the received router advertisement message, the mobile node MN creates a LCoA2 (for example, “312::10”). Here, since the address of router 4 is identical to those used in process (2) described with reference to FIG. 31, the mobile node MN recognizes that access router 7 is supported by access router 4 likewise access router 6.

Process (24): the mobile node MN sends router 4 a position registration message BU to register the RCoA1 and LCoA2 newly created by the mobile node MN into the router 4 in the same manner as the process in FIG. 31. At that time, the RCoA1 that has been registered in the homeagent HA requires no change and continues to be used even after the mobile node MN moves to the wireless communication area of router 7, so that the mobile node MN does not sent the homeagent HA a position registration message BU.

Process (25): upon receipt of the position registration message sent in the previous process (24), router 4 updates the binding cache based on the contents of the position registration message in order to retain the correspondence between RCoA1 and LCoA2.

Process (26): router 4 sends the mobile node MN a registration response message BA to notify completion of the update.

Upon completion of a handover of a wireless communication area of the mobile node MN, a packet destined to the mobile node MN is forwarded to router 4 via the homeagent HA in the same manner as process (11)-(13) in FIG. 32. Router 4 intercepts and encapsulates the forwarded packet so that the packet is destined for a router having an address of LCOA2, which has been created after the handover of the mobile node MN, and then sends the encapsulated packet to the proper destination LCoA2. As a consequence, the forwarded packet reaches the mobile node MN through access router 7.

Procedural steps performed when the mobile node MN further moves to cause another handover of a wireless communication area after the handover described with reference to FIG. 33 will now be described with reference to FIG. 34.

FIG. 34 is a diagram showing procedural steps in relation to a handover through hierarchical mobile IPv6 when a MAP is changed in accordance with a handover of a point of attachment of a mobile node MN. In FIG. 34, reference numbers identical to those already described refer to elements and parts identical or substantially identical those have been described.

Process (31): the mobile node MN moves from the wireless communication area of access router 7 to that of access router 8 in the visited network 103. Here, when the mobile node MN detects that a level of a radio signal received from access router 8 becomes higher than that from access router 7, the mobile node MN switches an attachment router to access router 8.

Process (32): the mobile node MN receives a router advertisement message issues periodically or responsive to a request from access router 8. A router advertisement message includes a network prefix (for example, “321::/64”) of a connection link of the mobile node MN and the address (for example “320::1”) of router 5. The address of router 5 is provided as a MAP option newly defined by hierarchical mobile IPv6, but is different from that used in process (2) described with reference to FIG. 31.

Process (33): on the basis of the network prefix of the connection link in the received router advertisement message, the mobile node MN creates a “LcoA3” (for example, “321::10”).

Process (34): since the address of router 5 is different from that used in process (22) in FIG. 33, the mobile node MN recognizes that access router 8 is supported by router 5 (that is different from a router that supports router 7). After that, the mobile node MN creates an “RCoA2” (for example, “320::10” based on the 64 bits at the head of the address of router 5 in the received router advertisement message.

Process (35): the mobile node MN sends router 5 a position registration message BU to register the RCoA2 and LCoA3 created by the mobile node MN into router 5.

Process (36): since a demand for changing the RCoA1 that has been registered in the homeagent HA to the RCoA2 arises, the mobile node MN sends the homeagent HA a position registration message BU to register the “RCoA2” created by the mobile node MN into the homeagent HA.

Process (37): upon receipt of the position registration message sent in the previous process (35), router 5 creates a binding cache based on the contents of the position registration message to retain a correspondence between RCoA2 and LCoA3.

Process (38): upon receipt of the position registration message sent in process (36), the homeagent HA updates the biding cache based on the contents of the received position registration message, so that the updated binding cache retains a corresponding between the home address of the mobile node MN and RCoA2.

Process (39): router 5 sends the mobile node MN a registration response message BA to notify the completion of the registration.

Process (40): the homeagent HA sends the mobile node MN a registration response message BA to notify the completion of the registration.

Upon completion of a handover of a wireless communication area of the mobile node MN, a packet destined for the mobile node MN is intercepted by the homeagent HA in the same manner as described with reference to FIG. 33. The homeagent HA encapsulates the intercepted packet by adding RCoA2 that is a new address of the mobile node MN after the handover and then forwards the intercepted packet to RCoA2. The intercepted packet is further intercepted by router 5, which performs another encapsulation on the packet so that the packet is destined to LCoA3 that is a new address of the mobile node MN after the handover and then forwards the intercepted packet to LCoA3. Finally, the packet reaches the mobile node MN via access router 8.

As shown in FIGS. 31 to 34, if the same MAP is used even when the mobile node MN moves to change an attachment router in hierarchical mobile IPv6, a binding cache registered in the homeagent HA requires no change and only a binding cache registered in the MAP requires to be updated. The MAP is usually disposed in a visited network whereupon the MAP locates near to the mobile node MN. Updating of a binding cache registered in a MAP therefore takes a shorter time than that is performed by the homeagent HA.

In short, hierarchical mobile IPv6 makes it possible to reduce the data amount of position registration message BU sent to the homeagent HA and to realize a high-speed switching of a packet forwarding route.

But, during communication through hierarchical mobile IPv6, there occurs a state of extremely inefficient consumption of resources in the network, which state is to be described with reference to FIG. 35.

FIG. 35 is a diagram showing inefficiency in communication through hierarchical mobile IPv6. In FIG. 35, reference numbers identical to those already described refer to elements and parts identical or substantially identical those have been described. Mobile communication system 500 in FIG. 35 has network 103 that supports hierarchical mobile IPv6 likewise that shown in FIG. 31. In mobile communication system 500, n mobile nodes MNs (n is a natural number more than 1) move into the wireless communication area of router 6 and each of the n mobile nodes MNs sends router 4 a position registration message BU so that router 4 creates binding caches for all of the n mobile nodes MNs. A packet destined for each mobile node MN is intercepted by a non-illustrated homeagent HA registered by the mobile node MN, and then the homeagent HA encapsulates the intercepted packet and forwards the packet to an RCoA of the mobile node MN in the visited network 103. Since the RCoA of each mobile node MN is created based on the address of router 4, a packet each of the homeagents HA has forwarded always reaches router 4 to be intercepted, and then encapsulated so as to be destined for an “LCoA” (an address used in the wireless communication area of router 6) of the corresponding mobile node MN. After that, the encapsulated packet is forwarded to the mobile node MN via access router 6.

Here, considering user's reception of communication service using a mobile node MN, mobile communication system 500 in FIG. 35 is characterized by following two points (Y1) and (Y2).

(Y1): communication service requiring continuity, bidirectionality, real timing, and a high-speed handover is limited to voice communication and videophone communication and the like and a time length for occupying one wireless communication link is short (approximately 3 to 5 minutes).

(Y2): only a few users utilize communication service requiring a high-speed handover such as communication described in (Y1) while they are taking a train or vehicle.

Considering the above points (Y1) and (Y2), most of communication services,.each of which is established by a user at a particular area, accomplish without occurrence of handovers of a wireless communication area of a mobile node MN. Namely, among the n mobile nodes MNs in FIG. 35, only a small number of mobile nodes MN cause handovers of a wireless communication area from access router 6 to access router 7 during communication.

At the extreme, only one from the n mobile nodes MNs moves to cause a handover during communication while the remaining n−1 mobile nodes MNs complete communication within the wireless communication area of access router 6 without moving to that of access router 7. In this case, router 4 receives position registration messages one from each of all n mobile nodes MNs to create binding caches, one for each of n mobile nodes MNs, to encapsulate packets destined to the individual mobile nodes MN. But, this series of process becomes of benefit only one mobile node MN. Conversely, reception of the position registration messages, creation of the binding caches and encapsulation of packets in relation to the remaining n−1 mobile nodes MN, which has not caused communication area handovers, are wasted.

In other words, communication through hierarchical mobile IPv6 causes the remaining n−1 mobile nodes MN to consume additional network resources as compared to communication through normal mobile IPv6.

Assuming that router 4 can retain binding caches, i.e., can supports mobile nodes MN, up ton (natural number). When the (n+1)th mobile node MN moves to the wireless communication area of router 6 (or access router 7), router 4 fails to acquire network resources for the (n+1)th mobile node MN because the entire network resources allocated to router 4 and used even if only network resources for one mobile node MN is effectively used. For this reason, router 4 refuses to create a binding cache for the (n+1)th mobile node MN whereupon the mobile node MN cannot continue communication after a move to the wireless communication area of access router 6 (or access router 7).

As a solution, there are arising requirements for a technique to prevent network resources from being wastefully consumed, avoiding a state in which a mobile node MN cannot continue communication at a wireless communication area of a handover destination, so that communication performed by a larger number of mobile nodes MN can be supported in hierarchical mobile IPv6 network.

Further, a conventional hierarchical mobile IPv6 network needs to dispose lots of high performance MAPs despite of extreme inefficiency in the use of the MAPs. Additionally, increasing facility costs have been loaded on telecommunication carriers to manage, support and maintain the networks.

### SUMMARY OF THE INVENTION

With the foregoing problems in view, it is an object of the present invention to provide a mobile communication method, a mobile communication system, and a router and a mobile node used in the mobile communication system, which can continue communication of the mobile node even when the mobile node moves at a high speed. Another object of the present invention is, with these method system, router and mobile node, to improve effective use of network resources without altering the configuration of an existing network, and also to realize data reception and transmission, reducing packet losses.

To attain the above objects, as a first generic feature, there is provided a mobile communication method for a mobile communication system comprising a mobile node MN, retaining network identification information, and a plurality of multistage interconnection routers including two or more access routers each of which is able to be communicably connected to the mobile node MN, comprising the steps of: (a) establishing communication between the mobile node MN and a first access router that is one from the access routers; at the mobile node MN, (b) issuing, to at least one of the plural multistage interconnection routers, a registration change request to change a first temporary address of the mobile node MN used during the communication with the first access router (6) into a second temporary address of the mobile node MN to be used during with a second access route that is one from the access routers in accordance with a change in the network identification information; at one or more distribution routers among the plural multistage interconnection routers, (c) creating a cache memory retaining the first and the second temporary addresses in correlation with each other based on the registration request issued in the step (b); and (d) forwarding a packet destined for the first temporary address to the second temporary address based on the cache memory created in the step (c).

With this mobile communication method, it is possible to continue communication of a mobile node even when the mobile node moves at a high speed without change of configuration of an existing network, and also to effectively improve usage of network resources and improve data reception and transmission, reducing packet losses.

As a preferable feature (X1), the step (c) may comprise the step of providing the cache created retaining the first temporary address that has been previously registered and the second temporary address included in the registration change request with the first temporary address bound to the second temporary address; and the step (d) may comprise step of forwarding, the packet destined for the first temporary address, which packet is issued from a correspondent node CN and is received by the one or more distribution routers, to the second temporary address.

As another preferable feature (X2), the mobile communication method may further comprise the steps of: at the mobile node MN, creating a third temporary address to be used during communication between the mobile node MN and a third access router which is different from the first and the second access routers in accordance with a change in the network identification information of the third access router, which change is caused by a move of the mobile node MN to establish communication with the third router; issuing, to the one or more distribution routers, a registration update request including the first and the third temporary addresses; upon receipt of the registration update request at the distribution routers, retrieving the first cash included in the registration update request in the cache memory; if the cache memory created by the distribution routers includes the first temporary address, extracting the third temporary address from the registration update request; updating the cache memory by correlating the first temporary address with the third temporary address extracted in the step of extracting; and receiving, in place of the mobile node MN, a packet destined for the first temporary address sent from a correspondent node CN and forwarding the received packet to the third temporary address based on the cache memory.

These preferable features (X1) and (X2) respectively enable data sent through the Internet to reach a distribution router if the mobile node moves to change an access router in communication with the mobile node.

As an additional preferable feature (X3), if the mobile node MN moves to cause a change in access router currently in communication with the mobile node MN while the mobile nodes is in communication with another mobile node or a server, the first-named mobile node MN may issue the registration change request, so that a network does not need to always reserve network resources for mobile communication.

As a further preferable feature (X4), the mobile node MN may be a mobile terminal; the and the step (b) of issuing may be performed when a handover of communication of the mobile node MN with from the first access router to the second access router occurs in a network. With this preferable feature, it is possible to enhance effective usage of network resources to support mobile communication service, reducing packet losses.

As a still further preferable feature, the mobile node MN may be a mobile terminal; and the method may further comprise the steps of: at one or more the access routers included in a network of the mobile communication system, informing the mobile terminal of an advertisement message including network identification information of a network to which the last-named access router is included; at the mobile terminal, creating the third temporary address based on the last-named network identification information included in the advertisement message; issuing a location registration request including the third temporary address to a homeagent HA; at the homeagent HA, creating cache memory retaining a correlation between a home address of the mobile terminal and the third temporary address; forwarding a packet including the third temporary address, sent from the correspondent node CN, to the mobile node MN the based on the last-named cache memory. As a result, it is possible to avoid to waste in using network resources and to guarantee continuous communication of a mobile node in a communication area to which the mobile node has moved to cause a handover.

As a still further preferable feature, if the method is performed through a mobile protocol which enables the mobile terminal to continue communication with an Internet Protocol network even when the mobile terminal moves to change a point of physical attachment to the Internet Protocol network, the mobile terminal may be able to communicate to the Internet Protocol network without updating a point of physical attachment, which updating is performed by the homeagent, so that the mobile communication method can support a large number of mobile nodes.

As a still further preferable feature, if the method is performed through a mobile protocol which enables the mobile terminal to continue communication with an Internet Protocol network even when the mobile terminal moves to change a point of physical attachment to the Internet Protocol network, the mobile terminal may continue to use the contents of a domain name system retaining a host name of the mobile terminal and the first temporary address used prior to the change of a point of physical attachment to the Internet Protocol network in correlation with each other. That can eliminate the requirement of a large number of high-performance MAP disposed in a network.

As a second generic feature, there is provided a mobile communication method for a mobile communication system comprising a mobile node MN, retaining network identification information, and a plurality of multistage interconnection routers including two or more access routers each of which is able to be communicably connected to the mobile node MN, comprising the steps of: at the mobile node MN in communication with a first access router that is one from the access routers, (e) detecting a change in the network identification information which change is caused by a move of the mobile node MN from a first attachment point to a second attachment point; (f) issuing, in accordance with the change detected in step (e) of detecting, a registration change request for changing a first temporary address indicating the first attachment point to a domain name system retaining a host name of the mobile node and the first temporary address in correlation with each other; at the domain name system; (g) updating the contents retained in the domain name system; at a correspondent node CN (h), sending the domain name system an inquiry about the first temporary address associated with the host name; and (i) sending a packet to the first temporary address. In this mobile communication method, if a mobile node has a temporary address used after a move of the mobile node, a correspondent node can grasp the current position of the mobile node by accessing to a domain name system whereby packet forwarding can be carried out without using the homeagent.

As a third generic feature, there is provided a router used in a mobile communication system comprising a mobile node MN, retaining network identification information, and a plurality of multistage interconnection routers including two or more access routers each of which is able to be communicably connected to the mobile node MN, comprising: a cache memory for retaining a first temporary address of the mobile node MN used for communication at a first attachment point; a first receiving section for receiving a first packet issued from the mobile node MN after the mobile node moves from the first attachment point to a second attachment point in a network including the access routers, and receiving a second packet sent from a correspondent node CN; a change arrangement section for changing, if the first packet received by the first receiving section includes a registration change request to change the first temporary address into a second temporary address, the first temporary address retained in the cache memory into the second temporary address; and a first transmitting section for transmitting the second packet received by the first receiving section to the second temporary address that has been changed from the first temporary address by the change arrangement section based on routing information that correlates an address of a next hop node to which the second packet received in the receiving section is to be forwarded with visited network identification information included in the second packet. With this router, a telecommunication carrier can reduce facility costs to manage, support and maintain a network.

Further, it is possible to surely reserve and effectively use resources.

As a preferable feature, the mobile node MN may be a mobile terminal; if the second packet received by the first receiving section includes a registration change request to change the first temporary address into the second temporary address, the change arrangement section may change the first temporary address retained in the cache memory into the second temporary address; and the first transmitting section may transmit the second packet received by the first receiving section to the second temporary address, which has been changed from the first temporary address by the change arrangement section, based on routing information in which an address of a next hop router to which the first packet received in the receiving section is to be forwarded is correlated with visited network identification information included in the second packet and with link information indicating whether the next hop router locates upstream or downstream of the router.

As another preferable feature, the routing table may retain first information correlating the addresses of the next hop router with the visited network identification information and second information correlating the visited network identification information with the link information with the first information correlated with the second information, so that network resources can be dynamically reserved.

As still another preferable feature, the change arrangement section may change the first temporary address to the second temporary address based on particular information of the registration changing request. The particular information is classified into the following (X5) through (X9).

As an additionable preferable feature (X5), the change arrangement section may change the first temporary address to the second temporary address based on the last-named information that is whether or not an output port associated with the first temporary address indicating the destination of the registration change request corresponds to any of one or more output ports retained in the routing table.

As a further preferable feature (X6), the change arrangement section may change the first temporary address to the second temporary address based on the last-named information that is a capacity of resource required for registration an address.

As a further preferable feature (X7), the change arrangement section may cancel the change of the first temporary address to the second temporary address when a predetermined time has passed since the change of the first temporary address to the second temporary address.

As a further preferable feature (X8), the change arrangement section may cancel the second temporary address if the change arrangement section receives a request for a deletion of the second temporary address.

As a further preferable feature (X9), the change arrangement section may delete the second temporary address if the change arrangement section receives a request for a deletion of the second temporary address while, if the change arrangement section does not receive the request for a deletion of the second temporary address, may cancel the change of the first temporary address to the second temporary address when a predetermined time has passed since the change of the first temporary address to the second temporary address.

With the above preferable features (X5) to (X9), address setting is automatically canceled whereupon waste in resource usage is also avoided.

As a still further preferable feature, the first transmitting section may transmit the header of the registration change request to the mobile terminal MN using a destination header conforming to the Internet Protocol version 6 so that resources are reserved without change in format of existing packets.

As a fourth generic feature, there is provided a mobile node used in a mobile communication system comprising the a mobile node MN, retaining network identification information, and a plurality of multistage interconnection routers including two or more access routers each of which is able to communicably connected to the mobile node MN, the mobile node MN comprising: a router identifier retaining section for retaining an identifier of one of the access routers, which one is currently in communication with the mobile node MN; a second receiving section for receiving a packet; a detecting section for detecting that the mobile node MN changes communication with a first access router to that with a second access router on the basis of network identification information included in the packet received in the second receiving section and the identifier retained in the router identifier retaining section; and a second transmitting section for transmitting, if the detecting section detects the change of communication with the first access router to that with the second access router, a registration change request to at least one of the plural multistage interconnection routers retaining a first temporary address of the mobile node MN, which address is used during the communication between the mobile node MN and the first access router such that the first temporary address is changed to a second temporary address to be used for communication between the mobile node MN and the second access router. Advantageously, only when a mobile node changes communication with a first access router to that with a second access router, the mobile node can obtain same result as that obtained when the first temporary address is used.

As a fifth generic feature, there is provided a mobile node used in a mobile communication system comprising the mobile node MN, retaining network identification information, and a plurality of multistage interconnection routers including two or more access routers each of which is able to communicably connected to the mobile node MN, the mobile node MN comprising: a router identifier retaining section for retaining an identifier of one of the access routers, which one is currently in communication with the mobile node MN; a second receiving section for receiving a packet; a detecting section for detecting that the mobile node MN changes communication with a first access router to that with a second access router on the basis of network identification information included in the packet received in the second receiving section, the identifier retained in the router identifier retaining section and the quality of a signal received by the detecting section; and a second transmitter for transmitting, if the detecting section detects the change of communication with the first access router to that with the second access router, a registration change request to the second access router in order to change a first temporary address used during communication between the mobile node MN and the first access router to a second temporary address to be used for communication between the mobile node MN and the second access router.

With this router, since no message is created unless a mobile node changes communication with a first access router to that with a second access router, undue traffic is not generated on a transmission path so that management and maintenance of a network can be efficiently carried out.

As a preferable feature, the second transmitting section may transmit the registration change request to the first temporary address if a distribution router is not determined among the plural multistage interconnection routers while, if the distribution router is determined, the second transmitting section may transmit the registration change request to the distribution router so that a network can provide a mobile node with communication service wherever the mobile node moves.

As another preferable feature, the second transmitting section may send the header of the registration request to the second temporary address using at least one of an IPv6 hop-by-hop options header and an IPv6 destination header whereupon less packet losses ensure communication of the mobile node.

As a sixth generic feature, there is provided a mobile communication system comprising a mobile node MN retaining network identification information and a plurality of multistage interconnection routers including two or more access routers each of which is able to be communicably connected to the mobile node MN, at least one of the plural multistage interconnection routers for forwarding a packet to the mobile node MN comprising: a cache memory for retaining a first temporary address of the mobile node MN used for communication at a first attachment point; a first receiving section for receiving a first packet issued from the mobile node MN after the mobile node MN moves from the first attachment point to a second attachment point in a network including the access routers, and a second packet sent from a correspondent node CN; a change arrangement section for changing, if the second packet received by the first receiving section includes a registration change request to change the first temporary address into a second temporary address to be used for communication at the second attachment point, the first temporary address retained in the cache memory into the second temporary address; and a first transmitting section for transmitting the second packet to the second temporary address, which has been changed from the first temporary address by the change arrangement section, based on routing information in which an address of a next hop router to which the first packet received by the first receiving section is forwarded is correlated with visited network identification information included in the second packet; and the mobile node MN comprising: a router identifier retaining section for retaining an identifier of one of the access routers, which one is currently in communication with the mobile node MN; a second receiving section for receiving the second packet; a detecting section for detecting that the mobile node MN moves to the first attachment point to the second attachment point so that the mobile node MN changes communication with a first access router to that with a second access router on the basis of network identification information included in the second packet received in the second receiving section and the identifier retained in the router identifier retaining section; and a second transmitting section for transmitting, if the detecting section detects the change of communication with the first access router to that with the second access router, a registration change request to change the first temporary address of the mobile node MN, which address is used during the communication between the mobile node MN and the first access router, into the second temporary address to be used for communication between the mobile node MN and the second access router, to the second access router. In this system, hierarchical processing is performed only on a mobile node which actually moves to change a point of attachment and that reduces loads on network.

As a preferable feature, the at least one of the plural multistage interconnection routers may be disposed at a node located on a forwarding route between the first temporary address of the mobile node MN and the second temporary address of the mobile so that facility costs for a network can be reduced.

Since the mobile communication system of the present invention includes at least one of the multistage interconnection routers, which one executes packet forwarding, comprises a cache memory, a first receiving section, a change arrangement section and a first transmitting section, and the system further includes a mobile node comprising a router identifier retaining section, a second receiving section, a detecting section and a second transmitting section. With this configuration, the mobile communication system of the present invention can support communication of an increased number of mobile nodes.

As another preferable feature, the change arrangement section may send the mobile node a confirmation response in response to the registration request issued by the mobile node MN so that communication service can be improved since a large number of mobile nodes can continue communication even if the mobile nodes move to cause handovers.

Other objects and further features of the present invention will be apparent from the following detailed description when read in conjunction with the accompanying drawings.

### BRIEF DESCRIPTION OF THE DRAWINGS

FIG. 1 is a diagram schematically showing a mobile communication system according to a first embodiment of the present invention;

FIG. 2 is a block diagram schematically showing elements of a mobile node according to the first embodiment;

FIG. 3 is a block diagram showing elements of arouter according to the first embodiment;

FIG. 4 is a flow diagram illustrating a succession of procedural steps performed by the mobile node of FIG. 2 according to the first embodiment;

FIG. 5 is a flow diagram illustrating a succession of procedural steps performed by a distribution router according to the first embodiment;

FIG. 6 is a diagram showing a manner of determining of a distribution router according to the first embodiment;

FIGS. 7 to 10 are diagrams respectively showing arrangements (first to fourth example) of routers according to the first embodiment;

FIGS. 11 and 12 are tables respectively illustrating first and second examples of a routing table according to the first embodiment;

FIG. 13(a) is a diagram illustrating an example of a registration request message according to the first embodiment;

FIG. 13(b) is a diagram illustrating an example of a format of a registration response message according to the first embodiment;

FIG. 13(c) is a diagram illustrating an example of a registration updating message according to the first embodiment;

FIG. 14 is a diagram illustrating procedural steps of a position registration according to the first embodiment;

FIG. 15 is a diagram illustrating procedural steps of a position registration and packet forwarding performed prior to occurrence of a handover of a wireless communication area according to the first embodiment;

FIG. 16 is a diagram illustrating procedural steps in relation to a handover of a wireless communication area performed subsequent to a position registration according to the first embodiment;

FIG. 17 is a diagram illustrating procedural steps of packet forwarding after occurrence of a handover of a wireless communication area according to the first embodiment;

FIG. 18 is a diagram illustrating procedural steps of a handover of a wireless communication area and packet forwarding performed after a change of an access router in communication according to the first embodiment;

FIG. 19 is a diagram illustrating procedural steps in relation to another handover of a wireless communication area under another access router after the first handover according to the first embodiment;

FIG. 20 is a diagram illustrating procedural steps of packet forwarding to an access router after a handover of a wireless communication area according to the first embodiment;

FIG. 21 is a diagram illustrating procedural steps of another handover of a wireless communication area and packet forwarding according to the first embodiment;

FIG. 22 is a diagram illustrating procedural steps of a position registration performed in the wireless communication area under an access router according to the first embodiment;

FIG. 23 is a diagram illustrating of procedural steps of a position registration and forwarding another packet according to the first embodiment;

FIG. 24 is a diagram illustrating of procedural steps in relation to a handover of wireless communication area after a position registration according to the first embodiment;

FIG. 25 is a diagram illustrating procedural steps of packet forwarding performed after occurrence of a handover of a wireless communication area of a router according to the first embodiment;

FIG. 26 is a diagram illustrating alternative procedural steps in relation to a handover from a wireless communication area of a router to that of another router and packet forwarding to a mobile node MN in the wireless communication area of the last-named router according to the first embodiment;

FIG. 27 is a diagram schematically showing an IP network according to a second embodiment of the present invention;

FIG. 28 is a diagram illustrating procedural steps of updating DNS performed in the wireless communication area of an access router according to the second embodiment;

FIG. 29 is a diagram illustrating procedural steps of a handover of a wireless communication area under an access router and packet forwarding according to the second embodiment;

FIG. 30 is a diagram illustrating an example in which a distribution router of the first embodiment serves to function as an access router;

FIG. 31 is a diagram illustrating procedural steps of a position registration in hierarchical mobile IPv6;

FIG. 32 is a diagram illustrating procedural steps of packet forwarding in hierarchical mobile IPv6;

FIGS. 33 and 34 are diagrams respectively illustrating procedural steps of a handover of a wireless communication area occurred via hierarchical mobile IPv6; and

FIG. 35 is a diagram showing inefficiency in communication through hierarchical mobile IPv6.

### DESCRIPTION OF THE PREFERRED EMBODIMENTS

Various preferred embodiments of the present invention will now be described with reference to the accompanying drawings.

### (A) First Embodiment

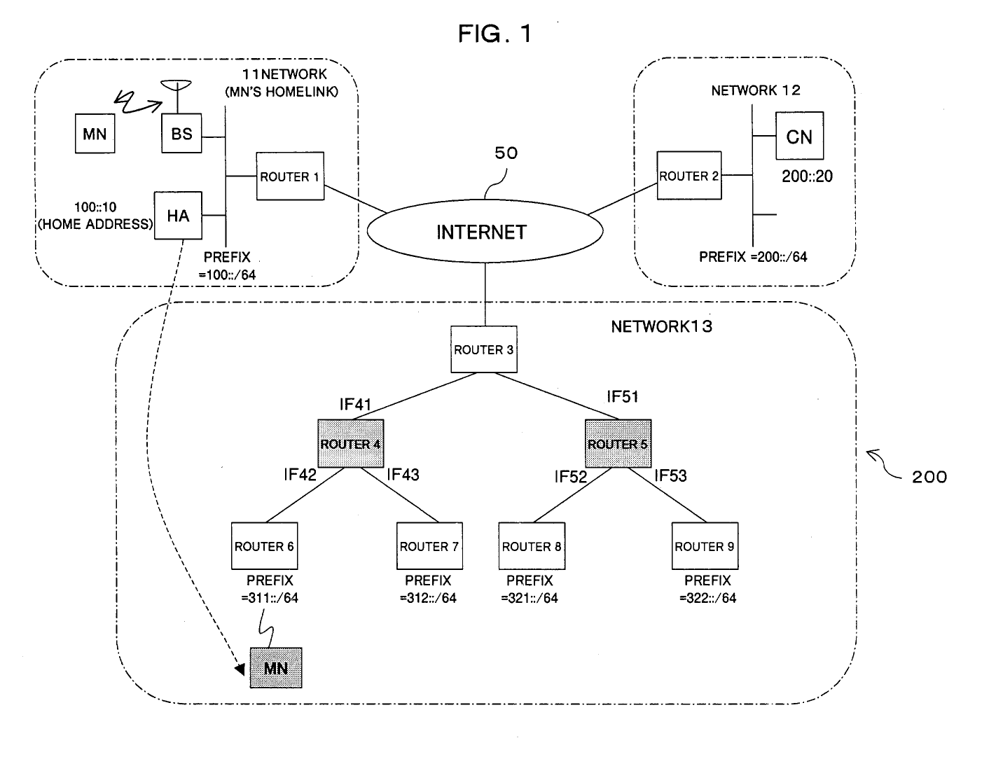

FIG. 1 shows a mobile communication system according to a first embodiment of the present invention. Mobile communication system 200 of FIG. 1 forwards an IP packet through mobile IPv4 and mobile IPv6, and includes network (hereinafter also called “home networks” or “home link”) 11, networks 12 and 13 and Internet 50.

Networks 11, 12 and 13 may be managed by respective different telecommunication carriers A-C or may be managed by the same telecommunication carrier. Each of networks 11, 12 and 13 can receive packets from and sent packets to other networks in mobile communication system 200. Internet 50 can receive IP packets and send IP packets, and carry out communication supported through IPv6.

(1) Description of each Node in Mobile Communication System 200:

(1-1) Mobile Node MN:

A mobile node MN is exemplified by a mobile telephone or a mobile terminal that subscribes to telecommunication carrier A. Network 11 has provided the mobile node MN with a home address (a fixed address) for a predetermined time period. When the mobile node MN moves to network 13, network 13 provides the mobile node MN with a temporary care-of address (hereinafter also called a CoA). After that, the mobile node MN communicates with a correspondent node CN disposed (a correspondent mobile node and a correspondent mobile terminal) at network 12 using the care-of address (temporary address).

The mobile node MN has functions of: receiving and sending of audio data and other type of data; creating a new CoA when a handover of a wireless communication area and retaining a previous CoA used immediately prior to the handover; and sending a registration request message (a registration change request) to mobile communication system 200 so that a packet destined for the previous CoA is forwarded to the new CoA. The mobile node MN does not reserve resources, such as acache, to send the registration request message and to carry out a handover of a wireless communication area as long as a handover occurs.

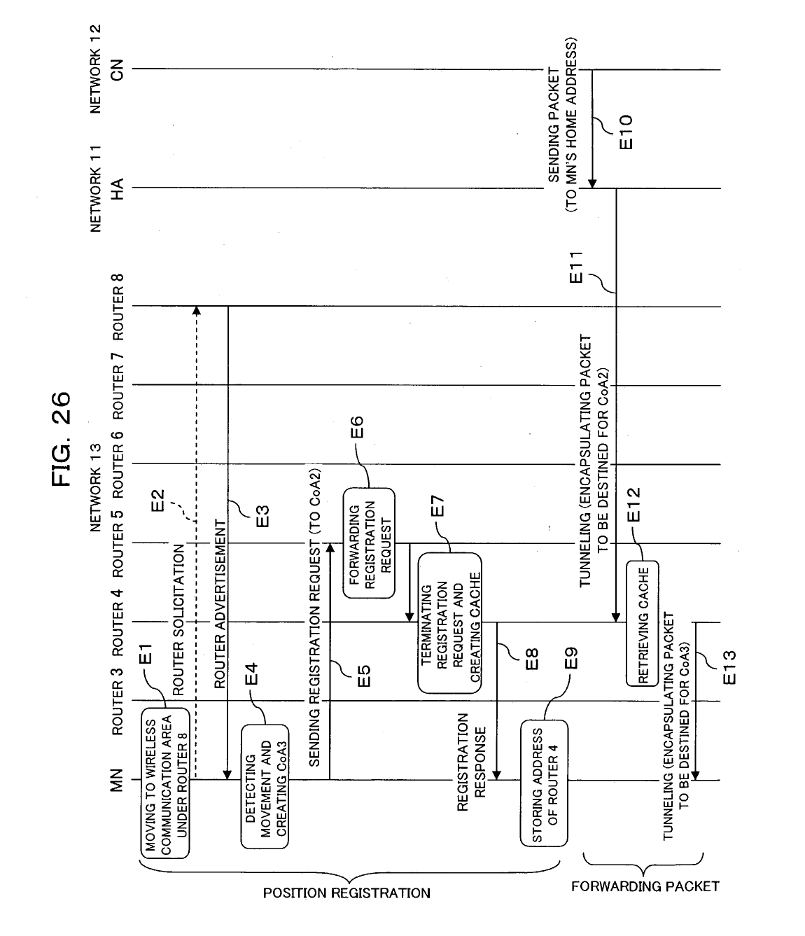

The mobile node MN does not have to support hierarchical mobile IPv6 protocol and mobile IPv6. Also in the second embodiment (to be described with reference to FIGS. 26 to 29) which uses a DNS (a domain name system), the mobile node MN does not have to support hierarchical mobile IPv6 protocol and mobile IPv6. A detailed description of elements or parts of the mobile node MN will be made later.

(1-2) Function of Routers (Distribution Routes) 4 and 5:

(1-2-1) Function for Normal Forwarding:

Each of distribution routers (forwarding point routers, cross point routers) 4 and 5 carries out normal packet forwarding and distribution (of packets) according to the present invention.

Distribution router 4 distributes a packet received from uplink router 3 to a corresponding one of downlink routers (access routers) 6 and 7.

The wording “uplink” means the upstream side, i.e., a connection link (one or more physical wireless communication links) to a router (router 3 in FIG. 1) disposed the nearer side to Internet 50.

On the other hand, the wording “downlink” means the downstream side, i.e., a connection link to the nearer side to a mobile node MN. In other words, a downlink is a link to a forwarding link to the next router arranged in the nearer direction with respect to a mobile node MN.

In the same manner, distribution router 5 distributes a packet received from uplink router 3 to a corresponding one of downlink routers (access routers) 8 and 9.

Each of distribution routers 4 and 5 has functions of creating of a cache, forwarding a packet to a new CoA based on the created cache. Distribution routers 4 and 5 are identical in configuration, functions and other features, so a description is made focusing on distribution router 4 and repetitious description on distribution router 5 is omitted here.

(1-2-2) Function for Creating Cache:

Distribution router 4 detects a registration request message issued from a mobile node MN, and, if the registration request message satisfies requirement (hereinafter called “interception requirements”) for interception, intercepts the registration request message. After that, distribution router 4 analyzes the contents of the intercepted message and creates a cache to forward a packet destined to the previous CoA to the new CoA. Conversely, if the registration request message does not satisfy the interception requirements, distribution router 4 does not intercept the message and forwards the message to the original destination i.e., the previous CoA, by performing a normal routing operation.

Distribution router 4 defines the following two points as the interception requirements to intercept a registration request message: the first requirement is that the outputting interface of the destination of registration request message issued from the mobile node MN is in a downlink; and the second requirement is that, if the number of caches that distribution router 4 can create is limited, the number of caches being created by distribution router 4 does not reach the upper limit and the unused resources allocated for distribution router 4 affords to create a cache.

(1-2-3) Function for Forwarding a Received Packet to a new CoA:

Mobile communication system 200 has message identifiers for a position registration message (a location registration message, a registration message), a registration updating message, and a registration response message, in addition to a message used for mobile IPv6.

If distribution router 4 receives a packet destined to the previous CoA the mobile node MN while retaining the created cache, distribution router 4 forwards the received packet to a new CoA based on the created cache.

First of all, the mobile nodeMN sends a registration request message (a registration change request) to one (for example, access router 7) from access routers 6-9 so that the previous care-of address used prior to a move of the mobile node MN is changed to another care-of address enables the mobile node MN to wirelessly attached to the one access router 7, which is different from access router 6, based on a change in the network prefix, in the mobile communication method of the present invention.

After that, distribution router 4 creates a binding cache retaining the previous care-of address which has been registered and which is used prior to the move of the mobile node MN and the new care-of address which is included in the registration request message and which is to be used after the move with the new care-of address bound to the previous care-of address.

Distribution router 4 receives, in place of the mobile node MN, a packet which is destined to the mobile node MN and which has been issued from the correspondent node CN, and then forwards the received packet to a new care-of address used after the move of the mobile node MN.

As a result, the present invention dynamically acquires network resources for one or more from a plurality of mobile nodes MN wirelessly attached to access router 6, which one or more mobile nodes MNs moved to a wireless communication area of other access routers so that the moved mobile nodes MN can perform handovers of a wireless communication area.

Namely, it is possible for a mobile node MN to continue communication even when the mobile node MN moves at a high speed and it is possible to improve efficiency in use of network resources without requiring configuration of the network whereupon effective data transportation can be realized, reducing packet loss.

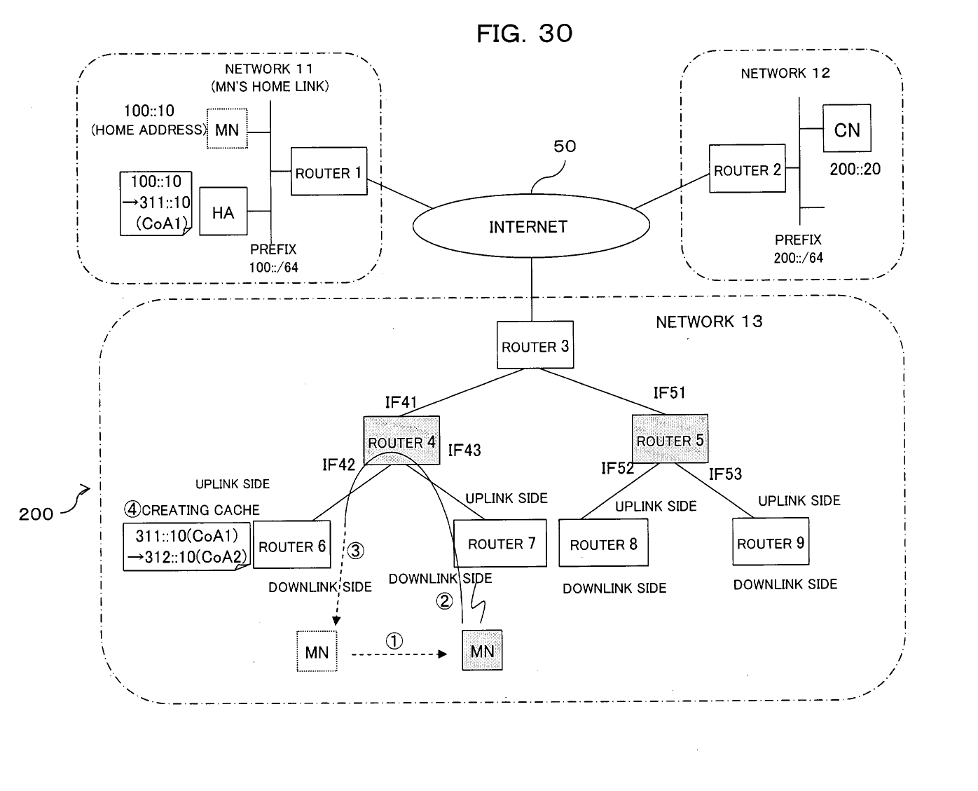

In mobile communication system 200, at least one router (exemplified by distribution routers 4 and 5) with a function of packet distribution has to be arranged on a packet transportation path extending from the previous CoA to the new CoA. Routers 4 and 5 arranged in the uplink direction of access routers 6 to 9 can serve as routers with a function of packet distribution. Alternatively, each of access routers 6 to 9 may serve as a router with a function of packet distribution, as described later with reference to FIG. 30.

Distribution routers 4 and 5 do not have a function to perform communication through hierarchical mobile IPv6.

(2) Network 11:

Network 11 is the home link (the home network) of a mobile node MN, and includes router 1, the mobile node MN (a mobile terminal), a homeagent HA, and a base station BS that is an example to connect the mobile node MN and homeagent HA.

If networks 11 and 13 are managed by respective different telecommunication carriers A and B, a mobile node MN visit network 13 from network 11.

On the other hand, if the same telecommunication carrier A manages both networks 11 and 13, a mobile node MN establishes communication with a network to which the mobile node MN subscribes. For example, telecommunication carrier A manages networks 11 and 13 and Internet 50 connects a part of network 11 at which the homeagent HA is disposed and a part of network 13 to which the mobile node MN is attached to form mobile communication system 200. At that time, the mobile node MN does not attach to network 11, the home link, and is thereby recognized to always moving outside the home link.

Network 11 is wirelessly connected to the mobile node MN in the first and later-described second embodiments. Alternatively, the mobile node MN may be connected to network 11 via a wire. Router 1 supports mobile IPv6 and/or mobile IPv4 irrespective of the mobile IP, and the homeagent HA that does not support hierarchical addresses also supports mobile IPv6 and/or mobile IPv4.

The mobile IP defines a link which has the homeagent HA and which has a prefix identical to the home address of the mobile node MN as a “home link”, and one or more link other than the home link as “foreign links”. In FIG. 1, when the mobile node MN moves from the home link to another link in network 11 having a plurality of links, the network that the mobile node MN visits is called a “foreign link.”

(2-1) Router 1:

Router 1 forwards a received packet to the destination of the received packet via IPv6 with reference to a routing table retained by router 1.

(2-2) Base Station BS:

The base station BS receives a radio signal from the mobile node MN, demodulates the received radio signal, extract a packet included in the received radio signal and forwards the packet to a destination included in the header of the packet. Additionally, if the destination of a packet received via Internet 50 is a mobile node MN, the base station BS modulates the received packet into a radio signal and sends the mobile node MN the received packet. This radio signal communication carried out by exiting modulation/demodulation and access manners.

A mobile node MN is not always connected to access routers 6 to 9 via the base station BS. Alternatively, network 11 has to include the homeagent HA, but, when the mobile node MN is always in a foreign link and never returned to the home link, network 11 does not have to include a base station BS.

(2-3) Mobile Node MN:

Since the home address does not indicates the current position of the mobile node MN, the correspondent node CN disposed in another network 13 cannot directly send a packet to the mobile node MN when the correspondent node CN does not know the current position. To avoid such inconvenience, the homeagent HA in network 11 retains a correspondence between the home address (for example, “100::10”) of the mobile node MN and a care-of address (for example, CoA1).

The mobile node MN retains a network prefix (network identification information). To the mobile node MN is assigned the home address remains unchanged even if the mobile node MN moves to another position. The home address is used during communication between the mobile node MN and another node or terminal. The home address corresponds to an IP address of a computer such as a fixed PC that utilizes an IP protocol, and, in other words, corresponds to the registered domicile or the homebase. In the illustrated example, the mobile node MN is provided with home address “100::10” used in network 11.

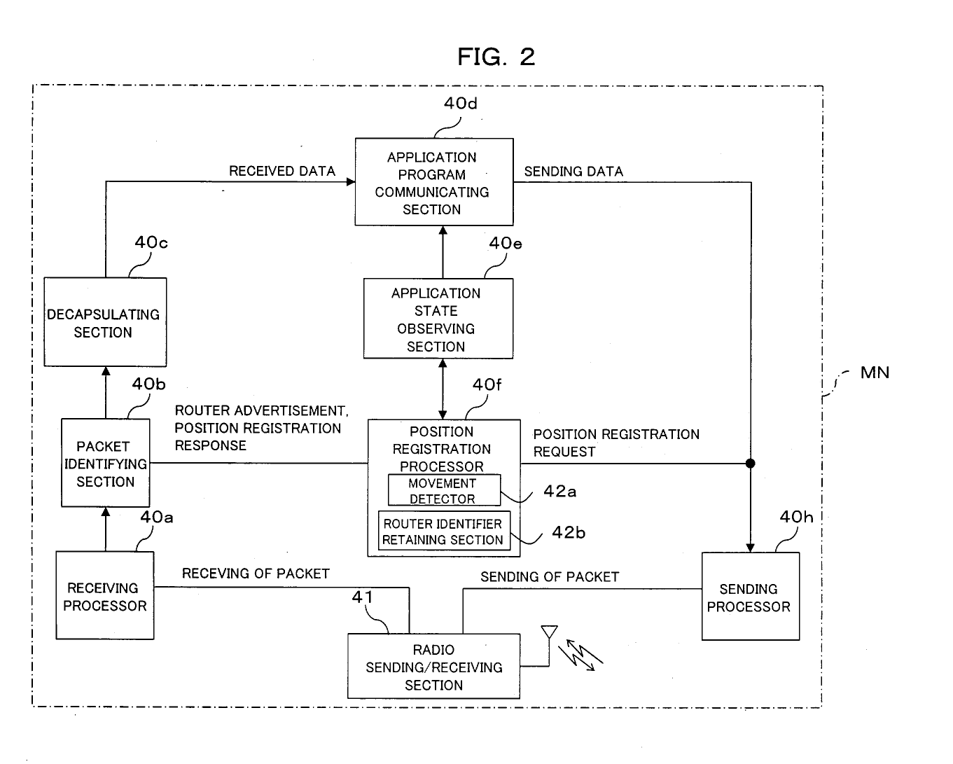

FIG. 2 is a block diagram showing elements of the mobile node MN according to the first embodiment. The mobile node MN of FIG. 2 comprises radio sending/receiving section 41, receiving processor (a second receiving section) 40a, packet identifying section 40b, decapsulating section 40c, application program communicating section 40d, application state observing section 40e, position registration processor (location registration processor, registration processor) 40f, and sending processor (a second sending section) 40h.

Radio sending/receiving section 41, which receives and sends radio signals, receives a radio signal, demodulates the received signal to extract a packet, and output the extracted packet to receiving processor 40a. Radio sending/receiving section 41 also modulates a packet input from sending processor 40h into a radio signal and send the radio signal.

Receiving processor 40a receives a packet (a first packet) issued from the mobile node MN which has moved to network 13 and a packet (a second packet) issued from the correspondent node CN. Then, for example, receiving processor 40a corrects an error in packet data received from radio sending/receiving section 41 and outputs the corrected packet.

Packet identifying section 40b extracts messages classified into a number of types from a packet received from receiving processor 40a to detect the type of the received packet. If the received packet is a data packet, packet identifying section 40b outputs the packet to decapsulating section 40c; and if the received packet is a router advertisement message or a position (location) registration response message (hereinafter abbreviated as a “registration response message”), packet identifying section 40b inputs information included in the message to position registration processor 40f.

Here, a router advertisement message is an acknowledgement message including a prefix of a network to which access routers 6 to 9 (see FIG. 1) belong. Each of access routers 6 to 9 periodically issues such acknowledgement messages. The mobile node MN receives an acknowledgement message to obtain a network prefix of the access router with which the mobile node MN are currently communicating because an IP address that the mobile node MN uses does not identify the base station BS.

Alternatively, each of access routers 6 to 9 may issue an acknowledgement message when a mobile node MN requests to. Of course, the mobile node MN may not be in communication. At that time, a router advertisement message indicates the current position of the mobile node MN.

A registration response message is issued to a mobile node MN by a distribution router to notify that the distribution router has created a binding cache to be described later.

Position registration processor 40f have major three functions of: identifying the current position or the current wireless communication area of the mobile node MN; sending a registration request message to one of access routers 6 to 9 which one controls the current position or the current wireless communication area of the mobile node MN; and receiving a registration response message issued responsive to a registration request message. In order to realize the three functions, position registration processor 40f include router identifier retaining section 42b and movement detector (detecting section) 42a.

Router identifier retaining section 42b retains the IPv6 address of one of access routers 6 to 9 which one is communicating with the mobile node MN, for example. Namely, position registration processor 40f retains information of the one of access routers 6 to 9 which one is communicating with the mobile node MN on the basis of the router advertisement message. When the mobile node MN is to issue a registration request message, sending processor 40h reads the information of the one of access routern6 to 9 which one is the destination of the registration request message, and inserts the read information into the registration request message. Further, when a registration response message is received, router identifier retaining section 42b compares information included in the registration response message with the retaining information to confirm that the one access router of access routers 6 to 9 which one has been registered is specified.

Movement detector 42a detects a change in wireless communication area from that of the one of access routers 6 to 9 to that of another one of access routers 6 to 9 based on the network prefix included in a packet (a router advertisement message) received in receiving processor 40a and the IPv6 address of the one access router retained in router identifier retaining section 42b.

The mobile node MN sends the registration request message when the mobile node MN moves to a wireless communication area of another access router while the mobile node MN is in communication with another mobile node or a server.

In the mobile communication method of the present invention, only a mobile node MN which has moved to cause a handover of a wireless communication area issues a registration request message so that the corresponding distribution router creates cache only the moved mobile node MN in response to the registration request message at the time of the handover. As a result, it is possible to improve the performance communication compared with a conventional manner using hierarchical mobile IPv6.

In other words, a mobile node MN issues a registration request message only when the mobile node MN moves to another cell and is in communication with another mobile node, a server or the like. Presence or absence of a communication application currently running or TCP session determines whether or not the mobile node MN is in communication. The present invention assumes that application state observing section 40e in FIG. 2 monitors the presence or absence of a communication application currently running or TCP session.

This dynamically creation of a cache is performed by one of the following two manners (Z1) and (Z2) of issuing of a registration change request:

(Z1) a registration change request is issued each time a mobile node MN moves to cause a handover of a wireless communication area; and

(Z2) a registration change request is issued when a mobile node MN moves to cause a handover of a wireless communication area only while the mobile node MN is in communication.

Manner (Z2) is more effective than manner (Z1).

Decapsulating section 40c removes the header from an encapsulated packet inputted from packet identifying section 40b and outputs the received data to application program communicating section 40d.

Application program communicating section 40d carries out voice communication and data communication. Application state observing section 40e controls or manages one or more application programs (hereinafter abbreviated as “applications”) currently running, for example, controls and manages a state of physical or logical attachment currently used by the mobile node MN.

Upon detection of a change in wireless communication area by movement detector 42a, sending processor 40h issues a registration request message to an entity retaining the previous care-of address of the mobile node MN used prior to the detected change so that the previous care-of address is changed to a new care-of address.

Application program communicating section 40d communicates with the correspondent node CN and a position registration message is destined for the previous CoA.

Respective different packets are created, one including data inputted from application program communicating section 40d and the position registration message data inputted from position registration processor 40f, and are output to radio sending/receiving section 41. A destination address of application program communicating section 40d is described in more detail.

When a distribution router 4 or 5 has not decided, sending processor 40h sends a position registration message to the previous care-of address used prior to the change in a wireless communication area. When router 4 is determined as the distribution router, the position registration message is sent to distribution router 4. Mobile communication system 200 can therefore provide the mobile node MN with communication service wherever the mobile node MN moves.

Sending processor 40h uses an IPv6 hop-by-hop options header or an IPv6 destination options header to send the header of the position registration request message (the location registration request message, the registration request message) and to receive a registration response message.

That reduces packet losses and realizes reliable communication. It is possible to perform an operation to acquire network resources without changing the exiting packet format.

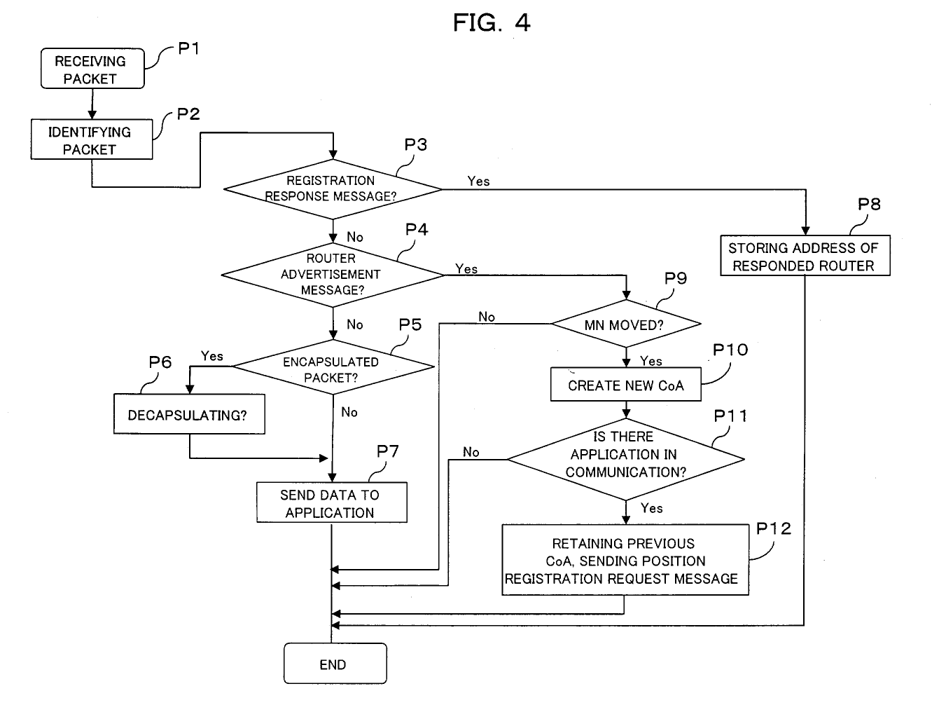

FIG. 4 is a flow diagram illustrating a succession of procedural steps performed by the mobile node MN of FIG. 2 according to the first embodiment. Upon receipt of a packet (step P1), the mobile node MN identifies the packet (step P2) and packets whether or not the packet is a registration response message (step P3). If the received packet is a registration response message, the procedural steps take the Yes route on which the mobile node MN stores the address of the source router of the registration response message (step P8) to complete the procedural steps. Conversely, if the received packet is determined not to be a registration response message at step P3, the procedural steps take the No route. Further, if the received packet is determined to be a router advertisement message at step P4, the procedural steps take the Yes route so that the mobile node MN confirms whether or not the mobile node MN itself has moved (step P9). In step P9, if the mobile node MN determines that the mobile node MN has not moved, the procedural steps take the No route and are completed. On the other hand, if the mobile node MN determines that the mobile node has moved at step P9, the Yes route is taken so that a new CoA is created (step P10). In the next step P11, whether or not an application program in communication is checked. If there is a program in communication, the procedural steps take the Yes route to retain the previous CoA and send a position registration request message (step P12). Conversely, if there is no program in communication, the procedural steps take the No route and are completed.

If the received packet is determined not to be a registration response message in step P4, the procedural steps take the No route on which the received packet is checked to be or not to be an encapsulated packet (step P5). If the result of the checking is negative, the received packet is sent to application program communicating section 40d (abbreviated to “application” in FIG. 4)(step P7) to complete the procedural steps. If the result of the checking in step P5 is positive, the procedural steps take the Yes route to decapsulate the received packet (step P6) and are completed.

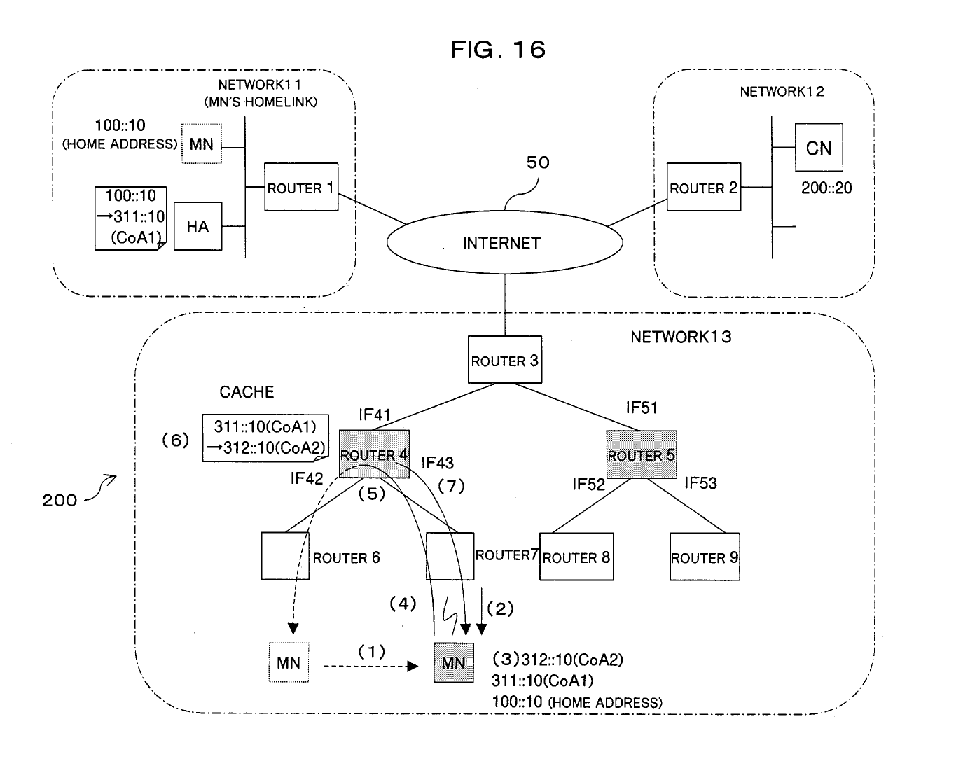

After the procedural steps of FIG. 4, the mobile communication according to the first embodiment is carried out. First of all, the mobile node MN located in network 11 shown in FIG. 16 moves to network 13. The mobile node MN appreciates a change in a wireless communication area by a change in a level of a received radio signal.

After that, when the mobile node MN moved to network 13 further moves from the wireless communication area of the first access router (here, access router 6) to that of the second access router that is one from the remaining access routers 7 to 9, the mobile node MN sends the second access router a registration request message so that the previous care-of address used prior to the latest move is changed to a new care-of address to be used after the move.

In the illustrated example of FIG. 16, the second access router, i.e., the destination of the registration request message, is access router 7. The registration request message may be sent to access router 8 or 9, of course.

Subsequently, router 4 is determined as the distribution router in accordance with the position of access router 6 and the second access router (one from the remaining access routers 7 to 9). Distribution router 4 is a communication node disposed at the uplink of access routers 6 to 9 and connected to the first and the second access routers in the downlink direction.

Distribution router 4 creates a cache having a correspondence between the previous care-of address and the new care-of address included in the registration request message so that distribution router 4 forwards a packet destined to the previous care-of address to the new care-of address based on the created cache.

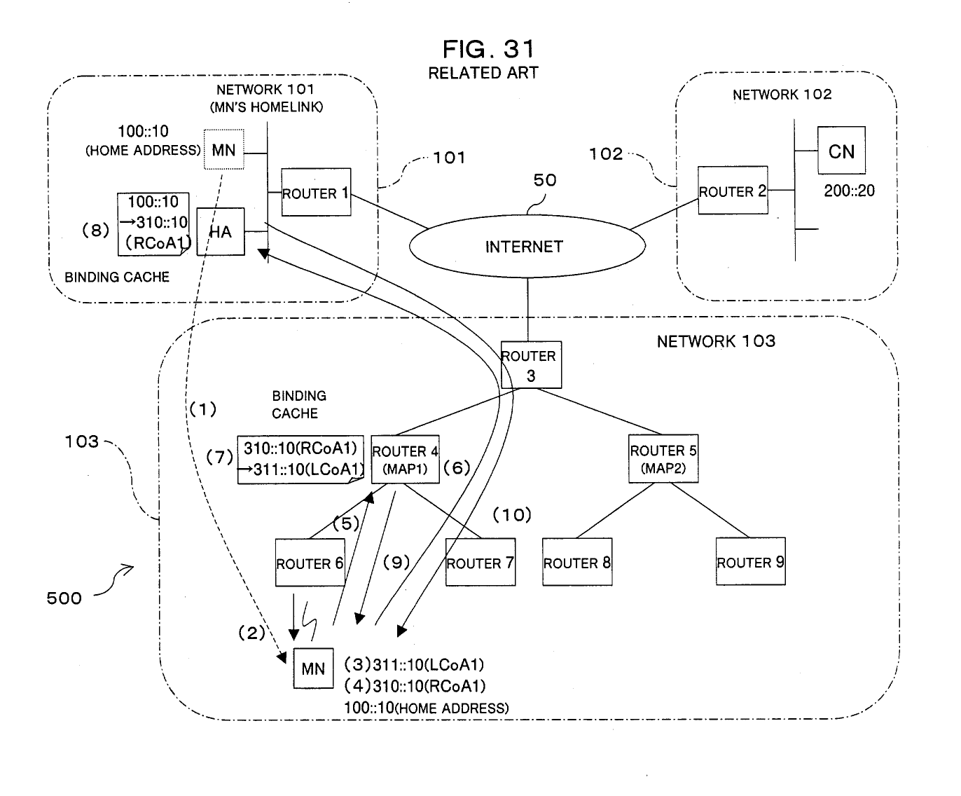

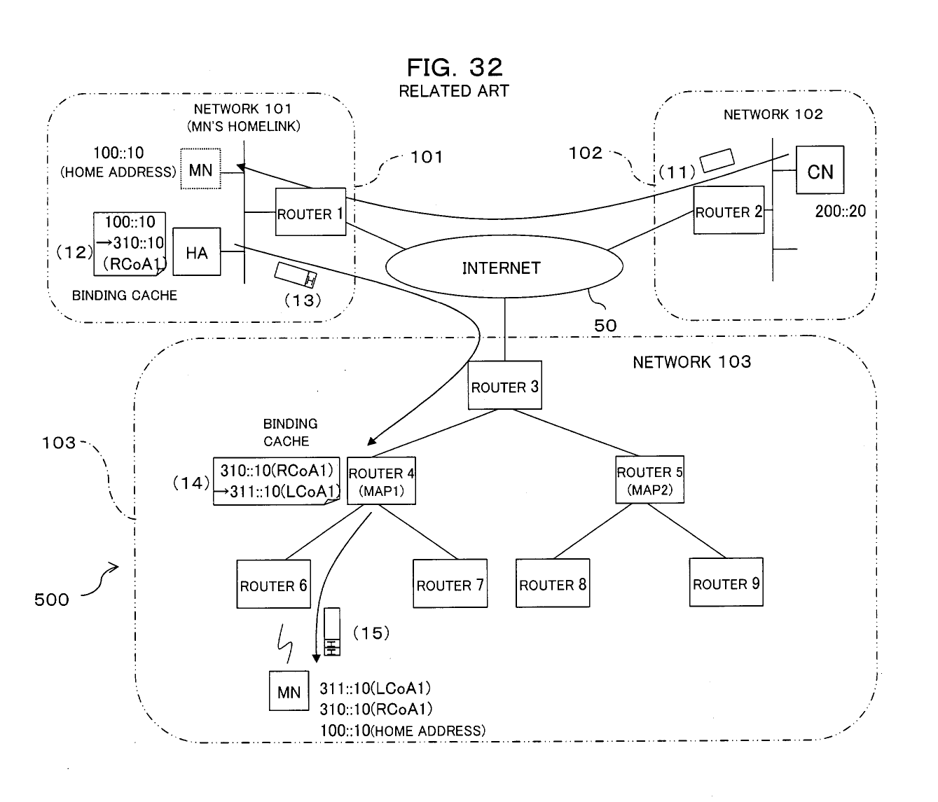

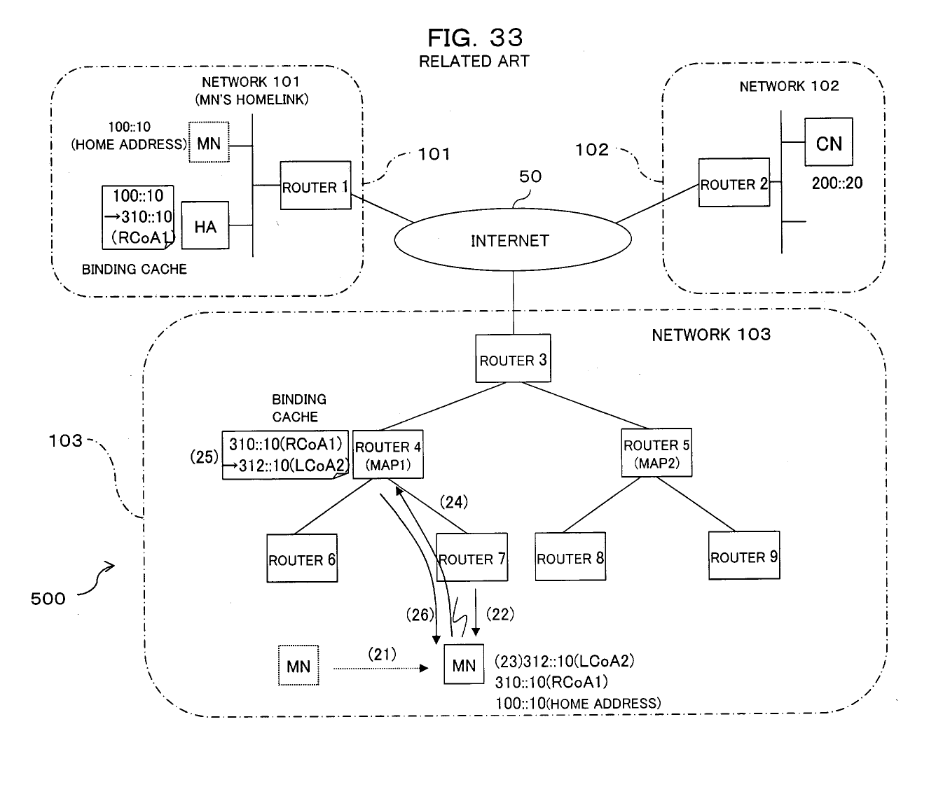

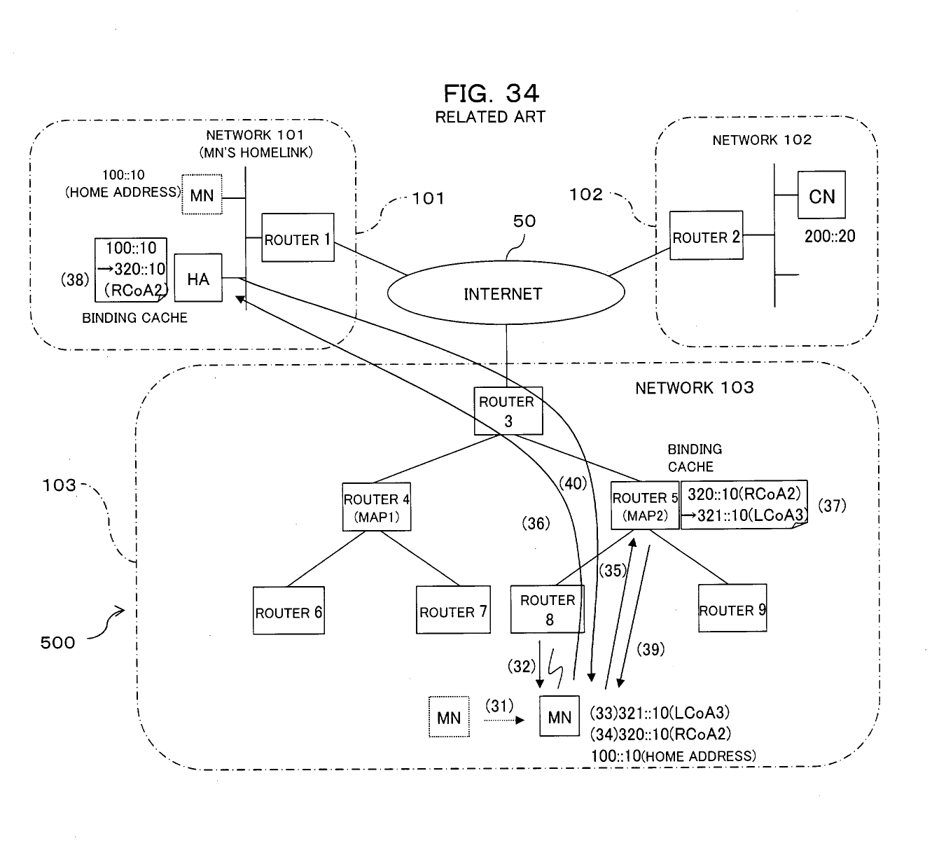

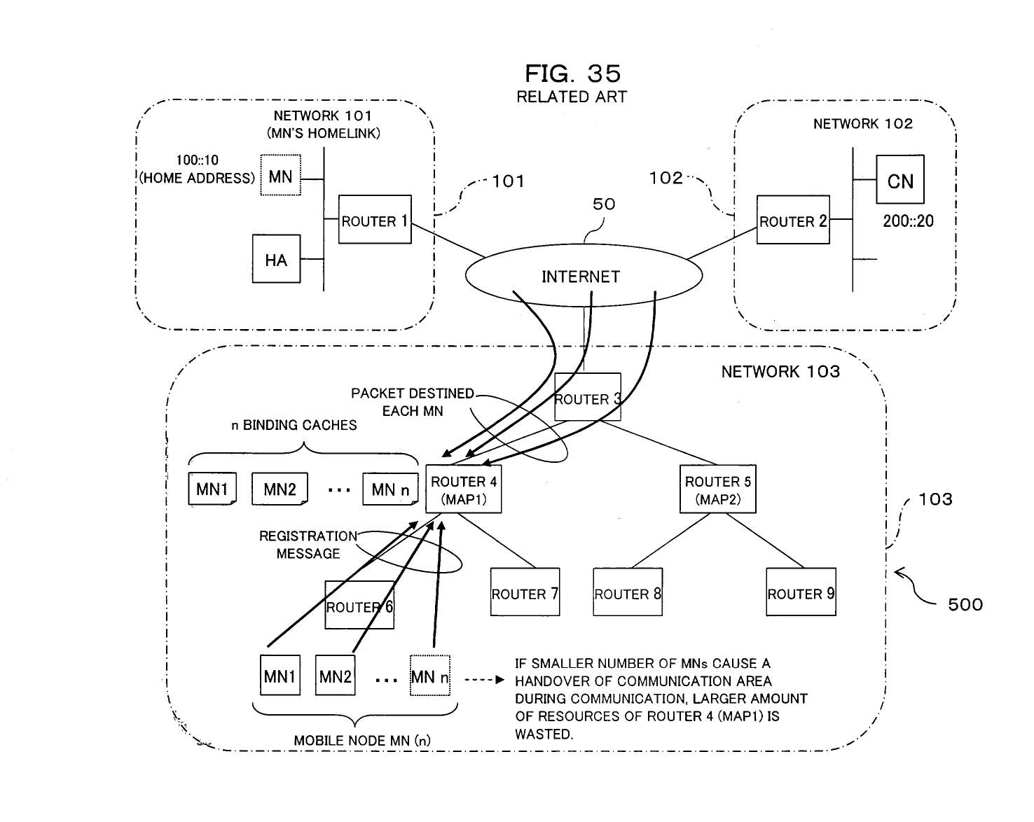

Focusing on distribution router 4, a conventional router 4 (see FIGS. 31 to 35) requires a process for hierarchical addressing through hierarchical mobile IPv6. Further, the conventional router 4 has performed hierarchical addressing on a number of mobile nodes MN currently located in the wireless communication areas of access routers 6 and 7 (the first and the second access routers) whereupon the process put a large load on the conventional router 4.

In the mobile communication method of the first embodiment, since distribution router 4 deals with only the mobile node MN which has actually caused a handover of a wireless communication area from access router 6 to access router 7, the load on distribution router 4 is greatly reduced.

Additionally, if distribution router 4 registers new care-of address of only a mobile node MN that has caused a handover of a wireless communication area while a currently operating application has been on communication, the throughput of distribution router 4 is further improved.

As described above, a reduced amount of loads on distribution router 4 increases network resources to be effectively used.

(2-4) Homeagent HA (see FIG. 1)

The homeagent HA receives, in place of the mobile node MN, a packet issued to the mobile node MN from the correspondent node CN and forwards the received packet to a care-of address (a temporary address) indicating the current position of the mobile node MN as a consequence of a move of the mobile node MN. The homeagent HA has a home address “100::1.”

The homeagent HA has a function for managing the current position each node or terminal belongs to network 11 in addition to a function for packet forwarding. In order to realize the position management, when the mobile node MN moves, for example, to a wireless communication area in network 13 from network 11, the homeagent HA instructs a mobile node MN to send a position registration message including information of a current position of the mobile node MN from the visited network 13.

(3) Network 13 (See FIG. 1):

Network 12 is attached to Internet 50 and includes router 2 and the correspondent node CN (also called the “source terminal”, the “correspondent node” and the “correspondent terminal”). Router 2 forwards a packet to the designated destination through IPv6 with reference to a routing table prepared beforehand.

The correspondent node CN is a normal terminal (subscribed to telecommunication carrier B) attached to network 12 and communicates with a mobile node MN to send a packet including voice data to the mobile node MN.

(4) Network 13:

Network 13 communicates with networks 11 and 12 via Internet 50 and includes router 3, distribution routers (distribution communication nodes) 4 and 5, and routers (access routers, or access communication nodes) 6 to 9. Routers 3 to 9 serve as communication nodes.

(4-1) Access Routers 6 to 9:

Each of access routers 6 to 9 can communicate with a mobile node MN, which has been moved to the wireless communication area of the router. In the first and second embodiments, a mobile node MN is wirelessly attached to each of access routers 6 to 9 via a radio base station, which however does not appear in the accompanying drawings. The radio base station comprises an antenna to receive and transmit a radio signal, and functions to receive and transmit the radio signal and to modulate and demodulate data. This radio signal communication carried out by any exiting modulation/demodulation and access manners.

(4-2) Router 3:

Router 3 forwards a packet to the designated destination through IPv6 with reference to the routing table prepared in advance. Router 3 may also serve as a gateway between Internet 50 and network 13.

(4-3) Function of Distribution Routers 4 and 5:

Distribution routers 4 and 5 are respectively located at the uplink of the first access routers 6 to 9 (the second access router), and connected to each of access routers 6 to 9 (the first access router) in the downlink direction. Information (downlink information) on one or more routers connected in the downlink direction is set by the network administrator based on the configuration of mobile communication system 200. Alternatively, the downlink information may be set by automatically exchanging routing information.

Distribution router 4 supports (also called “has command of”) a mobile node MN, which is wirelessly attached to access routers 6 or 7 to communicate. Distribution router 5 has command of access routers 8 and 9, and has a normal routing function to forward a received packet to the destination designated in accordance with the header of the received packet.

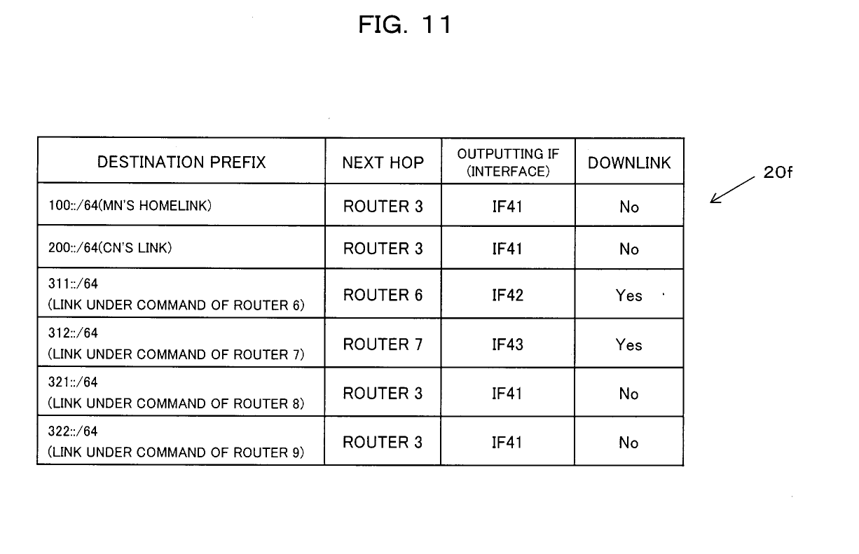

Distribution router 4 further includes outputting interface ports (outputting interfaces, indicated by “IF” in drawings) 41, 42, and 43 corresponding paths to input and output packets, and observes outputs and inputs of packets through outputting IFs 41, 42 and 43. The observing is performed with reference to information retained in routing table 20f (see FIG. 11). For this purpose, routing table 20f retains and mutually associates a network prefix, a next hop and a downlink.

Similarly, distribution router 5 includes outputting IFs 51, 52 and 53, to observe outputs and inputs of packets. Here, outputting IF 41 is disposed in the uplink direction of distribution router 4; and outputting IFs 42 and 43, in the downlink direction.

(4-4) Configuration of Distribution Routers 4 and 5:

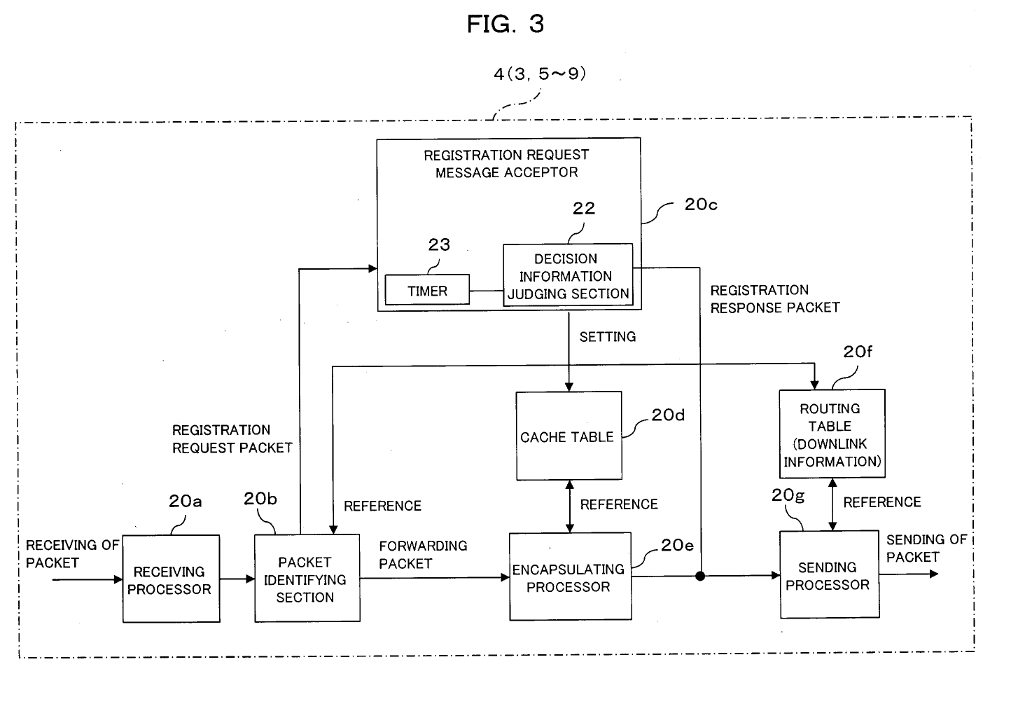

The configuration of distribution routers 4 and 5 will now be described in further detail with reference to FIG. 3.

FIG. 3 is a block diagram schematically showing distribution router 4 of the first embodiment. Distribution router 4 of FIG. 3 includes receiving processor (first receiving section) 20a, packet identifying section 20b, registration request message acceptor 20c, cache table 20d, encapsulating section 20e, routing table 20f and sending processor (first sending section) 20g.

(4-4-1) Receiving Processor 20a:

Receiving processor 20a receives a packet (a first packet) issued from a mobile node MN which has moved to network 13 and a packet (a second packet) issued from the correspondent node CN.

(4-4-2) Packet Identifying Section 20b:

Packet identifying section 20b extracts messages classified into a number or types from a packet received in receiving processor 20a. If the received packet has an identifier that indicating the packet is to be forwarded, packet identifying section 20b outputs the packet to encapsulating section 20e; and if the received packet is a registration change request (a registration request message), packet identifying section 20b outputs the packet to registration request message acceptor 20c.

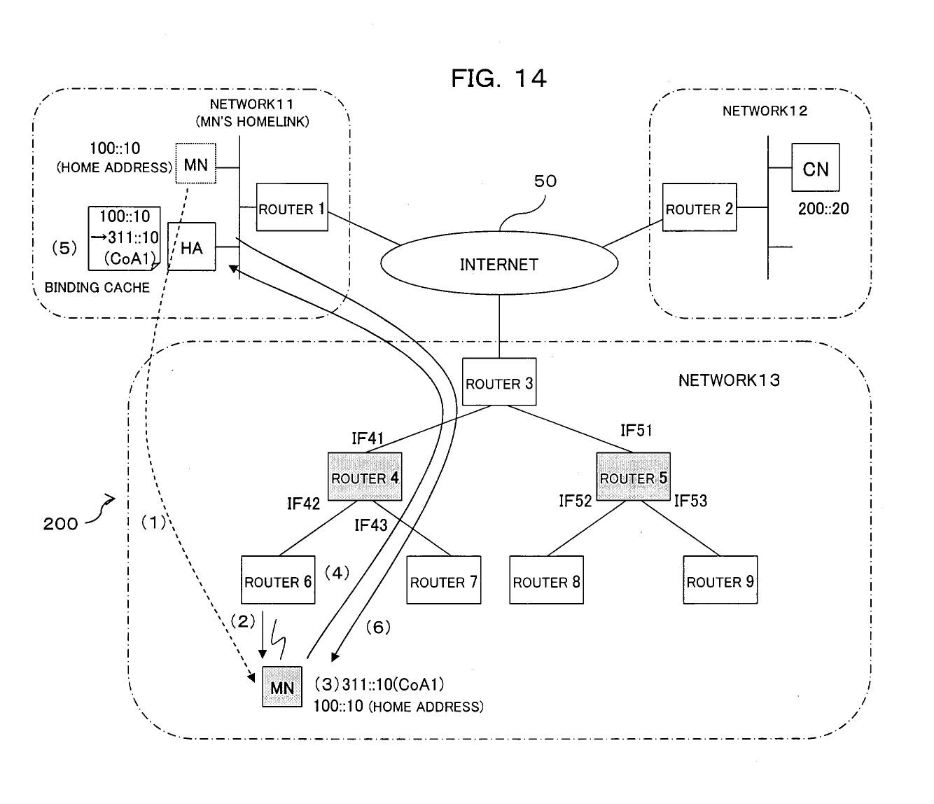

A registration request message is issued in order to change the previous care-of address used prior to a move of the mobile node MN to a new care-of address to be used after the move. When the mobile node MN moves to cause a handover of the wireless communication area of access router 7 from that of access router 6 (see FIG. 1 or 14), the mobile node MN sends a registration request message to one (for example, access router 7) of routers disposed in network 13 so that the previous care-of address used prior to the move of the mobile node MN is changed to a new care-of address to be used after the move. At that time, since the mobile node MN does not have to know the destination router to receive the registration request message, the mobile node MN provisionally sends the registration request message to access router 7, which engages communication with the mobile node MN after the move, without identifying the destination router.

A router located in the uplink direction of access routers 6 to 9 is selected as the destination router. An exemplary destination router is distribution router 4 which connected to both access router 6, which has been supported the mobile node MN before the move of the mobile node MN, and access router 7 which supports the mobile node MN after the move, in the downlink direction.

A distribution router may be arranged at the same position as those of access routers 6 to 9 in network 13.

FIG. 30 is a diagram illustrating an example inwhich access router 6 of the first embodiment serves to function as a distribution router.

Process (1): the mobile node MN moves from the wireless communication area of access router 6 to that of access router 7 and switches an attachment router to access router 7 based on levels of receiving radio signals.

Process (2): the mobile node MN sends one of a plurality routers arranged in network 13 a registration request message to request a packet destined to CoA1 used prior to the move of the mobile node MN to be forwarded to CoA2 used after the move.

Process (3): the registration request message is terminated in access router 6.

Process (4): access router 6 creates a cache to define a setting to forward a packet destined to CoA1 used prior to the move of the mobile node MN to CoA2 used after the move.

In the example of FIG. 30, access router 6 serves to function as a distribution router. A distribution router, likewise access router 6, always has to be connected to another router in the downlink direction. The example of FIG. 30 is also applied to the second embodiment described later. The reference numbers in FIG. 30 identical to those described above refer to identical or substantially identical elements or parts described.

(4-4-3) Cache Table 20d:

Cache table 20d (FIG. 3) is a memory to retain the previous care-of address used prior to the move of the mobile node MN. When the packet identifying section 20b receives a registration request message, registration request message acceptor 20c writes the previous address used before the move of the mobile node MN and the new care-of address of the mobile node MN used after the move, which care-of addresses are included in the registration request message in cache table 20d with the both care-of addresses correlated. Cache table 20d is realized by a RAM (random access memory), for example.

(4-4-4) Registration Request Message Acceptor 20c:

(4-4-4-1) Function for Changing a Care-of Address:

If a packet received in receiving processor 20a includes a registration request message to change the previous care-of address used prior to the move of the mobile node MN to the new address to be used after the move, registration request message acceptor 20c changes the previous care-of address, which is retained in cache table 20d, to the new care-of address. If there is no cache retaining the correlation between the previous and new care-of addresses, cache table 20d creates the cache.

As a result, registration request message acceptor 20c analyzes the registration request message identified by packet identifying section 20b and then a cache to retain data to forward a packet destined for the previous CoA to a node having an address of the new CoA is created in cache table 20d. Additionally, registration request message acceptor 20c creates a registration response message for the mobile node MN, which issued the registration request message, and outputs to the registration response message to sending processor 20g.

The function is realized by, for example, a CPU (central processing unit) and controller, which do not appear in the drawings.

(4-4-4-2) Decision Information to Change an Address:

Registration request message acceptor 20c changes an address responsive to the registration request message based of the following decision information piece (L1) to (L5), and comprises decision information judging section 22 to judge each decision information piece and timer 23 countable a predetermined time length.

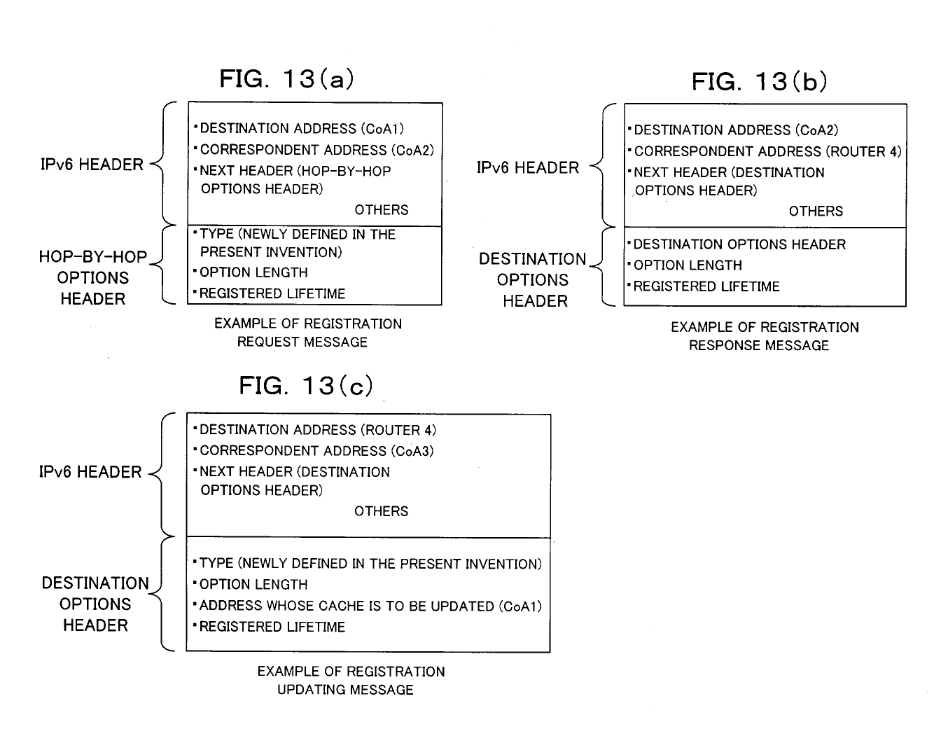

Decision information judging section 22 detects type information included in the header of a packet issued by mobile node MN to perform an example of decision manners. Specifically, decision information judging section 22 reads a “type region” included in the hop-by-hop options header (see FIG. 13(a) described later) or the destination header (see FIGS. 13(b) and 13(c)) of a packet to confirm that the read type corresponding to the registration request message or a deletion request message.

Information piece (L1): Decision information judging section 22 determines whether or not to create a cache on the basis of agreement or disagreement between an outputting interface port corresponding to a care-of address included in a registration request message and any of one or more outputting interface retained in the routing table 20f.

Specifically, when an outputting interface of the destination address of the received registration request message agrees with any one of outputting IFs 41 to 43, which distribution router 4 has previously selected and set among a number of outputting interfaces that distribution router 4 retains, registration request message acceptor 20c creates a cache. On the other hand, if the outputting interface of the destination address does not corresponding to any one of outputting IFs 41 to 43, registration request message acceptor 20c forwards the registration request message to a proper destination in the same manner as a normal packet.

Information piece (L2): Decision information judging section 22 determines whether or not to change an address based on an amount of resources required to register a new address.

Namely, if it is possible to reserve resources required for registration of a new address, registration request message acceptor 20c changes (or sets) the new address; conversely, if it is impossible, registration request message acceptor 20c forwards the received packet to a proper destination likewise a normal packet. The resources required for registration of a new address are exemplified by a memory capacity.

Information piece (L3): When a predetermined time has passed since an address change, registration request message acceptor 20c cancels the change.

Registration request message acceptor 20c continues to observe, using timer 23, whether or not the predetermined time has passed. An example of timer 23 is a timer disposed at the CPU. When a predetermined time has passed since timer 23 started counting, the change of an address is canceled.

Information piece (L4): If registration request message acceptor 20c receives a deletion request message to delete a changed address, the cache is deleted to thereby delete the changed address.

If registration request message acceptor 20c sets an address and then receives a deletion request message issued from the mobile node MN to delete the set message, registration request message acceptor 20c cancels the setting of the address used at that time.

Information piece (L5): If registration request message acceptor 20c receives a deletion request message to delete the changed address, the changed address is deleted while, if registration request message acceptor 20c does not receive such a deletion request message, the change of the address is canceled when the predetermined time has passed since the address change.

Upon registration request message acceptor 20c sets (or changes) an address and then receives adeletion request message issued from the mobile node MN to delete the set (or changed) address, registration request message acceptor 20c immediately cancels the setting (or changing) of the address. On the other hand, if registration request message acceptor 20c does not receive such a deletion request message, registration request message acceptor 20c automatically cancels the setting (or changing) if the address at the time when timer 23 counts the passage of the predetermined time.

Accordingly, the simultaneous use of timer 23 automatically deletes data retained in cache table 20d at intervals of a predetermined time. At the same time, registration request message acceptor 20c keeps observing the data volume of cache table 20d and, if received registration request messages is larger in volume than data automatically deleted (e.g., received registration request messages are in excess of 1,000), registration request message acceptor 20c notifies to the mobile node MN that resources cannot be reserved.

Alternatively, registration request message acceptor 20c may forward a registration request message, without processing, to an ahead distribution router, which creates the cache.

As a result, it is possible to surely reserve resources and to effectively use the resources.

(4-4-5) Encapsulating Section 20e:

Encapsulating section 20e (see FIG. 3) refers to cache table 20d and changes the destination address of a packet output from packet identifying section 20b in order to create a new header and encapsulate the header and data of the packet. Then encapsulating section 20e outputs the encapsulated packet. Namely, encapsulating process is to provide data with a new header.

(4-4-6) Sending Processor 20g:

Sending processor 20g sends a packet issued from a correspondent node CN to a care-of address, which has been changed by change arrangement section and which is to be used after a move of the mobile node MN, on the basis of routing information that correlates an address of a next hop-router to which the packet received in receiving processor 20a is forwarded with a network prefix included in the destination of the received packet and link information which indicates whether the position of the next hop-router is at the uplink or the downlink of the distribution router. Sending processor 20g sends a packet received form encapsulating section 20e with reference to routing table 20f.

(4-4-7) Routing Table 20f:

Routing table 20f is a memory retaining data for correlating the destination of a packet with a router to which the packet is to be output. Routing table 20f retains routing information that correlates an address of a next hop-router to which a packet received in receiving processor 20a is forwarded with a network prefix of the destination included in the received packet and link information which indicates whether the position of the next hop-router is at the uplink or the downlink of distribution router 4.

FIG. 11 illustrates an example of routing table 20f according to the first embodiment. Routing table 20f of FIG. 11 has entries for a destination prefix, a next hop, an outputting interface, and a downlink. The next-hop entry represents a router or a ne section of a data link having a function of a next hop. Specifically, a next hop is an address of a router to which a packet received is to be forwarded. An outputting IF (interface) represents an output port of a packet to hop. In addition to an outputting interface, routing table 20f judges whether (YES) or not (NO) the outputting interface is at downlink of distribution router 4.

Sending processor 20g sends a packet to the care-of address, which has been changed by the change arrangement section (20b, 20c, 20d, 20e) and which is to be used after the move of the mobile node MN, on the basis of the routing information.

Since distribution router 4 therefore acknowledges the care-of address of the mobile node MN, which address is to be used after the move of the mobile node MN, distribution router 4 receives a header of a packet that, for example, the homeagent HA has sent to a care-of address used prior to the move of the mobile node MN and changes the header of the received packet to the care-of address to be used after the move in order to ensure an accurate packet forwarding.

The symbolic convention for routing table 20f of FIG. 11 integrates downlink information with the routing information. The symbolic convention may be formed by an ordinary symbolic convention for a router and another table which is different from the ordinary symbolic convention and which correlates an outputting interface with a downlink. In this case, distribution router 4 retrieves in the routing table when execution of a usual packet routing and, when an outputting interface is determined, and upon determination of the outputting interface, retrieves in the another table retaining downlink information in order to judge whether or not the determined outputting interface is at the downlink on the basis of the determined outputting interface.

Only reception of a registration request message requires reference to a next hop, an outputting interface and downlink information. Reception of an ordinary packet requires reference only to a next hop.

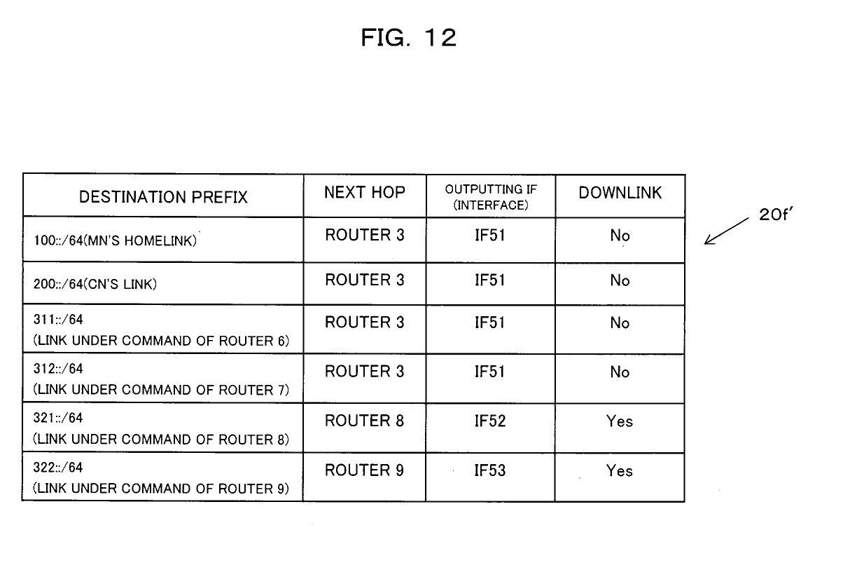

Similar to routing table 20f, routing table 20f′ included in distribution router 5 retains routing table information that an ordinary router includes and additionally retains downlink information for each corresponding outputting interface, as shown in an example of FIG. 12. Interfaces 52 and 53 are at the downlink interface of distribution router 5.

It is therefore possible to dynamically acquire network resources.

(4-4-8) Change Arrangement Section (20b, 20c, 20d, 20e):

If a packet received by receiving processor 20a includes a registration change request to change a care-of address used prior to the move of the mobile node MN to another care-of address to be used after the move, change arrangement section (20b, 20c, 20d, 20e) changes the first-named care-of address, which has been used prior to the move and which is retained in cache table 20d, to the second-named care-of address used after the move. Further, if cache table 20d does not retain the first-named care-of address, change arrangement section (20b, 20c, 20d, 20e) immediately notifies cache table 20d of the contents of the registration change request.

Change arrangement section (20b, 20c, 20d, 20e) is realized by co-operation performed by packet identifying section 20b, registration request message acceptor 20c, cache table 20dand encapsulating section 20e.

(4-5) Manner of Determination of a Distribution Router:

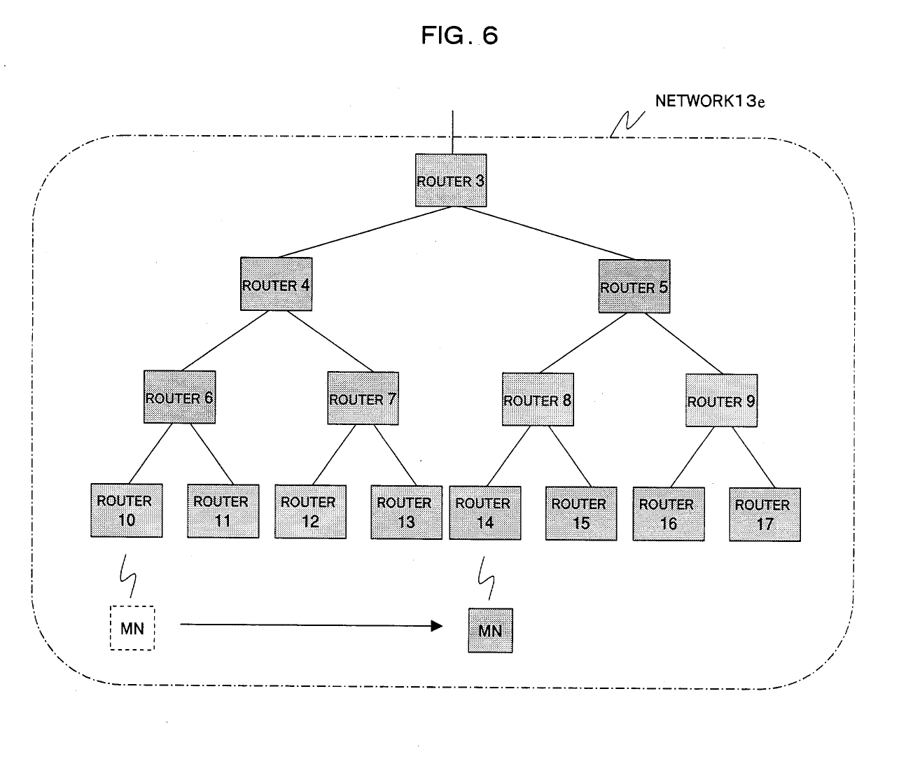

FIG. 6 shows a manner of determining of a distribution router of the first embodiment. Network 13 of FIG. 6 is in three stages formed by from access routers 10-17 to router 3. Dark painted routers in FIG. 6 are serving as distribution routers of the present invention.

The elements and parts having identical reference numbers with those described above are identical or substantially identical elements and parts, so any repetitious description is omitted here. Access routers 6-9 may not serves as access routers.

The mobile node MN is attached to access router 10 prior to a move of the mobile node MN and moves to be attached to access router 14. When the mobile node MN moves to initiate an attachment to access router 14, the mobile node MN issues a registration request message through access router 14 to the uplink side. Access router 14 acknowledges that both addresses of the mobile node MN used prior to and after the move are not under command of access router 14, and then sends the registration request message to uplink access router 8. Access router 8 analyzes the contents of the registration request message, which is included in a packet forwarded, in the same manner as performed by network 13 in order to check whether or not the two address are under command of access router 8. After that, also access router 8 sends the forwarded packet to distribution router 5, which performs the same check on the packet and forwards the packet to router 3. Upon receipt of the forwarded packet, router 3 acknowledges that access routers 10 and 14, respectively attached to the mobile node MN prior to and after the move, are under command of router 3, which acknowledges that router 3 itself is the distribution router.

(4-6) Arrangement of Distribution Router:

One or more distribution routers functioning to distribute packets are disposed at uplink of the access routers 6-9. Specifically, in FIG. 1, distribution router 4 is disposed at between access routers 6 and 7; and distribution 5, between access routers 8 and 9. Further, distribution routers 4 and 5 locate between access routers 6 and 8, and also between access routers 6 and 9. Distribution routers 4 and 5 are disposed at the uplink side of access routers 6-9, and a path connects arbitrary two of access router 6-9 always includes one of distributions 4 and 5 or both of distribution routers 4 and 5.

Namely, mobile communication system 200 may include at least one of distribution routers 4 and 5 at a node (in the form of a router, a PC or a work station, for example) disposed on a packet forwarding router (path) extending from an address used prior to a move of the mobile node MN to another address to be used after the move. Such arrangement of a distribution router can reduce the cost for mobile communication system 200.

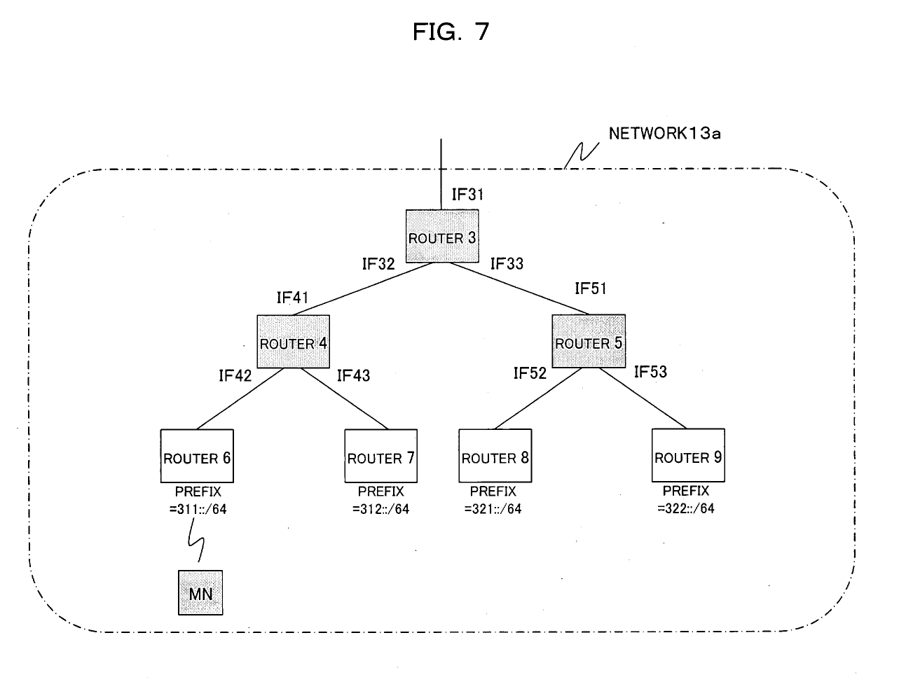

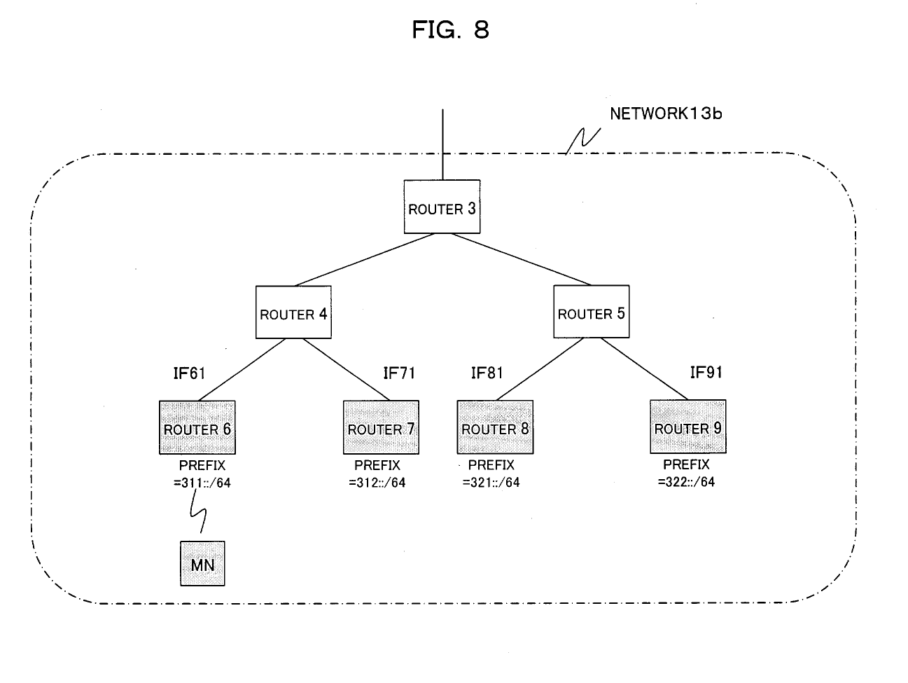

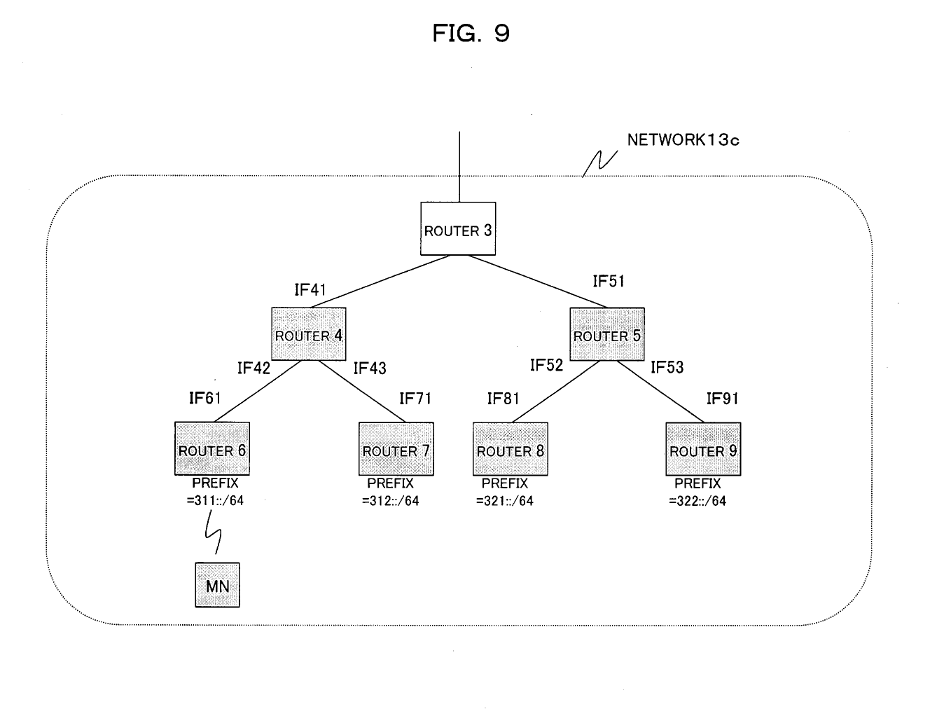

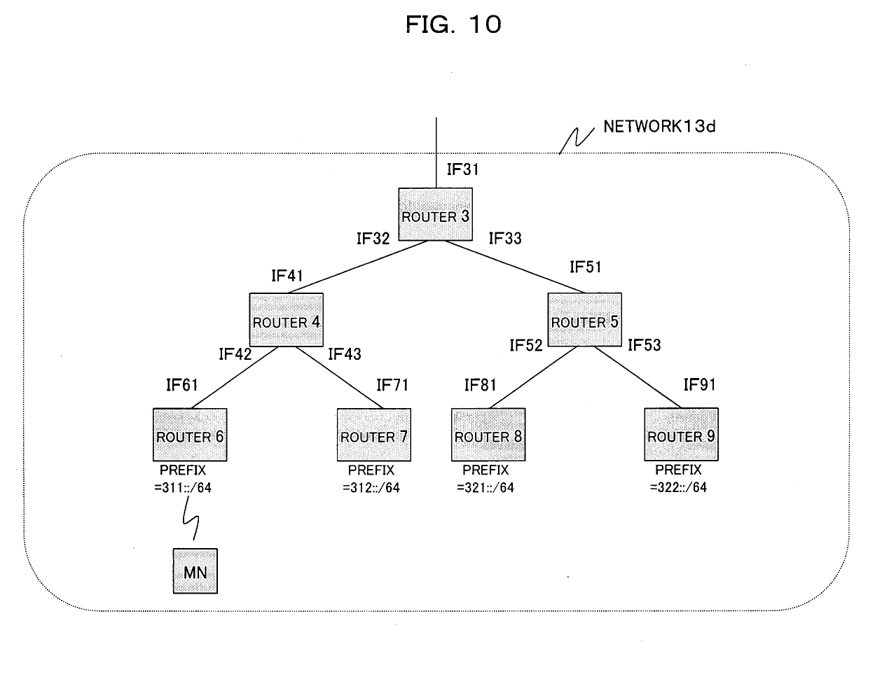

FIG. 7 to 10 respectively show arrangements of routers according to the first embodiment. In these drawings, the elements and parts having identical reference numbers with those described above are identical or substantially identical elements and parts. Arrangement of distribution routers (painted dark) is classified into four patterns. Routers 3-5 serve as distribution routers in network 13a (FIG. 7); access routers 6-9, in network 13b (FIG. 8); routers 4-9, in network 13c (FIG. 9); and all routers 3-9, in network 13d (FIG. 10).

Outputting IFs (interfaces) 61, 71, 81 and 91 in each drawing are interface ports for paths through which packets are input and output and observe packets to be input or output.

Routers in mobile communication system 200 (FIG. 1) arranged in a tree topology, but should by no means be limited to a tree topology. Alternatively, mobile communication system 200 may include a plurality of gateways to be communicably connected to Internet 50.

(4-7) A Format of a Message Sent or Received:

FIG. 13(a) shows an example of a registration request message of the first embodiment. The header of a registration request message shown in FIG. 13(a) is formed by an IPv6 header and a hop-by-hop options header. Here, an IPv6 header is a basic partition common to all packets, and a hop-by-hop options header is a partition into which data to be used for processes performed by the all routers on a forwarding path of a packet is written. Further, a hop-by-hop options header includes a type value to acknowledge that the hop-by-hop options header is a registration request message, and a lifetime of a created cache. An IPv6 destination address in a hop-by-hop options header represents CoA1 used prior to the move of the mobile node MN and a correspondent address (the address of the correspondent node CN) represents CoA2 to be used after the move.

FIG. 13(b) shows the format of a registration response message of the first embodiment. A registration response message of FIG. 13(b) includes an IPv6 header and a destination options header that indicates a process to be performed by a destination host. Here, an IPv6 destination address represents CoA2 and the correspondent address represents distribution router 4. The contents of the destination options header include a type value to acknowledge that the destination options header is a registration response message and a lifetime of a created cache.

FIG. 13(c) shows an example of a registration updating message of the first embodiment. The header of an registration updating message of FIG. 13(c) includes an IPv6 header and a destination options header that indicates a process to be performed by a destination host. Here, distribution router 4 and CoA3 are respectively written as an IPv6 destination address and the correspondent address. The contents of a destination options header include a type value to acknowledge that the destination options is a registration updating message, address CoA1 to a cache to be updated and a lifetime of the created cache.

(4-8) Process Performed in Distribution Routers 4 and 5:

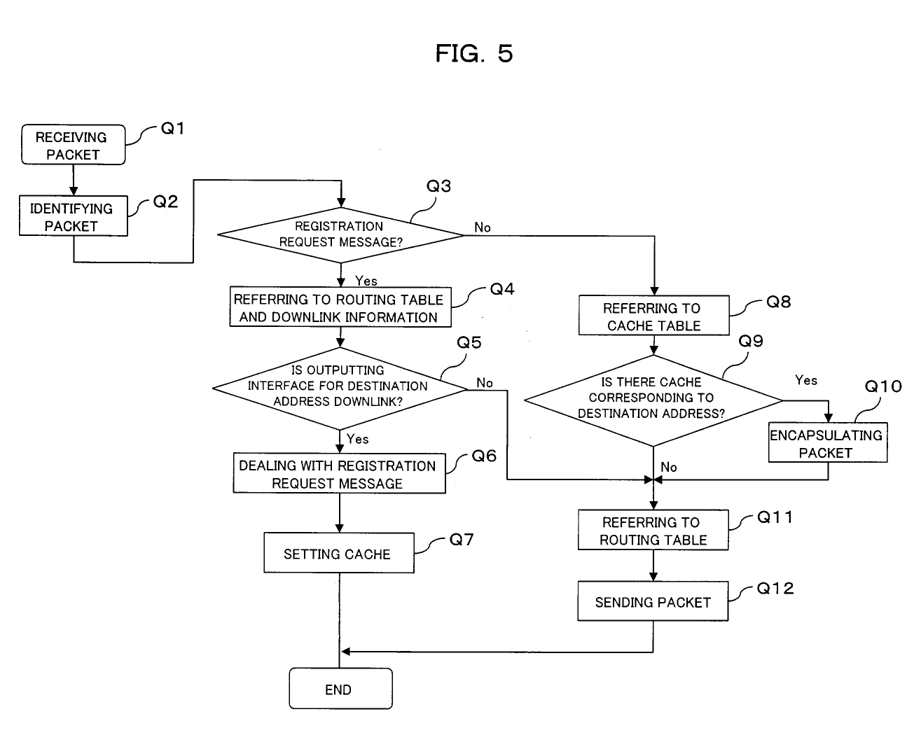

FIG. 5 is a flow diagram illustrating a succession of procedural steps performed by distribution router 4 of the first embodiment. Distribution router 5 performs substantially identical procedural steps with distribution router 4, so any repetitious description is omitted here. Further, distribution router 5 and another router 3 having a function for distribution also perform the procedural steps substantially identical to those in FIG. 5.

Upon receipt of a packet (step Q1), distribution router 4 identifies the packet (step Q2) and judges whether or not the packet is a registration request message (step Q3). If the packet is a registration request message, the procedural steps take the Yes route so that a main controller (not shown) refers to the routing table and the downlink information retained in cache table 20d (step Q4) and checks whether or not the outputting interface (outputting IF) corresponding to the destination address of the message is at the downlink of distribution router 4 (Step Q5). If the corresponding outputting IF is at the downlink, the procedural steps take the Yes route so that distribution router 4 carries out processes to deal with the registration request message (step Q6) and an address is set into cache table 20d (step Q7).

At step Q3, if the received packet is judged not to be a registration request message, the procedural steps take the No route so that the main controller refers to cache table 20d (step Q8) to check whether or not cache table 20d retains data corresponding to the destination address of the received packet (step Q9). If cache table 20d retains the corresponding data, the received packet is encapsulated (step Q10). After that, distribution router 4 refers to the routing table (step Q11) and sends the packet to the destination address (step Q12).

On the other hand, the corresponding outputting interface is judged not to be at the downlink in step Q5, the procedural steps take the No route to perform step Q11 and the subsequent step. If the result of step Q9 is negative, the procedural steps take the No route to perform step Q11.

In the above manner, a registration request message received by any one of access routers 6-9 is read by each of routers and one from the routers, which one commands two routers that are attached to the mobile node MN prior to and after the move of the mobile node MN, acknowledges to function as a distribution router whereupon updates cache table 20d therein on the basis of information in the registration request message.

Accordingly, distribution router 4 sets (or changes) binding information for the mobile node MN, so that a function for retaining binding information, which function is usually set at the homeagent HA, is set at distribution router 4, which distributes a packet.

As a result, when the mobile node MN moves to wireless communication area of access router 6 to that of access router 7 in mobile communication system 200 of FIG. 1, access router 7 causes a registration request message to hop from the mobile node MN to distribution router 4, which is located at the uplink of access router in Internet 50 (in other words, access router 7 forwards a registration request message to distribution router 4). Distribution router 4 that is the hop destination of the registration request message checks whether or not both access routers 6 and 7, which are in communication with the mobile node MN prior to and after the move of the mobile node MN, respectively, are under command of distribution router 4. If the result of the check is positive, distribution router 4 change previous care-of addresses CoA1 used for communication prior to the move to a new care-of address used after the move. Further, seen from the entire mobile communication system 200, dynamically setting of a care-of address is realized by sending a registration request message from the mobile node MN and dealing with the sent registration request message by the router disposed in mobile communication system 200.

At the time a handover of a wireless communication area of the mobile node MN occurs, a router in mobile communication system 200 dynamically change a setting to forward a packet destined for a CoA used prior to the handover of the mobile node MN to another CoA used after the move.

Distribution router 4 therefore does not have to set (or update) a binding cache or perform encapsulation in relation to all registration messages sent from the all mobile nodes MN. In other words, distribution router 4 requires to perform updating a binding cache and encapsulation only on a mobile node MN that caused a handover of a wireless communication area at a particular area. Additionally, distribution router 4 acquires a resource only for a mobile node MN that caused a handover whereupon a multistage agent and a binding cache required in conventional technique are no longer required. Distribution router 4 does not reject access of a mobile node MN because of resource shortage.

It is possible to increase the number of mobile nodes MNs that distribution router 4 can support. More mobile nodes MNs can receive service at a wireless communication area at visited networks as a result of a handover so that the quality of the communication service is improved.

Further, mobile communication system 200 can therefore supports communication of a mobile node MN on the high-speed move and reduce packet losses so that the management and maintenance costs can also be reduced.

Mobile communication system of FIG. 1 includes a mobile node MN, network 11 having the homeagent HA, and network 13 having a plurality of access router 6-9. In mobile communication system 200, one or more routers, exemplified by distribution routers 4 and 5, are disposed at the uplink of access routers 6-9 in order to forward a packet to an appropriate destination.

In the illustrated example, router 4 and 5 require cache table 20d and change arrangement section (20b, 20c, 20d, 20e) to loop back and distribute a packet while access routers 6-9 do not have to include cache table 20d or change arrangement section (20b, 20c, 20d, 20e).

As mentioned above, each of distribution routers 4 and 5 comprises cache table 20d, receiving processor 20a, change arrangement section (20b, 20c, 20d, 20e) and sending processor 20g. A mobile node MN comprises router identifier retaining section 42b, receiving processor 40a, movement detector 42a and sending processor 40h.

Further, change arrangement section (20b, 20c, 20d, 20e) of a router sends a mobile node MN a confirmation response responsive to a registration request issued by the mobile node MN.

(5) Description of an Operation Performed in Mobile Communication System 200:

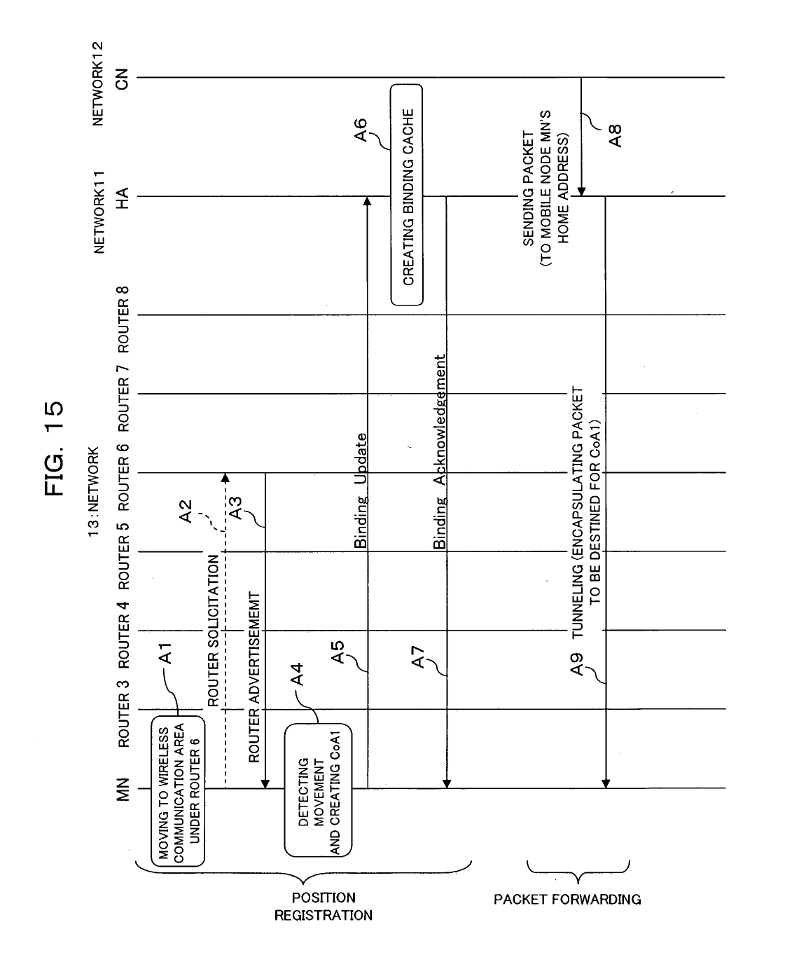

Hereinafter, a mobile communication method performed in mobile communication system 200 will be now described. First of all, a handover from a wireless communication area of access router 6 to that of access router 7 is described with reference to FIGS. 14 and 15.

FIG. 14 illustrates procedural steps of a position registration (a location registration or a registration) of the first embodiment, which steps are performed when a mobile node MN moves to the wireless communication area of access router 6 in mobile communication system 200. The procedural steps of a position registration of FIG. 14 is identical to those performed at the homeagent HA through an ordinary mobile IPv6 described above with reference to FIG. 1.

In FIG. 14, elements and parts having identical reference numbers with those described above are identical or substantially identical elements and parts, so any repetitious description is omitted here. The positions of a mobile node MN prior to and after a move in this description are examples, and the mobile node MN may of course move to wireless communication area of a router other than that described here.

Process (1): a mobile node MN visits network 13 from network 11 (see the dotted line in the drawing) to move to the wireless communication area of access router 6.

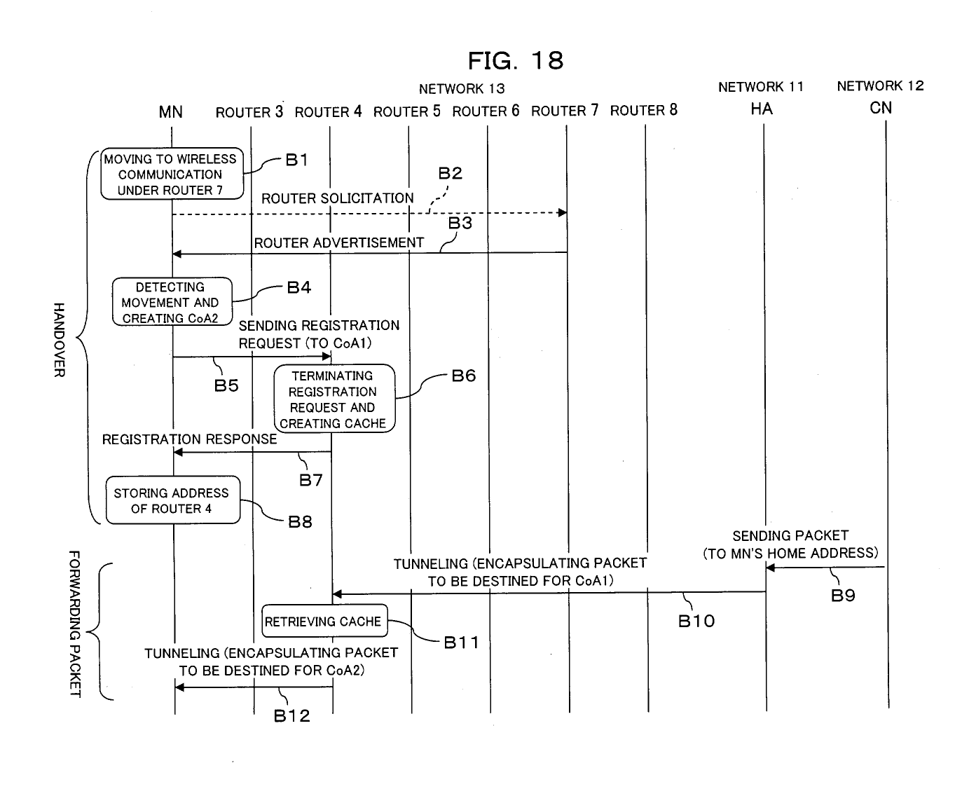

Process (2): the mobile node MN receives a router advertisement message which access router 6 issues periodically or responsive to a request from the mobile node MN (the last-named request corresponds to a router solicitation of FIGS. 15 and 18). The router advertisement message includes a network prefix (for example, “311::/64”) corresponding to the current connection link of the mobile node MN. The router advertisement message does not include the address (for example, MAP1 of FIG. 31) of distribution router 4. That is different from hierarchical mobile IPv6.

A connection link represents a physical link while a network prefix represents a logical link. Therefore, a plurality of network prefixes can be allocated to the same one frequency channel, for example.

Process (3): the mobile node MN creates CoA1 (for example, “311::10”) on the basis the network prefix of the connection link included in the received router advertisement message.

Process (4): the mobile node MN sends a position registration message BU to the homeagent HA to register CoA1 created by the mobile node MN and the home address in the homeagent HA.

Process (5): upon receipt of the position registration message BU issued in the previous step (4), the homeagent HA creates a binding cache based on the contents of the position registration message BU. The created binding cache retains a correlation between the home address and CoA1.

Process (6): the homeagent HA sends the mobile node MN a registration response message BA to notify the mobile node MN of reception of the registration.

After completion of process (6), a packet that the correspondent node CN has issued to the home address of the mobile node MN is intercepted by the homeagent HA, is encapsulated so as to be destined to CoA1 of the mobile node MN and forwarded to CoA1 (the processes are not shown).

As comparing with hierarchical mobile IPv6, in mobile IPv6, distribution router 4 does not perform another encapsulation on the encapsulated packet. Namely, distribution router 4 does not write a binding cache into MAP1 while however writes through the hierarchical mobile IPv6 described with reference to FIG. 31.

FIG. 15 illustrates procedural steps of a position registration performed and subsequent packet forwarding performed prior to a handover of a wireless communication area of the first embodiment. Here, position registration is performed on the mobile node MN locating in the wireless communication area under access router 6, and a packet issued form the correspondent node CN is forwarded to the mobile node MN. In FIG. 15, elements and parts having identical reference numbers with those described above are identical or substantially identical elements and parts, so any repetitious description is omitted here.

First of all, the mobile node MN moves to the wireless communication area under access router 6 (step A1) and sends access router 6 a router solicitation (step A2). Upon receipt of the router solicitation, access router 6 sends the mobile node MN a router advertisement message (step A3). Upon receipt of the router advertisement message, the mobile node MN detects a move of the mobile node MN itself to another wireless communication area and creates CoA1 (step A4). After that, the mobile node MN sends the homeagent HA in network 11 a message BU to request updating of a binding cache (step A5). Receipt of the message causes the homeagent HA to create the binding cache (step A6) and send a confirmation response (a Binding Acknowledgement) to the mobile node MN (step A7). With these steps, it is possible to register the current position of a mobile node MN even after a movement of the mobile node MN.

In succession, the correspondent node CN in network 12 issues a packet to the mobile node MN (step A8). The homeagent HA receives (intercepts) and relays the packet in order to send the packet to the mobile node MN (step A9). It is therefore possible to ensure also packet forwarding.

Further, position registration and packet forwarding can be certainly carried out even when one or more mobile nodes in the communication area of each router are changed.

FIG. 16 illustrates procedural steps of a handover of a wireless communication area performed after the position registration of FIG. 14 of the first embodiment.

Process (1): the mobile node MN moves to the wireless communication area of access router 7 from that of access router 6 in the visited network 13 (see the dotted line). When the mobile node MN detects that the level of a radio signal received from access router 7 becomes higher than that from access router 6, the mobile node MN switches the point of attachment from access router 6 to access router 7.

Process (2): the mobile node MN receives a router advertisement message which access router 7 issues periodically or responsive to a request from the mobile node MN. The router advertisement message includes a network prefix (for example, “312::/64”) corresponding to the current connection link of the mobile node MN. Here, dissimilar from hierarchical mobile IPv6, the router advertisement message does not include the address (MAP1 in FIG. 31) of distribution router 4. The reception of the router advertisement message causes the mobile node MN to detect a change in network prefix.

The mobile node MN requests that data that a user of another mobile node MN has issued to the mobile node MN is destined for access router 7, not access router 6. For this reason, when the mobile node MN is on the move from the wireless communication area of access router 6 to that of access router 7, the mobile node MN requests that destination of such data is changed to access router 7 to be used after the move from access router 6 used prior to the move.

The mobile node MN holds an old address CoAw (w is a natural number equal to or larger than 1) that the mobile node MN has used while the mobile node MN is in the wireless communication area under access router 6 prior to the move. The mobile node MN has to hold only one CoA used for communication in wireless communication area at which the mobile node MN established the current communication. Once the mobile node MN finishes communication, the mobile node MN has only to retain new CoA for a wireless communication area at which the mobile node MN is present at the end time of the communication.

In the example of FIG. 16, if the mobile node MN has no information on distribution router 4 or the like, the mobile node MN may send such a request to a previous router whose address has been retained in the mobile node MN or to a default router.

Process (3): the mobile node MN creates CoA2 (for example, “312::10”) on the basis the network prefix of the connection link included in the received router advertisement message. At this time, the mobile node MN does not delete CoA1 that has been used during communication in the wireless communication area under access router 6 prior to the move.

Process (4): the mobile node MN sends one or more from the plural routers communicably connected to Internet 50 a registration change request to request network 13 to forward a packet destined for CoA1 used prior to the move to CoA2 to be used for after the move.

In other words, the mobile node MN sends a registration request message to register another care-of address used at the destination of the move of the mobile node MN on the basis of the change of the network prefix to the second access router 7 that is different from access router 6.

For example, the header of a registration request message is formed by an IPv6 header and a hop-by-hop options header, as shown in FIG. 13(a). Here, an IPv6 header is a basic partition common to all packets, and a hop-by-hop options header is a partition into which data to be used for processes performed by the entire routers on packet forwarding path. Specifically, a hop-by-hop options header includes a type value to acknowledge that the hop-by-hop options header is a registration request message of the present invention and a lifetime of a cache to be created. An IPv6 destination address in a hop-by-hop options header represents CoA1 used prior to the move of the mobile node MN and a correspondent address represents CoA2 to be used after the move.

After that, the mobile node MN sends a router belongs to network 13 data including a request to retain information corresponding to the binding cache retained in the homeagent HA. The router (distribution router 4 in FIG. 14) to which the data is sent is determined on the basis of position relationship between access router 7 and access router 6 that are in communication with the mobile node MN after and prior to the move, respectively, and is one of routers that have received the registration request message. In order to determined the one router, each of the above routers received the message checks whether or not the router itself agrees with one or more predetermined rules to correspond to the one router. If a router agrees with the predetermined rules, the router acknowledges that the router itself is the one. The determined router is therefore not a definitive router that is communicably connected to Internet 50.

If a packet is destined for the downlink of a router, in other words, if the router makes checks a packet received and the result of the check finds the destination of the received packet to be looped back to the downlink of the router, the router acknowledges to be the one that should create a cache. Namely, if a received packet has to be forwarded to the downlink of a router, the router that loops back the packet recognize to be a router having a function for looping back a packet and then creates a cache.

Here, distribution router 4 which is communicably connected to access router 6 and second access router 7 in the downlink direction thereof creates a cache retaining a correspondence between a care-of address used prior to the move of the mobile node MN and another care-of address, which is to be used after the move and which is included in the registration request message.

Process (5): Since the registration request message is destined for CoA1, the message is routed to one or more routers (the mobile node MN) disposed at the downlink of access router 6. The following processes are performed when the registration request message passes through distribution router 4 on the way to the routing.

Process (5-1): distribution router 4 analyzes the hop-by-hop options header of the registration request message.

Process (5-2): on the basis of the type value retained in the hop-by-hop options header, distribution router 4 detects that the packet is a registration request message of the present invention.

Process (5-3): distribution router 4 confirms CoA1 that is the destination address of the registration request message and retrieves in the routing table (see FIG. 11 or 12).

Process (5-4): as the result of the retrieval, distribution router 4 acknowledges that CoA1 is “311::10” and a destination prefix “311::/64” is hit as an entry matching to the CoA1.

Process (5-5): distribution router 4 determines interface 42 through which the registration request message is to be output. But, since the corresponding downlink information is “Yes” so that the next output is carried out to the downlink side, distribution router 4 intercepts the registration request message without forwarding the message to the destination and starts a cache creating operation.

On the other hand, if the next output of the registration request message is not carried out to the downlink side, distribution router 4 does not intercept the registration request message and forwards the registration request message to the destination by performing a normal routing operation.

Process (5-6): distribution router 4 acknowledges that the destination of the registration request message issued by the mobile node MN is located at the downlink of distribution router 4.

Referring to FIG. 16, on the basis of the correspondent address CoA2 and the destination address CoA1 indicated in the IPv6 header in the intercepted registration request message, distribution router 4 creates a cache in which data (for example, “312::10” (CoA2)) represents access router 7 whose wireless communication area holds the mobile node MN is written. After that, when distribution router 4 receives data destined for the mobile node MN from Internet 50, distribution router 4 forwards the data to access router 7, not to access router 6.

The lifetime of the cache is determined with reference to the lifetime registered in the hop-by-hop options header. Alternatively, the policy of distribution router 4 may prolong or shorten the lifetime of the cache.

Process (7): distribution router 4 sends a registration response message to the mobile node MN to notify the mobile node MN of the reception of the registration request message.

Process: as shown in FIG. 16, the mobile node MN receives the registration response message, thereby confirms that distribution router 4 has created the cache and then extracts and retains the address of distribution router 4 from the correspondent address of the received message.

Process: distribution router 4, in place of the mobile node MN, receives a packet which is issued from the correspondent node CN and which is destined for the care-of address used prior to the move and forwards the received packet to the care-of address used after the move, as shown in FIG. 16.

As a result, data issued to the mobile node MN by a correspondent is sent to distribution router 4 via the homeagent HA in network 11, and distribution router 4 holds the issued data without sending the data to access router 6 and then forwards the issued data to access router 7.

In mobile communication system 200, even if the mobile node MN does not acquire a resource for a handover in advance, a cache is dynamically created at the time a handover occurs.

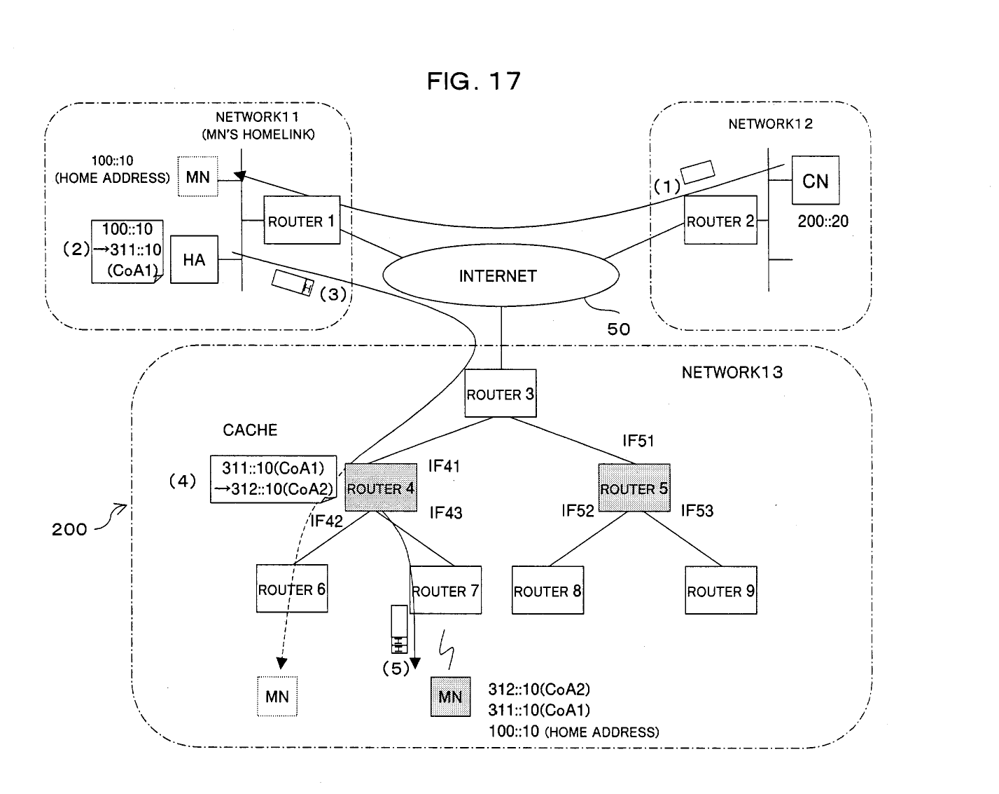

When a mobile node MN causes a handover to the wireless communication area of access router 7 and distribution router 4 create a cache, procedural steps shown in FIG. 17 are performed in order to forward a packet to access router 7 through Internet 50.

FIG. 17 illustrates procedural steps of packet forwarding after a handover of a wireless communication area of the first embodiment. In this example, the mobile node MN causes a handover to the wireless communication area of access router 7. The elements and parts, in FIG. 17, having identical reference numbers with those described above represent identical or substantially identical elements and parts.

Process (1): the correspondent node CN (having address of “200::20”, for example) in network 12 issues a packet destined for the mobile node MN to the home address (for example, “100::10”, of the mobile node MN.

Process (2): the homeagent HA in network 11, in place of the mobile node MN, intercepts the packet destined for the mobile node MN and encapsulates the intercepted packet by providing the packet with a header to change the destination address of the packet to CoA1 on the basis of information retained in the binding cache.

Process (3): the homeagent HA forwards the encapsulated packet to the CoA.

Process (4): since distribution router 4 retains the cache of CoA1 that is the destination of the encapsulated packet which has been forwarded in the previous process (3), distribution router 4 performs another encapsulation on the packet by adding a header to change the destination address of the packet into CoA2 on the basis of the information in the retained cache.

Process (5): distribution router 4 forwards the packet encapsulated in the previous process (4) to CoA2. The encapsulated packet is received by the mobile node MN through access router 7. The mobile node MN removes encapsulation headers respectively added by the homeagent HA and distribution router 4 from the received packet in order to receive the original packet that has been issued by the correspondent node CN in the initial process (1).

FIG. 18 illustrates procedural steps of a handover of a wireless communication area and of forwarding a packet performed after a change of access router of the first embodiment. In this example, the mobile node MN causes a handover of a wireless communication area from access router 6 to access router 7 so that a packet destined for the mobile node MN is forwarded to the wireless communication area under access router 7. Networks, routers and terminals, in FIG. 18, having identical reference numbers with those described above refer to identical or substantially identical elements and parts, so any repetitious description will be omitted here.

First of all, the mobile node MN moves to the wireless communication area of access router 7 (step B1) and sends access router 7 a router solicitation (step B2). Upon receipt of the router solicitation, access router 7 sends a router advertisement message (represented by “router advertisement” in the drawing) (step B3). Upon receipt of the router advertisement message, the mobile node MN detects a movement of the mobile node MN itself to another wireless communication area and creates CoA2 (step B4). After that, the mobile node MN sends distribution router 4 a registration request message to change CoA1 to CoA2 (step B5). Receipt of the message causes distribution router 4 to terminate the registration request message and create a cache (step B6). Distribution router 4 then sends a confirmation response to the mobile node MN (step B7). The mobile node MN, which has received the confirmation response, stores the address of distribution router 4 therein (step B8).

With these processes, it is possible for each router to grasp the current position of the mobile node MN even after the mobile node MN causes a handover of a wireless communication area fro access router 6 to access router 7 so that each router in mobile communication system 200 ensures wireless communication of the mobile node MN. In other words, only distribution router 4 requires to trace the position of the mobile node MN while the other routers executes normal packet forwarding.

In this state, when the correspondent node CN in network 12 issues a packet to the mobile node MN (step B9), the homeagent HA receives and encapsulates the packet and then sends the packet to CoA1 in step B10. The process performed in step B10 is called a tunneling, during which an IPv6 packet is encapsulated using an IPv4 or IPv6 packet with the result that the encapsulated packet can be sent to the destination through a possible network that supports only IPv4 on the forwarding path.

Distribution router 4 retrieves a cache corresponding to the encapsulated data (step B11), and further tunnels the encapsulated data destined for CoA2 and sends the data to the mobile node MN (step B12).

As described above, after the mobile node MN causes a handover, a packet issued from the correspondent node CN is through the homeagent HA and a cache corresponding to the destination of the issued packet is retrieved by distribution router 4 that has a looping-back function. Finally, the issued packet is surely sent to the mobile node MN. Accordingly, it is possible to certainly deal with a handover and packet forwarding at the same time.

(6) Modification of First Embodiment:

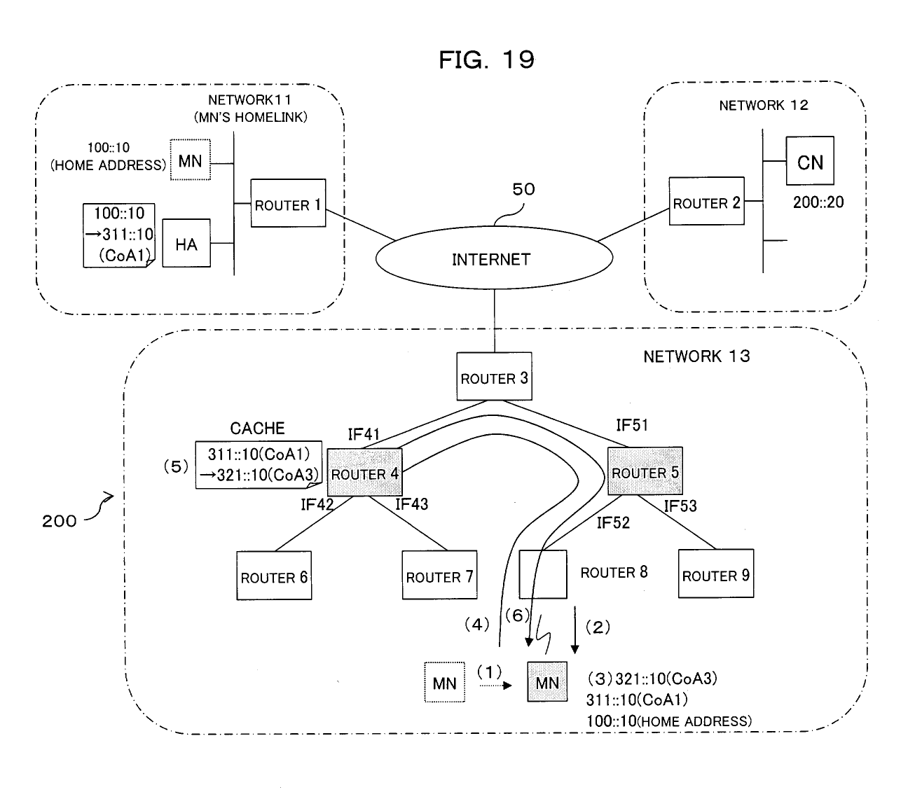

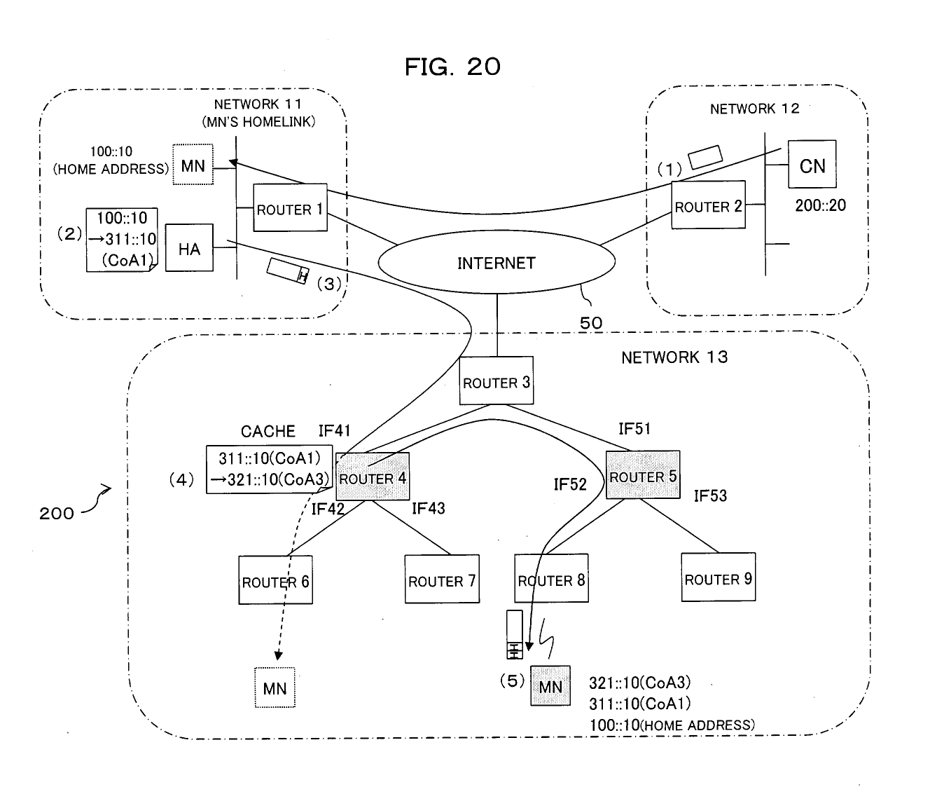

In succession to the move of the mobile node MN exemplified by those of FIGS. 17 and 18, the procedural steps performed when the mobile node MN causes another handover will now be described with reference to FIGS. 19 and 20, in which elements and parts having identical reference numbers with those described above are identical or substantially identical elements and parts. Hereinafter, description will be made on an embodiment in which cooperation of distribution routers 4 and 5 enable packet distribution”.

FIG. 19 illustrates procedural steps of another handover to the wireless communication area under access router 8 after the first handover described with reference to FIG. 17 of the first embodiment.

Process (1): the mobile node MN moves to the wireless communication area of access router 8 from that of access router 7 in the visited network 13 (see the dotted line). When the mobile node MN detects that the level of a radio signal received from access router 8 becomes higher than that from access router 7, the mobile node MN switches the point of attachment from access router 7 to access router 8.

Process (2): the mobile node MN receives a router advertisement message which access router 8 issues periodically or responsive to a request from the mobile node MN. The router advertisement message includes a network prefix (for example, “321::/64”) corresponding to the current connection link of the mobile node MN. Dissimilar from hierarchical mobile IPv6, the router advertisement message does not include the address (for example, MAP2 of FIG. 31) of distribution router 5.

Process (3): the mobile node MN creates CoA3 (for example, “321::10”) on the basis the network prefix of the connection link included in the received router advertisement message. At that time, the mobile node MN does not delete CoA1 that has been used for the communication at the wireless communication area under access router 6 when the mobile node MN has moved to network 13 from network 11.

The mobile node MN may delete the CoA2, which has been used after the first handover in network 13 to the wireless communication area under access router 7 and which is therefore no longer required.

Process (4): using the address of distribution router 4 which address has been stored in the mobile node MN when receipt of the registration response message in Process (7) in FIG. 16, the mobile node MN sends distribution router 4 a registration updating message to request that the contents of cache retained in distribution router 4 to be updated.

After that, if distribution router 4 registers another address (address CoA3) therein responsive to the registration updating message, distribution router 4 sends the mobile node MN a registration response message in order to reply to the registration updating message. As a result, “router (distribution router) 4” is stored or set for the destination address of an IPv6 header shown in FIG. 13(c).

Process (5): distribution router 4 updates the cache based on the contents of the received registration updating message in the following manner.

Process (5-1): distribution router 4 acknowledges that the received message is a registration updating message based on the type value written in the destination options header.

Process (5-2): with reference to a cache updating address in the destination options header, distribution router 4 acknowledges that a cache to be updated is that for CoA1 and retrieves the presence or absence of the cache for CoA1 therein.

Process (5-3): as the result of the retrieval, if distribution router 4 retains the cache for CoA1, distribution router 4 extracts the correspondent address (CoA3) of the IPv6 header from the received registration updating message and sets the extracted correspondent address as a new destination for the retrieved cache.

Process (5-4): distribution router 4 determines lifetime of the updated cache based on the lifetime registered in the destination options header.

Process (6): distribution router 4 sends the registration response message to the mobile node MN to notify the mobile node MN of reception of registration updating. Upon receipt of the registration response message, the mobile node MN acknowledges that the cache has been updated and stores the determined lifetime of the updated cache.

Accordingly, in the method for mobile communication of the present invention, the mobile node MN creates a care-of address (a third temporary address) used for communication in the wireless communication area of access router 8 or 9, which is different from access routers 6 and 7 on the basis of the network prefix to which access routers 8 and 9 belong. After that, the mobile node MN sends distribution router 4 a registration updating request message including CoA1 and access router 8 or 9.

Upon receipt of the registration updating request message, distribution router 4 retrieves a cache in relation to CoA1 included in the registration updating request message. If distribution router 4 has created the corresponding cache, distribution router 4 extracts the care-of address for communication in wireless communication area of access router 8 or 9 from the registration updating message, and updates the cache by correlating the extracted care-of address with CoA1. Consequently, distribution router 4 receives a packet destined for CoA1 in place of the mobile node MN and forwards the packet to the care-of address for access routers 8 or 9.

A cache retained in distribution router 4 is updated in the above manner so that data sent from Internet 50 side can be sent to distribution router 4 even after the mobile node MN has moved to change a wireless communication area. Further, distribution router 4 updates the cache by itself whereby such data is looped back at distribution router 4 to forward the data to the new CoA (for example. CoA3).

Still further, after updating the cache, procedural steps of forwarding a packet that the correspondent node CN in network 12 has issued to the mobile node MN will be now described with reference to FIG. 20.

FIG. 20 is a diagram illustrating procedural step of forwarding a packet after the mobile node MN causes a handover to the wireless communication area of access router 8.

Process (1): the correspondent node CN (having an address 200::20, for example) sends a packet destined for the mobile node MN to the home address (100::10, for example) of the mobile node MN.

Process (2): the homeagent HA in the home network 11 of the mobile node MN intercepts the packet destined for the mobile node MN on behalf of the mobile node MN. On the basis of the information on the binding cache, the homeagent HA encapsulates the intercepted packet by adding a header to change the destination address to CoA1 to the packet.

Process (3): the homeagent HA forwards to the packet encapsulated in the previous process (2) to CoA1.

Process (4): the presence of a cache of CoA1 that is the destination of the encapsulated packet forwarded in the previous process (3) causes distribution router 4 to add a header for changing the destination address to CoA3 to the packet based on the information of the cache in order to further encapsulate the packet.

Process (5): distribution router 4 forwards the packet encapsulated in the previous process (4) to CoA3. The encapsulated packet is received by the mobile node MN via router 3, distribution router 5 and access router 8. Upon receipt, the mobile node MN removes the headers respectively provided by the homeagent HA and distribution router 4, so that the mobile node MN can receive the original packet that the correspondent node CN has issued.

As described above, even if individual routers and the mobile node MN does not realize the construction of network 13, a binding cache is dynamically created so that each router can follow each movement of the mobile node MN.

Further, network resources are acquired only for a mobile terminal that has made a move to change a point of attachment so that the mobile node MN can cause a dynamic handover. It is therefore possible to effectively use network resources, resulting in data communication with reduced packet losses, whereupon the present invention supports the realization of mobile communication.

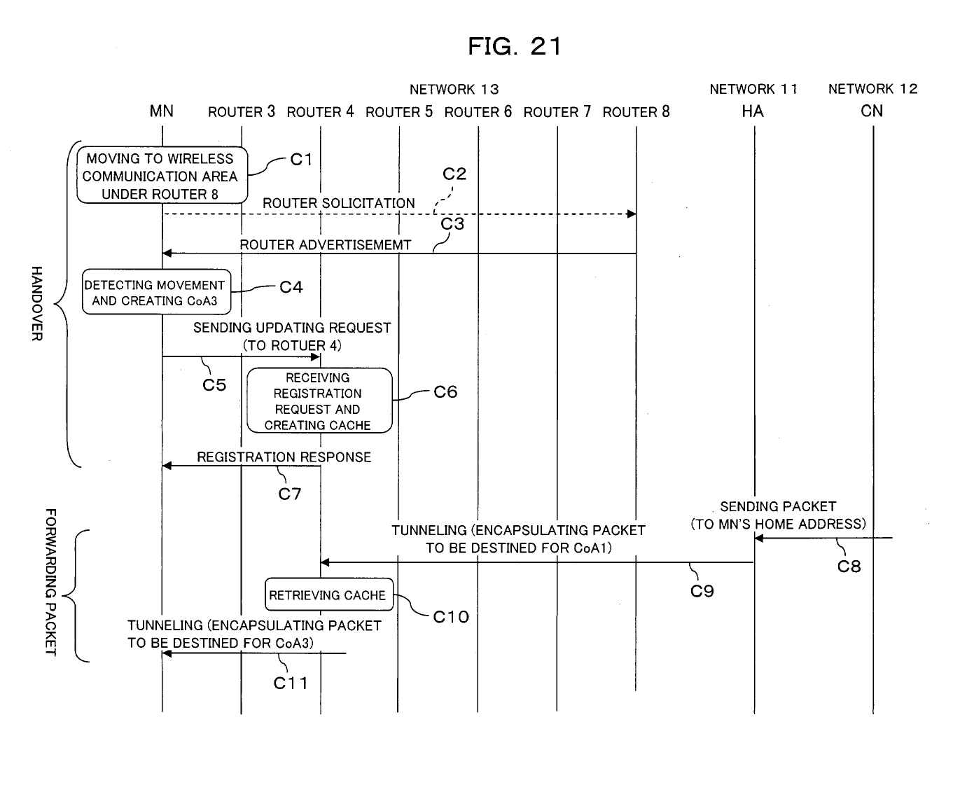

FIG. 21 illustrates procedural steps of another handover of a wireless communication area and packet forwarding of the first embodiment. Here, the mobile node MN causes the second handover from the wireless communication area of access router 7 to that of access router 8 and a packet is forwarded to the mobile node MN in the wireless communication area under access router 8. Also in the drawing, the elements and parts having identical reference numbers with those described above refer to identical or substantially identical elements and parts.

First of all, the mobile node MN moves to the wireless communication area of access router 8 (step C1) and sends access router 8 a router solicitation (step C2). Upon receipt of the router solicitation, access router 8 sends the mobile node MN a router advertisement message (step C3). Upon receipt of the router advertisement message, the mobile node MN detects a move of the mobile node MN itself to another wireless communication area and creates CoA3 (step C4) and sends distribution router 4 an updating request message (step C5). Distribution router 4 receives the updating request message, updates the binding cache (the cache) (step C6) and sends the mobile node MN a registration response message (step C7). In the manner, the mobile node MN causes a handover of a wireless communication area.

Subsequently, the correspondent node CN in network 12 sends the homeagent HA in network 11 a packet destined for the mobile node MN (step C8). Upon receipt of the packet, the homeagent HA encapsulates the packet such that the packet is destined for CoA1, and sends the encapsulated packet to CoA1 (step C9). Distribution router 4 receives the encapsulated packet and retrieves the binding cache that the distribution router 4 itself retains (step C10), performs another encapsulation on the packet such that the packet destined for CoA3 and then sends the encapsulated packet to CoA3, (step C11). It is therefore possible to ensure packet forwarding.

Hereinafter a comparison of mobile communication system 200 of the present invention with conventional technique will now be described. In a conventional hierarchical mobile IPv6, periodic broadcasting by access routers 6 and 7 causes each mobile node MN to realize the position of a multistage agent in a network. Whereupon, each mobile node MN refers to the address or the like of the multistage agent to realize a router having a multistage agent in which the mobile node MN itself is to be registered.

Conversely, in mobile communication system 200 of the present invention, even when each mobile node MN does not realize the structure of mobile communication system 200, the mobile node MN simply sends the network side its CoAw, so that the corresponding cache is dynamically created at one or more proper nodes.

For example, when a mobile node MN establishes communication in the wireless communication area of access router 6 and remains in the same communication area during the communication, a new cache is not created. In other words, since the present invention dynamically creates a cache only when a mobile node MN moves to change a wireless communication area, it is possible to use resources more efficiently than the conventional hierarchical mobile IPv6.

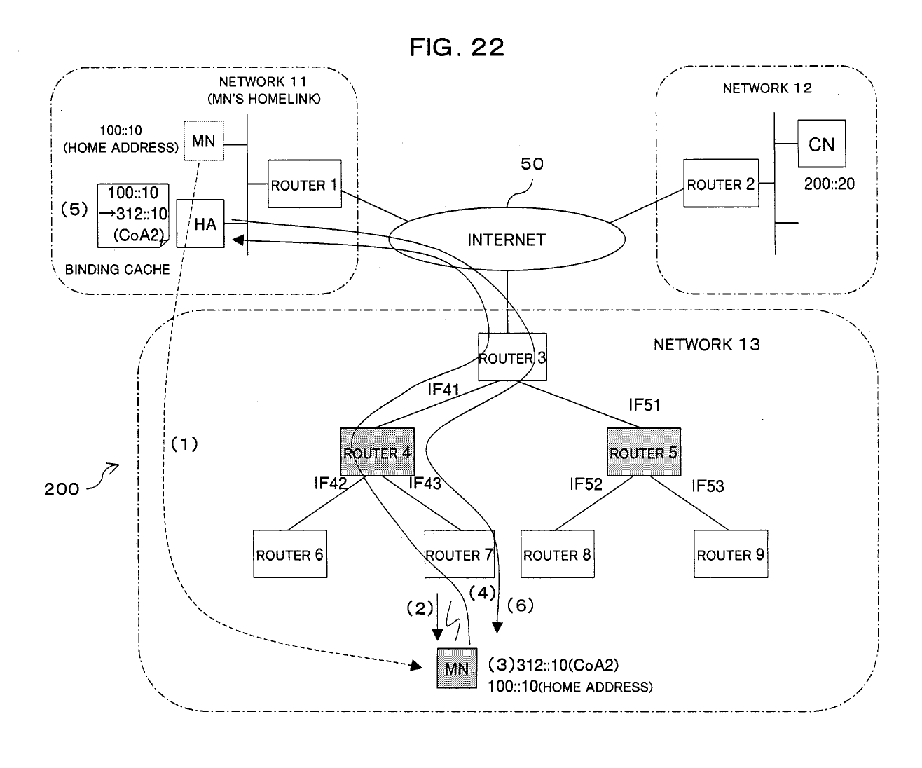

In the conventional technique, packet forwarding has been performed using distribution router 4 with a function for looping back a packet. The present invention can be also realized by cooperation of such a router with a looping-back function and a router which can forward a packet without using a looping-back function even the router is equipped with the function. Hereinafter, a modification of the first embodiment will now be described with reference to FIGS. 22-26 in which elements and parts having identical reference numbers with those described above are identical or substantially identical elements and parts.

FIG. 22 illustrates procedural steps of a position registration performed for the mobile node MN in the wireless communication area of access router 7 of the first embodiment. Here, the position registration takes place when the mobile node MN moves to the wireless communication area of access router 7. The procedural steps in FIG. 22 are identical to those performed in the homeagent HA through normal mobile IPv6 to register the position of the mobile node MN (see FIG. 1).

Process (1): the mobile node MN moves to the wireless communication area of access router 7 in network 13 from network 11 (see the dotted line).

Process (2): the mobile node MN receives a router advertisement message that access router 7 sends periodically or responsive to a request from the mobile node MN. A router advertisement message includes a network prefix (for example, “312::/64”) of a current connection link of the mobile node MN. Dissimilar from hierarchical mobile IPv6, the router advertisement message does not include the address (MAP1 of FIG. 31) of distribution router 4.

Process (3): on the basis of the network prefix of the connection link included in the received router advertisement message, the mobile node MN creates CoA2(for example, 312::10).

Process (4): the mobile node MN issues the homeagent HA a position registration message BU to register CoA2created by the mobile node MN and the home address into the homeagent HA.

Process (5): upon receipt of the position registration message BU issued in the previous process (4), the homeagent HA creates a binding cache based on the contents of the position registration message BU. The created binding cache retains a correlation between the home address and CoA2.

Process (6): the homeagent HA sends the mobile node MN a registration response message BA to notify the mobile node MN of reception of the registration.

After completion of process (6), a packet that the correspondent node CN has issued to the home address of the mobile node MN is intercepted by the homeagent HA, is encapsulated so as to be destined to CoA2 of the mobile node MN and forwarded to CoA2 (the processes are not shown in drawings). These procedural steps are different from those through hierarchical mobile IPv6 not to perform another encapsulation on the encapsulated packet at the distribution router 4 (MAP1 of FIG. 31).

As mentioned above, unnecessary process can be omitted whereupon the individual routers can continue communication with the mobile node MN while the mobile node MN moves at high speed.

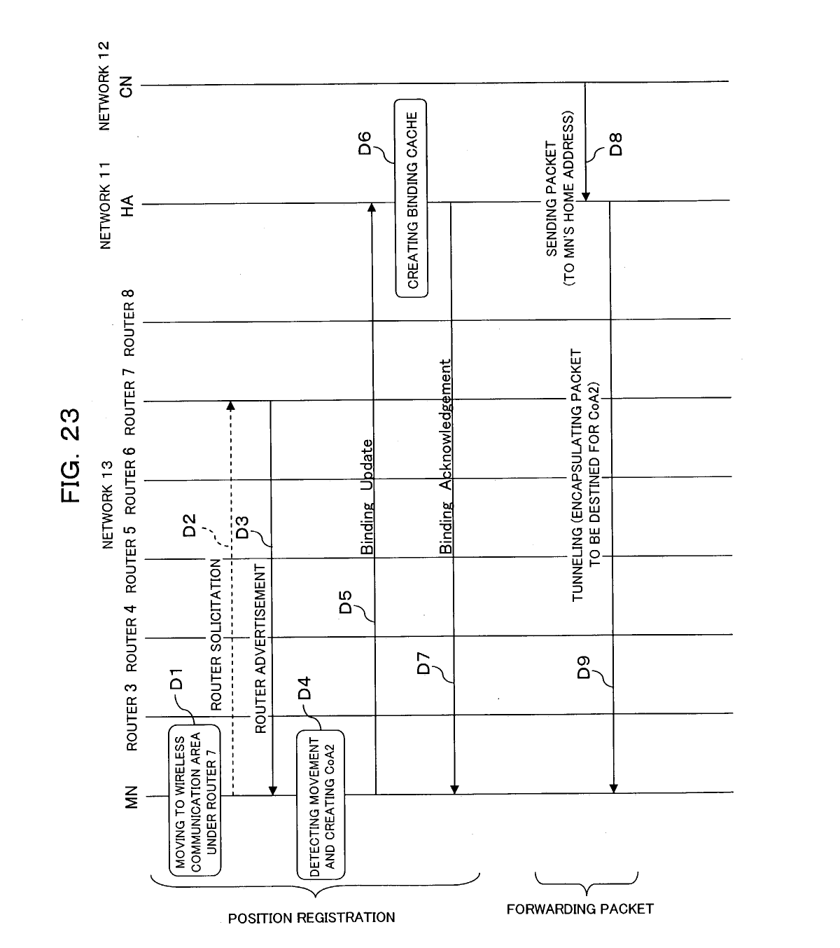

FIG. 23 illustrates procedural steps of a position registration and forwarding another packet of the first embodiment. Here, the procedural steps are carried out for registration of the mobile node MN moved to the wireless communication area to access router 7 and forwarding of a packet issued to the mobile node MN from the correspondent node CN. Also in the drawing, the elements and parts having identical reference numbers with those described above are identical or substantially identical elements and parts.

First of all, the mobile node MN moves to the wireless communication area of access router 7 (step D1) and sends access router 7 a router solicitation message (step D2). Upon receipt of the router solicitation message, access router 7 sends the mobile node MN a router advertisement message (step D3). Upon receipt of the router advertisement message, the mobile node MN detects a movement of the mobile node MN itself to another wireless communication area and creates CoA2 (step D4). After that, the mobile node MN sends the homeagent HA in network 11 a message (Binding Update) to request updating of the binding cache (step D5). Receipt of the message causes the homeagent HA to create a binding cache (step D6) and send a Binding Acknowledgement to the mobile node MN (step D7). With these processes, it is possible to register the current position of a mobile node MN even after a move of the mobile node MN to change a point of attachment.

In succession, the correspondent node CN in network 12 issues a packet to the mobile node MN (step D8). The homeagent HA receives and relays the packet, and then sends the packet to the mobile node MN (step D9). It is therefore possible to ensure also packet forwarding.

Further, position registration and packet forwarding can be certainly carried out even when the mobile node MN has moved to change a wireless communication area.

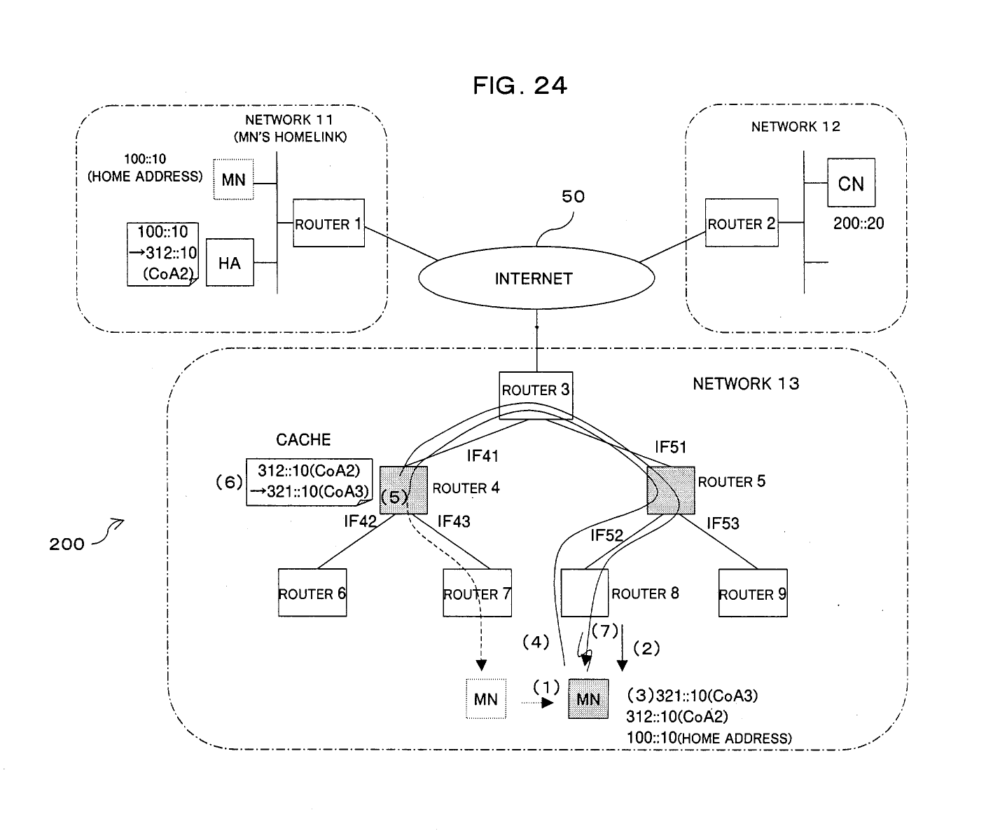

FIG. 24 illustrates procedural steps of a handover of wireless communication area after the position registration of FIG. 22 according to the first embodiment. The elements and parts having identical reference numbers in the drawing with those described above are identical or substantially identical elements and parts.

Process (1): the mobile node MN moves to the wireless communication area of access router 8 from that of access router 7 in the visited network 13 (see the dotted line). When the mobile node MN detects that the level of a radio signal received from access router 8 becomes higher than that from access router 7, the mobile node MN switches the point of attachment from access router 7 to access router 8.

Process (2): the mobile node MN receives a router advertisement message which access router 8 issues periodically or responsive to a request from the mobile node MN. The router advertisement message includes the network prefix (for example, “321::/64”) corresponding to the current connection link of the mobile node MN. Here, dissimilar from hierarchical mobile IPv6, the router advertisement message does not include the address (MAP2 in FIG. 31) of distribution router 5.

Process (3): the mobile node MN creates CoA3 (for example, “321::10”) on the basis the network prefix of the connection link included in the received router advertisement message. At this time, the mobile node MN does not delete CoA2 that has been used during communication in the wireless communication area of access router 7 prior to the last move.

Process (4): the mobile node MN sends access router 8 a registration request message to request network 13 to change the destination of a packet destined for CoA2used prior to the move to CoA3 to be used after the move.

The registration request message is identical in format to that in FIG. 13(a) but the destination address and the correspondent address in the IPv6 header are CoA2and CoA3 that are respectively used prior to and after the move of the mobile node MN. The registration request message is destined for CoA2 and is routed to the mobile node MN disposed at the downlink of access router 7. The following processes are performed when the registration request message pass through distribution router 5 on the way to the routing.

Process (4-1): distribution router 5 analyzes the hop-by-hop options header of the registration request message.

Process (4-2): on the basis of the type value indicated in the hop-by-hop options header, distribution router 5 detects that the packet is a registration request message of the present invention.

Process (4-3): distribution router 5 confirms CoA2that is the destination address of the registration request message and retrieves in the routing table (see FIG. 11 or 12).

Process (4-4): as the result of the retrieval, distribution router 5 acknowledges that CoA2 is “312::10” and prefix “312::/64” is hit as an entry matching to the CoA2.

Process (4-5): distribution router 5 determines interface 51 through which the registration request message is to be output. But, since the corresponding downlink information is “No”, so that the next output is not carried out to the downlink side, distribution router 5 does not intercept the registration request message and performs normal packet forwarding on the message in the normal forwarding manner. In other words, distribution router 5 simply relays the message.

Process (5): subsequently, the following processes are to be performed when the registration request message forwarded by distribution router 5 passes through distribution router 4.

Process (5-1): distribution router 4 analyzes the hop-by-hop options header of the registration request message.

Process (5-2): on the basis of the type value indicated in the hop-by-hop options header, distribution router 4 detects that the packet is a registration request message of the present invention.

Process (5-3): distribution router 4 confirms CoA2the destination address of the registration request message and retrieves in the routing table (see FIG. 11 or 12).

Process (5-4): as the result of the retrieval, distribution router 4 acknowledges that CoA2 is “312::10” and prefix “312::/64” is hit as an entry matching to the CoA2.

Process (5-5): distribution router 4 determines interface 43 through which the registration request message is to be output. But, since the corresponding downlink information is “Yes”, so that the next output of the registration request message is carried out to the downlink side, distribution router 4 intercepts the registration request message without sending the message and starts a cache creating operation.

Process (6): distribution router 4 creates a cache on the basis of the correspondent address (CoA3) and the destination address CoA2 in the IPv6 header of the intercepted registration request message. The lifetime of the created cache is determined with reference to the lifetime registered in the hop-by-hop options header (optional header). Alternatively, the policy of distribution router 4 may prolong or shorten the lifetime of the cache.

Process (7): distribution router 4 sends a registration response message to the mobile node MN to notify the mobile node MN of the reception of the registration request message. The registration response message is identical in format to that shown in FIG. 13(b), but the destination address and the correspondent address in the IPv6 header are respectively CoA3 and the address of distribution router 4. The destination options header in the registration response message indicates a type value for judgment that the destination options header is a registration response message of the present invention and a lifetime of the cache created. The registration response message causes the mobile node MN to acknowledge the creation of the cache in distribution router 4 and then the mobile node MN extracts the address of distribution router 4 from the correspondent address to retain.

As described above, distribution router 4 serves a loop-back function and concurrently, distribution router 5 carries out a normal routing operation to forward a registration message to the destination address. Namely, distribution router 5 simply relays the message.

As a result, in the illustrated modification, all of the router attached to Internet 50 do not serve a looping-back function but an efficient packet forwarding can be realized by cooperation of a router (distribution router 4) serving a function of looping back a packet and a router (distribution router 5) not serving the same function.

Further, mobile communication system 200 does not usually reserve resources for a handover while dynamically creates a cache only at the time when a mobile node MN causes a handover of a wireless communication area.

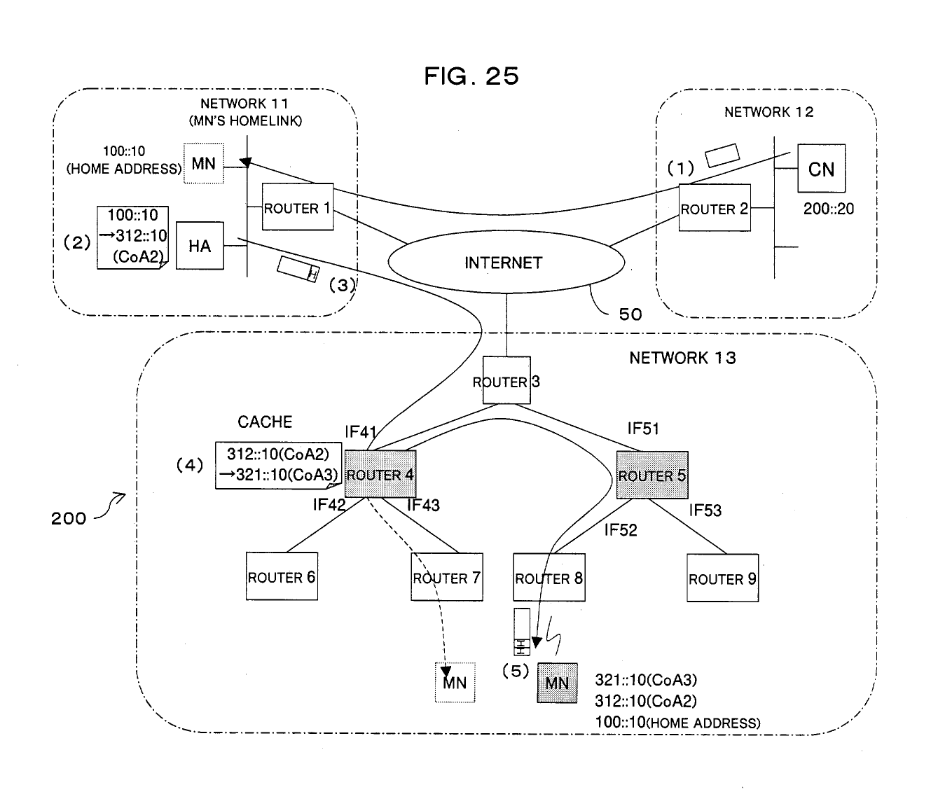

Next, FIG. 25 illustrates procedural steps of packet forwarding after occurrence of a handover of a wireless communication area of the first embodiment.

Process (1): the correspondent node CN (having address of 200::20, for example) sends a packet destined for the mobile node MN to the home address (for example, “100::10”) of the mobile node MN.

Process (2): the homeagent HA in network 11 intercepts, in place of the mobile node MN, the packet destined for the mobile node MN, and encapsulates the intercepted packet by providing the packet with a header to change the destination address to CoA2 on the basis of the information in the binding cache.

Process (3): the homeagent HA forwards the encapsulated packet to CoA2.

Process (4): since distribution router 4 retains the cache of CoA2 that is the destination of the encapsulated packet which has been forwarded in the previous process (3), distribution router 4 performs an encapsulation on the packet by adding a header to change the destination address of the packet into CoA3 on the basis of the information in the retained cache.

Process (5): distribution router 4 forwards the packet encapsulated in process (4) to CoA3. The encapsulated packet is received by the mobile node MN through router 3, distribution router 5 and access router 8. The mobile node MN removes the encapsulation headers respectively added by the homeagent HA and distribution router 4 from the received packet in order to receive the original packet that has been issued by the correspondent node CN in the initial process (1).

After that, if the mobile node MN causes a handover from the wireless communication area of access router 8 to that of access router 9, the procedural steps for a handover identical to those of FIG. 15 are performed (not shown).

FIG. 26 illustrates alternative procedural steps of a handover from the wireless communication area of access router 7 to that of access router 8 and of packet forwarding to mobile node MN in the wireless communication area of access router 8 of the first embodiment. In FIG. 26, the elements and parts having identical reference numbers with those described above refer to identical or substantially identical elements and parts.

First of all, the mobile node MN moves to the wireless communication area of access router 8 (step E1) and sends access router 8 a router solicitation (step E2). Upon receipt of the router solicitation, access router 8 sends the mobile node MN a router advertisement message (a router advertisement) (step E3). Upon receipt of the router advertisement message, the mobile node MN detects a movement of the mobile node MN itself to another wireless communication area and creates CoA3 (step E4). After that, the mobile node MN sends distribution router 5 a registration request message destined for CoA2 (step E5).

The following procedural steps are different from those performed in FIG. 15. In the illustrated procedural steps of FIG. 26, upon receipt of the registration request message, distribution router 5 forwards the registration request message to distribution router 4 (step E6). Upon receipt of the forwarded registration request message from distribution router 5, distribution router 4 terminates the registration request message and creates a cache (step E7), and further sends the mobile node MN a registration response (step E8). Upon receipt of the registration response message, the mobile node MN holds the address of distribution router 4 (step E9).

With the above procedural steps, if the mobile node MN moves to the wireless communication area of access router from that of access router 7, only distribution router 4 requires to trace a position of the mobile node MN while other routers have only to perform normal packet forwarding.

Additionally, if the correspondent node CN in network 12 issues a packet destined for the mobile node MN to the home address of the mobile node MN (step E10) in this state, the homeagent HA in network 11 receives the packet, encapsulates the packet in step E11 and sends the encapsulated packet to CoA2. After that, distribution router 4 retrieves a cache in relation to the data on which tunneling has been performed (step E12). Distribution router 4 further encapsulates the packet such that the packet is destined for CoA3, and sends the packet to the mobile node MN (step E13).

With these procedural steps, after the mobile node MN causes a handover of a wireless communication area, a packet issued to the mobile node MN from the correspondent node CN is temporarily received by the homeagent HA, looped back by distribution router 4 and forwarded to distribution router 5. The packet is relayed by distribution router 5 and further forwarded to access router 8, which sends the packet to the mobile node MN. As a result, both handover and packet forwarding are ensured.

The usage of mobile IP in mobile communication system 200 causes the correspondent node CN to assume that the destination IP address does not change. Namely, the correspondent node CN always accesses only to the homeagent HA so that, during the communication between the correspondent node CN and the mobile node MN, the correspondent node CN can sends a packet to the mobile node MN irrespective of a change in address of the mobile node MN, which change is caused by a move of the mobile node MN. As a result, even if the address of a communication companion terminal is changed during communication, the communication session is not disengaged.

### (B) Second Embodiment

The second embodiment will be described with reference to two types of examples. The first example utilizes a mobile node MN having functions for substitute packet forwarding using DNS installed in network 11 in addition to the functions identical to a mobile node MN used in the first embodiment. In the first example, a mobile node MN uses both distribution router 4 and the DNS. If the mobile node MN receives mobile communication support that uses distribution router 4, the mobile node MN does not update the correspondence between the host name and the address of the mobile node MN, which correspondence is retained in the DNS.

Conversely, in the second example, the mobile node MN does not use mobile IP, which is used in the first embodiment, and performs a substitute packet forwarding using the DNS. Also the second example will be described later.

In the first embodiment, a packet that the correspondent node CN issues to the home address of the mobile node MN is forwarded to the mobile node MN via the homeagent HA in network 11.

In the second embodiment, after a packet from the correspondent node CN is forwarded to the mobile node MN, the mobile node MN notifies the correspondent node CN of CoA of the mobile node MN itself. After receipt of the notification, the correspondent node CN sends another packet directly to router to which the mobile node MN is attached without sending the packet to the homeagent HA whereupon efficiency in packet forwarding can be improved.

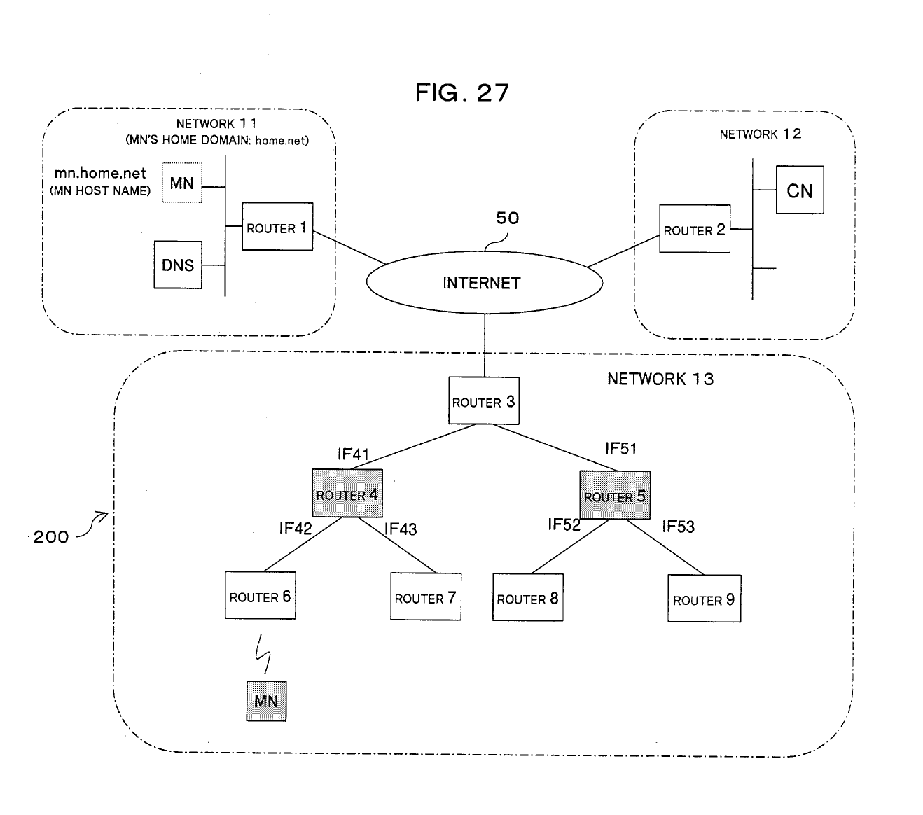

In other words, the correspondent node CN obtains information (CoA) of a router to which the mobile node MN moved to attach, so that efficiency in packet forwarding is improved. FIG. 27 shows an example of mobile communication system 200 according to the second embodiment, which system is similar to that shown in FIG. 1. The elements and parts, in FIG. 27, having identical reference numbers with those described above are identical or substantially identical elements and parts, so any repetitious description is omitted here.

The mobile communication system 200 of FIG. 27 is different from that of the first embodiment in that the mobile node MN does not utilize mobile IPv6 in the system of FIG. 27. For this reason, network 11 in FIG. 27 does not include a homeagent HA but includes a DNS as a substitute.

The DNS holds a record of a correspondence between the host name (for example, MN.home.net) of the mobile node MN and the IPv6 address of the mobile node MN, and responds to an inquiry about IPv6 address corresponding to the host name. Differently from communication through mobile IPv6, the mobile node MN does not register the current position of the mobile node MN in the homeagent HA. Instead, if the mobile node MN changes the IPv6 address of the mobile node MN, the mobile node MN notifies the DNS of the change so that the DNS updates the record in relation to the mobile node MN.

The DNS may record an IPv4 address in addition to an IPv6 address.

In the mobile communication method of the present invention, if packet communication is carried out through a mobile protocol in which communication can be continued even when a mobile node MN moves to change a physical attachment position in Internet 50, the mobile node MN does not change the contents held by the DNS, which retains the correspondence between the host name and the home address (the IPv6 address) of the mobile node MN.

Further, in the mobile communication method of the present invention, a mobile node MN, currently in communication with access router 6 that in one from access routers 6-9, detects a change in network prefix and then sends a registration change request to notify CoA1 used for communication after the move to the visited network 13 of the mobile node MN to the DNS, which retains a correspondence between the host name of the mobile node MN and CoA1 used for communication prior to a move on the basis of the change in network prefix.

Upon receipt of the registration change request, the DNS updates the contents retained in the DNS. The correspondent node CN issues an inquiry about CoA1corresponding to the host name of the mobile node MN, and sends a packet to the CoA1.

If the mobile communication method of the second embodiment utilizes a mobile protocol in which communication can be continued even when a mobile node MN moves to change a physical attachment position in mobile communication system 200, the mobile node MN can continue communication without requesting the homeagent HA to update the position of the mobile node MN.

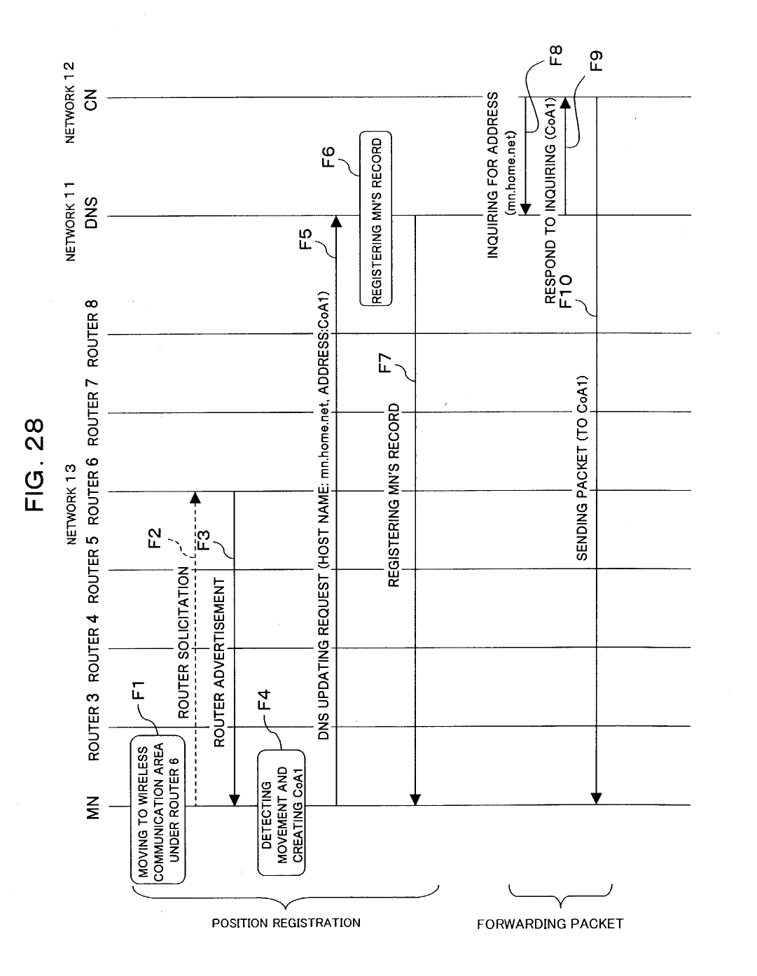

FIG. 28 illustrates procedural steps of updating DNS performed in relation to the mobile node MN in the wireless communication area of access router 6 of the second embodiment. The drawing sequentially illustrates procedural steps of an updating operation performed in the DNS when the mobile node MN moves to the wireless communication area of access router 6 and successive packet forwarding performed in the wireless communication area of access router 6. The elements and parts, also in FIG. 28, having identical reference numbers with those described above refer to identical or substantially identical elements and parts.

Similar to processes (1) to (3) in FIG. 14, the mobile node MN creates CoA1 used for communication in the wireless communication area of access router 6. More specifically, the mobile node MN moves to the wireless communication area of access router 6 (step F1) and sends access router 6 a router solicitation message (step F2). Upon receipt of the message, access router 6 sends the mobile node MN a router advertisement message (step F3). Receipt of the router advertisement message causes the mobile node MN to detect a move of the mobile node MN itself to another wireless communication area and create CoA1 (step F4).

After that, the mobile node MN sends the DNS an updating request message to request for registration (step F5). The registration is performed on the correspondence between the host name (for example, MN.home.net) and an IPv6 address (for example, CoA1) of the mobile node MN, for example. At step F6, if there is no record to be updated in conformity with the updating request, the DNS registers a new record while, if there is the corresponding record, the DNS updates the record. The DNS sends the mobile node MN a DNS updating response message (step F7) and the position registration is thereby completed.

In this state, when the correspondent node CN is to issue a packet to the mobile node MN, the correspondent node CN, first of all, sends an inquiry about an IPv6 address corresponding to the host name (for example, MN.home.net) of the mobile node MN (step F8) and obtains the IPv6 address (for example, CoA1) of the mobile node MN responsive to the inquiry (step F9). The correspondent node CN issues a packet destined for the mobile node MN to CoA1 (step F10). The issued packet is not encapsulated on the routing path and is forwarded to the mobile node MN whereupon packet forwarding is accomplished.

As mentioned above, hierarchical processing is performed only on a mobile node which actually moves to change a point of attachment and that reduces loads on network.

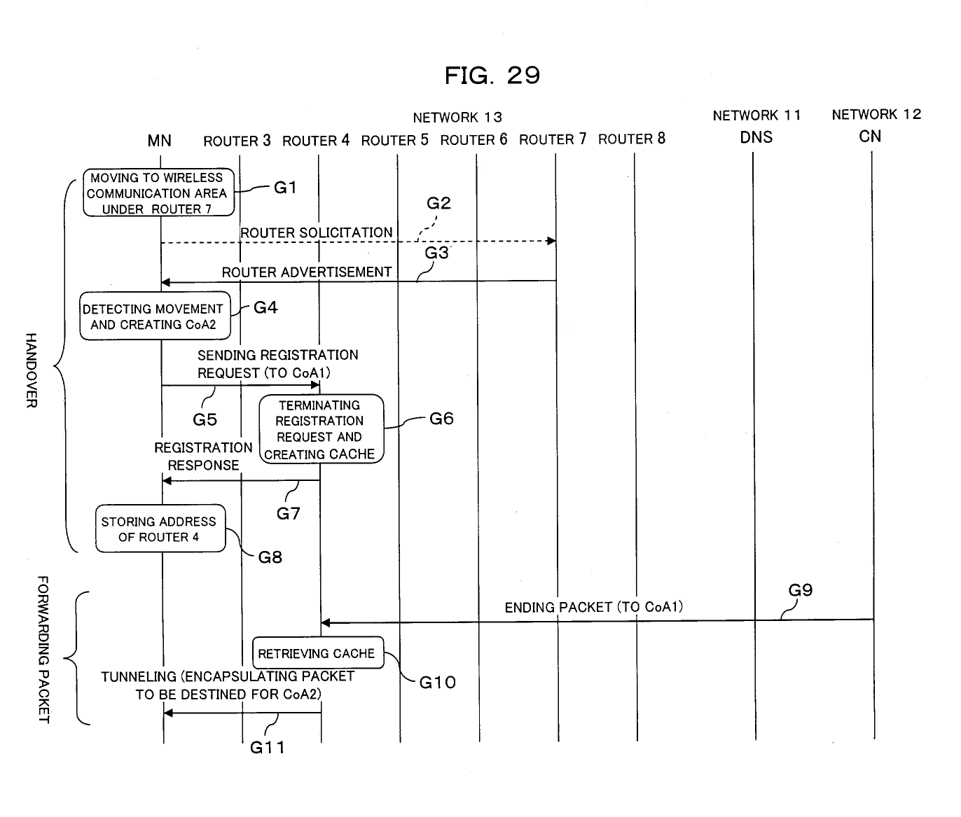

FIG. 29 illustrates procedural steps of a handover of a wireless communication area and packet forwarding of the second embodiment. The procedural steps represents a handover to the wireless communication area of access router 7 after the DNS updating of FIG. 28 and packet forwarding to the mobile node MN in the wireless communication area under access router 7. The elements and parts, in FIG. 29, having identical reference numbers with those described above refer to identical or substantially identical elements and parts.

The mobile node MN creates CoA2 that is to be used for communication in the wireless communication area of access router 7 (steps G1-G4) in the same manner as processes (1) to (7) of FIG. 14. Then the mobile node MN sends distribution router 4 in network 13 a registration request message to request distribution router 4 to create a cache (step G5). Upon receipt of the registration request message, distribution router 4 creates a cache so that a packet destined to CoA1 is destined for CoA2 (step G6). At that time, there is no need to update the record registered in the DNS. Subsequently, distribution router 4 sends the mobile node MN a registration response message (step G7), so that the mobile node MN retains the address of distribution router 4 (step G8).

In this state, since the correspondent node CN holds the host name (for example, MN.home.net) and an IPv6 address (for example, CoA1) of the mobile node MN based on the response to the inquiry referred in FIG. 27, the mobile node MN sends a packet destined for the mobile node MN to CoA1 (step G9). Similar to processes (4) and (5) in FIG. 16, a cache in relation to the packet is retrieved (step G10) and encapsulation is performed on the packet so that the packet becomes destined for CoA2. The encapsulated packet is forwarded to the mobile node MN in the wireless communication area under access router 7 (step G11).

As a result, the packet the correspondent node CN has issued is encapsulated when passing through distribution router 4, and forwarded to the mobile node MN.

As described above, if the mobile node MN has a care-of address after a move to another wireless communication area, the correspondent node CN can grasp a current position of the mobile node MN by accessing to the DNS whereupon such a packet can be forwarded to the mobile node MN without using the homeagent HA.

Further, the present invention can attain the same result as using a combination with the DNS as substitute for a mobile IP. Mobility in mobile communication system 200 can also be improved so that the present invention can be realized at an upper layer or a lower layer in the system.

The second embodiment has the same advantages as that of the first embodiment. Namely, the results of the wireless communication of the second embodiment are identical to those caused by using a hierarchical address only when a mobile node MN that has moved to change a wireless communication area. Alternatively, when a mobile node MN does not move to change a wireless communication area, no massage may be issued.

Issuing of no message does not generate undue traffic on a routing path and thereby mobile communication system 200 can be efficiently managed and maintained.

Further, there is no requirement to support all mobile nodes MNs by dealing with messages at a MAP. In the conventional wireless communication, when any mobile node MN in communication moves to change a wireless communication from an original area to another area while the other remaining mobile nodes MNs in the original area to be supported are in communication and are not on the move, records in relation to all mobile nodes MNs including the immoving ones have to be periodically refreshed (updated) so that such updating manner greatly loads on mobile communication system 200. Conversely, the present invention largely reduces such loads on mobile communication system 200.

In conventional technique, since the MAP retains the states of the all mobile nodes MNs belonging to the wireless communication areas under command of the MAP, it is very difficult to efficiently utilize physical resources exemplified by a memory capacity. The present invention enables to the resources to be effectively used.

If each mobile node MN carries out communication through IPv4 and IPv6 and is supported by a mobile communication while the mobile node MN is on the move, the mobile node MN does not updates the current position of the mobile node MN in the homeagent HA.

### (C) Others

The present invention should by no means be limited to these foregoing embodiments, and various changes or modifications may be suggested without departing from the gist of the invention.

Each of access routers 6-9 is connected to the mobile node MN via a wireless link, but alternatively may be connected via a wired link. For example, a mobile node MN may be a personal computer (hereinafter called a portable PC, not illustrated in the drawings) with portability.

Here, the portable PC and access routers 6-9 are equipped with connectors for LAN cables, and are connected with LAN cables.

In mobile communication system 200 with such an arrangement, the portable PC registers the position of the portable PC itself into the homeagent HA beforehand. The user moves the portable PC to another wired communication area and connects the portable PC to the network.

At that time, the PC is powered on to be activated and acknowledges that the PC itself is attached to a network other than that initially connected to.

In this state, the portable PC performs procedural steps of FIG. 16, for example, so that a router serving as a distribution router creates a cache table.

A correspondent node CN at another network issued a packet to the portable PC and the issued packet is forwarded to the portable PC locating at a position different from the initial position.

As a result, the mobile communication via wireless and/or wired connection can expand the range of user of the present invention.

What is claimed is:

1. A mobile communication method for a mobile communication system comprising a mobile node MN, retaining network identification information, and a plurality of multistage interconnection routers including two or more access routers each of which is able to be communicably connected to the mobile node MN, comprising the steps of:
(a) establishing communication between the mobile node MN and a first access router that is one from the access routers;
at the mobile node MN,
(b) issuing, to at least one of the plural multistage interconnection routers, a registration change request to change a first temporary address of the mobile node MN used during the communication with the first access router into a second temporary address of the mobile node MN to be used during with a second access router that is one from the access routers in accordance with a change in said network identification information;
at one or more distribution routers among the plural multistage interconnection routers,
(c) creating a cache memory retaining said first and said second temporary addresses in correlation with each other based on the registration request issued in said step (b); and
(d) forwarding a packet destined for said first temporary address to said second temporary address based on said cache memory created in said step (c).

2. A mobile communication method according to claim 1, wherein:
said step (c) comprises the step of providing said cache retaining said first temporary address that has been previously registered and said second temporary address included in the registration change request with said first temporary address bound to said second temporary address; and
said step (d) comprises the step of forwarding the packet destined for said first temporary address to said second temporary address.

3. A mobile communication method according to claim 1, further comprising the steps of:
at the mobile node MN,
creating a third temporary address to be used during communication between the mobile node MN and a third access router which is different from the first and the second access routers in accordance with a change in said network identification information of the third access router, which change is caused by a move of the mobile node MN to establish communication with the third router;
issuing, to the one or more distribution routers, a registration update request including said first and said third temporary addresses;
upon receipt of said registration update request at the distribution routers,
retrieving said first cash included in said registration update request in said cache memory;
if said cache memory created by the distribution routers includes said first temporary address,
extracting said third temporary address from said registration update request;
updating said cache memory by correlating said first temporary address with said third temporary address extracted in said step of extracting; and
receiving a packet destined for said first temporary address sent from a correspondent node CN and forwarding the received packet to said third temporary address based on said cache memory.

4. A mobile communication method according to claim 1, wherein, if the mobile node MN moves to cause a change in access router currently in communication with the mobile node MN while the mobile nodes is in communication with another mobile node or a server, the first-named mobile node MN issues said registration change request.

5. A mobile communication method according to claim 1, wherein:
the mobile node MN is a mobile terminal; and
said step (b) of issuing is performed when a handover of communication of the mobile node MN with from the first access router to the second access router occurs in a network

6. A mobile communication method according to claim 3, wherein:
the mobile node MN is a mobile terminal; and
said method further comprises the steps of:
at one or more the access routers included in a network of the mobile communication system,
informing the mobile terminal of an advertisement message including network identification information of a network to which the last-named access router is included;
at the mobile terminal,
creating said third temporary address based on said last-named network identification information included in said advertisement message;
issuing a location registration request including said third temporary address to a homeagent HA;
at the homeagent HA,
creating cache memory retaining a correlation between a home address of the mobile terminal and said third temporary address; and
forwarding a packet including said third temporary address, sent from the correspondent node CN, to the mobile node MN based on said last-named cache memory.

7. A mobile communication method according to claim 6, wherein, if said method is performed through a mobile protocol which enables the mobile terminal to continue communication with an Internet Protocol network even when the mobile terminal moves to change a point of physical attachment to the Internet Protocol network, the mobile terminal is able to communicate to the Internet Protocol network without updating a point of physical attachment, which updating is performed by the homeagent HA.

8. A mobile communication method according to claim 6, wherein, if said method is performed through a mobile protocol which enables the mobile terminal to continue communication with an Internet Protocol network even when the mobile terminal moves to change a point of physical attachment to the Internet Protocol network, the mobile terminal continues to use the contents of a domain name system retaining a host name of the mobile terminal and said first temporary address used prior to the change of a point of physical attachment to the Internet Protocol network in correlation with each other.

9. A mobile communication method for a mobile communication system comprising a mobile node MN, retaining network identification information, and a plurality of multistage interconnection routers including two or more access routers each of which is able to be communicably connected to the mobile node MN, comprising the steps of:
at the mobile node MN in communication with a first access router that is one from the access routers,
(e) detecting a change in said network identification information which change is caused by a move of the mobile node MN from a first attachment point to a second attachment point;
(f) issuing, in accordance with the change detected in step (e) of detecting, a registration change request for changing a first temporary address indicating the first attachment point to a domain name system retaining a host name of the mobile node MN and said first temporary address in correlation with each other;
at the domain name system;
(g) updating the contents retained in the domain name system;
at a correspondent node CN
(h) sending the domain name system an inquiry about said first temporary address associated with the host name; and
(i) sending a packet to said first temporary address.

10. A router used in a mobile communication system comprising a mobile node MN, retaining network identification information, and a plurality of multistage interconnection routers including two or more access routers each of which is able to be communicably connected to the mobile node MN, comprising:
a cache memory for retaining a first temporary address of the mobile node MN used for communication at a first attachment point;
a first receiving section for receiving a first packet issued from the mobile node MN after the mobile node moves from the first attachment point to a second attachment point in a network including the access routers, and receiving a second packet sent from a correspondent node CN;
a change arrangement section for changing, if the first packet received by said first receiving section includes a registration change request to change the first temporary address into a second temporary address, the first temporary address retained in said cache memory into the second temporary address; and
a first transmitting section for transmitting the second packet received by the first receiving section to the second temporary address that has been changed from the first temporary address by said change arrangement section based on routing information that correlates an address of a next hop node to which the second packet received in said receiving section is to be forwarded with visited network identification information included in the second packet.

11. A router according to claim 10, wherein:
the mobile node MN is a mobile terminal;
if the second packet received by said first receiving section includes a registration change request to change the first temporary address into the second temporary address, said change arrangement section changes the first temporary address retained in said cache memory into the second temporary address; and
said first transmitting section transmits the second packet received by the first receiving section to the second temporary address, which has been changed from the first temporary address by said change arrangement section, based on routing information in which an address of a next hop router to which the first packet received in said receiving section is to be forwarded is correlated with visited network identification information included in the second packet and with link information indicating whether the next hop router locates upstream or downstream of said router.

12. A router according to claim 10, wherein:
the mobile node MN is a mobile terminal;
said first receiving section receives the first packet issued from the mobile node MN after the mobile node moves from the first attachment point to the second attachment point, and said second packet sent from the correspondent node CN;
if the second packet received by said first receiving section includes a registration change request to change the first temporary address into the second temporary address, said change arrangement section changes the first temporary address retained in said cache memory into the second temporary address;
said router further comprises a routing table retaining routing information in which an address of a next hop to which the first packet received in said receiving section is to be forwarded is correlated with visited network identification information included in the second packet and with link information indicating whether the next hop router locates upstream or downstream of said router; and
said first transmitting section transmits the second packet received by the first receiving section to the second temporary address, which has been changed from the first temporary address by said change arrangement section, based on said routing information.

13. A router according to claim 12, wherein said routing table retains first information correlating the addresses of the next hop router with the visited network identification information and second information correlating the visited network identification information with the link information with the first information correlated with the second information.

14. A router according to claim 10, wherein said change arrangement section changes the first temporary address to the second temporary address based on particular information of the registration changing request.

15. A router according to claim 14, wherein said change arrangement section changes the first temporary address to the second temporary address based on the last-named information that is whether or not an output port associated with the first temporary address indicating the destination of the registration change request corresponds to any of one or more output ports retained in said routing table.

16. A router according to claim 14, wherein said change arrangement section changes the first temporary address to the second temporary address based on the last-named information that is a capacity of resource required for registration an address.

17. A router according to claim 14, wherein said change arrangement section cancels the change of the first temporary address to the second temporary address when a predetermined time has passed since the change of the first temporary address to the second temporary address.

18. A router according to claim 14, wherein said change arrangement section deletes the second temporary address if said change arrangement section receives a request for a deletion of the second temporary address.

19. A router according to claim 14, wherein said change arrangement section deletes the second temporary address if said change arrangement section receives a request for a deletion of the second temporary address while, if said change arrangement section does not receive the request for a deletion of the second temporary address, cancels the change of the first temporary address to the second temporary address when a predetermined time has passed since the change of the first temporary address to the second temporary address.

20. A router according to claim 10, wherein said first transmitting section transmits the header of the registration change request to the mobile terminal MN using a destination header conforming to the Internet Protocol version 6.

21. A mobile node used in a mobile communication system comprising a mobile node MN, retaining network identification information, and a plurality of multistage interconnection routers including two or more access routers each of which is able to communicably connected to said mobile node MN, said mobile node MN comprising:
a router identifier retaining section for retaining an identifier of one of the access routers, which one is currently in communication with said mobile node MN;
a second receiving section for receiving a packet;
a detecting section for detecting that said mobile node MN changes communication with a first access router to that with a second access router on the basis of network identification information included in the packet received in said second receiving section and the identifier retained in said router identifier retaining section; and
a second transmitting section for transmitting, if said detecting section detects the change of communication with the first access router to that with the second access router, a registration change request to at least one of the plural multistage interconnection routers retaining a first temporary address of said mobile node MN, which address is used during the communication between said mobile node MN and the first access router such that the first temporary address is changed to a second temporary address to be used for communication between said mobile node MN and the second access router.

22. A mobile node used in a mobile communication system comprising said mobile node MN, retaining network identification information, and a plurality of multistage interconnection routers including two or more access routers each of which is able to communicably connected to said mobile node MN, said mobile node MN comprising:
a router identifier retaining section for retaining an identifier of one of the access routers, which one is currently in communication with said mobile node MN;
a second receiving section for receiving a packet;
a detecting section for detecting that said mobile node MN changes communication with a first access router to that with a second access router on the basis of network identification information included in the packet received in said second receiving section, the identifier retained in said router identifier retaining section and the quality of a signal received by said detecting section; and
a second transmitter for transmitting, if said detecting section detects the change of communication with the first access router to that with the second access router, a registration change request to the second access routerin order to change a first temporary address used during communication between said mobile node MN and the first access router to a second temporary address to be used for communication between said mobile node MN and the second access router.

23. A mobile node according to claim 22, wherein said second transmitting section transmits the registration change request to the first temporary address if a distribution router is not determined among the plural multistage interconnection routers while, if the distribution router is determined, said second transmitting section transmits the registration change request to the distribution router.

24. A mobile node according to claim 22, wherein said second transmitting section sends the header of said registration request to the second temporary address using at least one of an IPv6 hop-by-hop options header and an IPv6 destination header.

25. A mobile communication system comprising a mobile node MN retaining network identification information and a plurality of multistage interconnection routers including two or more access routers each of which is able to be communicably connected to the mobile node MN,
at least one of the plural multistage interconnection routers for forwarding a packet to the mobile node MN comprising:
a cache memory for retaining a first temporary address of the mobile node MN used for communication at a first attachment point;
a first receiving section for receiving a first packet issued from the mobile node MN after the mobile node MN moves from the first attachment point to a second attachment point in a network including the access routers, and a second packet sent from a correspondent node CN;
a change arrangement section for changing, if the second packet received by said first receiving section includes a registration change request to change the first temporary address into a second temporary address to be used for communication at the second attachment point, the first temporary address retained in said cache memory into the second temporary address; and
a first transmitting section for transmitting the second packet to the second temporary address, which has been changed from the first temporary address by said change arrangement section, based on routing information in which an address of a next hop router to which the first packet received by said first receiving section is forwarded is correlated with visited network identification information included in the second packet; and
said mobile node MN comprising:
a router identifier retaining section for retaining an identifier of one of the access routers, which one is currently in communication with said mobile node MN;
a second receiving section for receiving the second packet;
a detecting section for detecting that said mobile node MN moves to the first attachment point to the second attachment point so that said mobile node MN changes communication with a first access router to that with a second access router on the basis of network identification information included in the second packet received in said second receiving section and the identifier retained in said router identifier retaining section; and
a second transmitting section for transmitting, if said detecting section detects the change of communication with the first access router to that with the second access router, a registration change request to change the first temporary address of said mobile node MN, which address is used during the communication between said mobile node MN and the first access router, into the second temporary address to be used for communication between said mobile node MN and the second access router, to the second access router.

26. A mobile communication system according to claim 25, wherein said at least one of said plural multistage interconnection routers is disposed at a node located on a forwarding route between the first temporary address of said mobile node MN and the second temporary address of said mobile node MN.

27. A mobile communication system according to claim 25, wherein said change arrangement section sends said mobile node a confirmation response in response to the registration request issued by said mobile node MN.
